(19) United States
(12) Patent Application Publication
(10) Pub. No.: US 2026/0224331 A1
(43) Pub. Date: Aug. 6, 2026

(54) PALATAL EXPANDERS FOR USE WITH SECONDARY DENTAL APPLIANCES

(71) Applicant: Align Technology, Inc., San Jose, CA (US)

(72) Inventors: Jordan Harm, Cupertino, CA (US); Jun Sato, San Jose, CA (US); Jeremy Riley, Mountain View, CA (US); Jeffrey McGuire, Raleigh, NC (US); Jason Marshall Cox, Chapel Hill, NC (US); Yuxiang Wang, Newark, CA (US); Fan Fei, Mountain View, CA (US)

(21) Appl. No.: 19/531,074

(22) Filed: Feb. 5, 2026

Related U.S. Application Data
(60) Provisional application No. 63/755,006, filed on Feb. 6, 2025.

(51) Int. Cl. A61C 7/10; A61C 7/00; A61C 7/20

(52) U.S. Cl. CPC A61C 7/10; A61C 7/002; A61C 7/20

(57) ABSTRACT

Systems, methods, and devices for treating a patient’s teeth are provided. In some embodiments, a series of palatal expanders for treating a patient in combination with a secondary dental appliance includes one or more palatal expanders having: a first tooth engagement portion configured to receive first teeth at a left side of an upper dental arch, where the first tooth engagement portion includes a first wire interface configured to removably couple to a first wire portion of the secondary dental appliance; a second tooth engagement portion configured to receive second teeth at a right side of the upper dental arch, where the second tooth engagement portion includes a second wire interface configured to removably couple to a second wire portion of the secondary dental appliance; and a palatal portion between the first and second tooth engagement portions, where the palatal portion is configured to expand the palate of the patient.

### CROSS-REFERENCE TO RELATED APPLICATIONS

The present application claims the benefit of priority to U.S. Provisional Application No. 63/755,006, filed February 6, 2025, the disclosure of which is incorporated by reference herein in its entirety.

### TECHNICAL FIELD

The present technology generally relates to dental appliances, and in particular, to palatal expanders for use with secondary dental appliances.

### BACKGROUND

Dental appliances are used to treat various dental conditions, such as dental malocclusions, jaw dysfunction/misalignment, functional and/or aesthetic conditions, endodontic conditions, and others. For example, wire and bracket appliances can be used to correct maloccluded teeth. Headgear may be used for severe malocclusions and/or to correct jaw misalignment. If significant tooth and/or jaw movements are involved, skeletal anchorage devices such as temporary anchorage devices (TADs) may be used to secure the dental appliance to bone to ensure that the dental appliance can generate sufficiently high forces to produce the desired therapeutic effect. However, skeletal anchorage devices require surgery for implantation and removal, which may be invasive and inconvenient for the patient.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1A is a perspective view of a palatal expander configured in accordance with embodiments of the present technology.

FIG. 1B is a bottom view of an upper dental arch of a patient including dental auxiliaries, in accordance with embodiments of the present technology.

FIG. 1C illustrates the palatal expander of FIG. 1A on the dental arch of FIG. 1B, in accordance with embodiments of the present technology.

FIG. 2A is a bottom view of a system including a palatal expander and a wire and bracket appliance on an upper dental arch, in accordance with embodiments of the present technology.

FIG. 2B is a bottom view of a system including a palatal expander and a wire and bracket appliance on an upper dental arch, in accordance with embodiments of the present technology.

FIG. 2C is a bottom view of a system including a palatal expander and a wire and bracket appliance on an upper dental arch, in accordance with embodiments of the present technology.

FIG. 2D is a bottom view of a system including a palatal expander and a facebow on an upper dental arch, in accordance with embodiments of the present technology.

FIG. 3A is a perspective view of a portion of a palatal expander including a wire interface configured as a pocket, in accordance with embodiments of the present technology.

FIG. 3B is a perspective view of the wire interface of FIG. 3A, in accordance with embodiments of the present technology.

FIG. 3C is a side view of the palatal expander and the wire interface of FIG. 3A with a fastener for securing a wire portion, in accordance with embodiments of the present technology.

FIG. 3D is a perspective view of a portion of a palatal expander including a reversed wire interface, in accordance with embodiments of the present technology.

FIG. 3E is a perspective view of a portion of a palatal expander including a wire interface on a handle, in accordance with embodiments of the present technology.

FIG. 3F is a perspective view of a portion of a palatal expander including a wire interface connected to flexible struts, in accordance with embodiments of the present technology.

FIG. 4A is a perspective view of a portion of a palatal expander including a wire interface configured as a snap fit feature, in accordance with embodiments of the present technology.

FIG. 4B is a perspective view of the wire interface of FIG. 4A, in accordance with embodiments of the present technology.

FIG. 4C is a side view of the palatal expander and the wire interface of FIG. 4A, in accordance with embodiments of the present technology.

FIG. 5A is a side view of a portion of a palatal expander including a wire interface configured to receive an elastic, in accordance with embodiments of the present technology.

FIG. 5B is a perspective view of the wire interface of FIG. 5A, in accordance with embodiments of the present technology.

FIGS. 6A and 6B are perspective views of a palatal expander including an aperture for receiving a bracket, in accordance with embodiments of the present technology.

FIG. 7A–7G illustrate a system including a palatal expander with a longitudinal internal channel for coupling to a secondary dental appliance, in accordance with embodiments of the present technology.

FIG. 8 is a bottom view of a system including a palatal expander with a longitudinal internal channel for coupling to a secondary dental appliance, in accordance with embodiments of the present technology.

FIGS. 9A–9H illustrate a system including a palatal expander with a longitudinal and transverse internal channel for coupling to a secondary dental appliance, in accordance with embodiments of the present technology.

FIGS. 10A–10G illustrate a system including a palatal expander with internal projections for coupling to a secondary dental appliance, in accordance with embodiments of the present technology.

FIG. 11 is a perspective view of a portion of a palatal expander including a slot for coupling to a wire portion of a secondary dental appliance, in accordance with embodiments of the present technology.

FIG. 12A is a side view of a button for removably coupling to an elastic, in accordance with embodiments of the present technology.

FIG. 12B is a perspective view of a palatal expander including buttons for coupling to a secondary dental appliance via elastics, in accordance with embodiments of the present technology.

FIG. 13A is a side view of a hook for removably coupling to an elastic, in accordance with embodiments of the present technology.

FIG. 13B is a perspective view of a palatal expander including posteriorly-oriented hooks for coupling to a secondary dental appliance via elastics, in accordance with embodiments of the present technology.

FIG. 13C is a perspective view of a palatal expander including anteriorly-oriented hooks for coupling to a secondary dental appliance via elastics, in accordance with embodiments of the present technology.

FIG. 14A is partially schematic front cross-sectional view of a system for interarch treatment using a palatal expander coupled to a secondary dental appliance via elastics, in accordance with embodiments of the present technology.

FIG. 14B is partially schematic front cross-sectional view of a system for interarch treatment using a palatal expander coupled to a secondary dental appliance via elastics, in accordance with embodiments of the present technology.

FIG. 15 is a perspective view of a dental appliance including interfaces for coupling to a secondary dental appliance, in accordance with embodiments of the present technology.

FIG. 16 is a flow diagram illustrating a method for treating a patient’s teeth, in accordance with embodiments of the present technology.

FIG. 17 is a flow diagram illustrating a method for designing a palatal expander, in accordance with embodiments of the present technology.

FIG. 18A illustrates a representative example of a tooth repositioning appliance configured in accordance with embodiments of the present technology.

FIG. 18B illustrates a tooth repositioning system including a plurality of appliances, in accordance with embodiments of the present technology.

FIG. 18C illustrates a method of orthodontic treatment using a plurality of appliances, in accordance with embodiments of the present technology.

FIG. 19 illustrates a method for designing an orthodontic appliance, in accordance with embodiments of the present technology.

FIG. 20 illustrates a method for digitally planning an orthodontic treatment and/or design or fabrication of an appliance, in accordance with embodiments of the present technology.

### DETAILED DESCRIPTION

The present technology relates to systems, devices, and methods for treating a patient’s teeth. In some embodiments, for example, a palatal expander for treating a patient in combination with a secondary dental appliance is provided. The palatal expander can include a first tooth engagement portion configured to receive one or more first teeth at a left side of an upper dental arch of the patient, a second tooth engagement portion configured to receive one or more second teeth at a right side of the upper dental arch of the patient, and a palatal portion between the first and second tooth engagement portions, where the palatal portion is configured to apply forces to the first and second tooth engagement portions to expand the palate of the patient. The secondary dental appliance can be a wire-based appliance (e.g., a wire and bracket appliance, a headgear) that includes one or more wires for applying forces to the patient’s teeth. The first tooth engagement portion of the palatal expander can include a first wire interface configured to removably couple to a first wire portion of the secondary dental appliance, and the second tooth engagement portion of the palatal expander can include a second wire interface configured to removably couple to a second wire portion of the secondary dental appliance. Accordingly, the palatal expander can be used to secure the secondary dental appliance to the patient’s upper dental arch, thereby allowing for palatal expansion therapy in combination with the therapy provided by the secondary dental appliance (e.g., tooth repositioning, correction of Class II malocclusions).

The present technology can provide numerous advantages compared to conventional dental treatment approaches. For instance, the palatal expanders described herein may be used to secure a secondary dental appliance to the patient’s upper dental arch without requiring non-patient removable devices such as molar bands and skeletal anchorage devices (e.g., TADs), thereby reducing invasiveness and improving patient convenience. Moreover, the palatal expander can be removably coupled to the secondary dental appliance, thus allowing for the secondary dental appliance and palatal expander to be removed from the patient’s dental arch as appropriate (e.g., during eating/drinking/sleeping and/or to allow different appliances to be applied to the patient’s teeth as a part of the treatment plan). Further, the approaches described herein allow palatal expansion therapy to be implemented in combination with other types of dental treatments, which may improve the flexibility and efficiency of dental treatment.

For example, palatal expansion and anterior tooth alignment can be performed simultaneously using the systems and devices described herein. In some cases, patients with misalignment of anterior teeth may receive treatment to align their teeth with anterior braces, which feature brackets connected by an archwire. Alignment of anterior teeth may require overcoming tooth crowding, for which palatal expansion may be desired to create additional space in the arch. Thus, a palatal expander worn on the posterior teeth can be used to create more space in the dental arch while also providing mechanical anchorage for the archwire to facilitate the alignment of the anterior teeth. In some embodiments, the present technology adds new features to removable palatal expanders and/or repurposes existing features of palatal expanders to integrate with the archwire of anterior braces. Specifically, a wire interface with a mechanical coupling can be introduced to connect the palatal expander to the archwire (e.g., passively or actively). The shape of the wire interface and palatal expander can be customized to exert compressive, tensile, flexural, and/or torsional loads alone or in combination on the archwire to facilitate desired anterior tooth movements. This approach allows the hardware of the anterior braces to remain fixed to the teeth throughout the course of treatment, while also permitting the insertion and removal of a series of palatal expanders. Moreover, the treatment forces exerted by the archwire can be adjusted by selecting a palatal expander with an appropriately configured wire interface, instead of requiring an in-person appointment for manual archwire adjustments.

As another example, palatal expansion and treatment of Class II malocclusions can be performed simultaneously using the systems and devices described herein. In a Class II malocclusion, the maxilla is too far forwards relative to the mandible. Class II malocclusions can be treated using headgear to push on the maxilla to prevent further advancement and/or to retract the maxilla relative to the mandible. Any suitable structure for providing a force to push the maxilla may be used. For example, the headgear may be connected to the back of the patient’s head or neck, and can pull on a headgear mounted to the teeth of the maxilla. A palatal expander can be coupled to the headgear to provide mechanical anchorage for delivering force to the maxilla and/or to prevent any undesired rotation.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I.Palatal Expanders for Securing Secondary Dental Appliances

The present technology relates to palatal expanders that are used in combination with a secondary dental appliance (e.g., an archwire, a headgear) to treat a patient’s teeth. In some embodiments, the palatal expanders described herein are coupled to relatively stable teeth in the patient’s upper dental arch (e.g., large, multi-rooted teeth such as the molars) and thus can serve as a non-invasive, patient-removable anchoring device for securing the secondary dental appliance to the upper arch. For example, the palatal expander can provide a fixed platform for applying forces to move the upper arch relative to the lower arch (e.g., for treatments of Class II or Class III malocclusions via headgear and/or interarch treatments) and/or for applying forces for tooth repositioning (e.g., of the anterior teeth via wire and bracket appliances). As used herein, the term “palatal expanders” encompasses active devices that expand the palate in combination with the therapy provided by the secondary dental appliance, as well as passive devices that are worn over the patient’s teeth but do not expand the palate and instead serve solely as an anchoring device for the secondary dental appliance. The palatal expanders described herein may be used in many different situations where anchorage to the upper dental arch is desired, without requiring non-patient removable anchorage devices such as molar bands, TADs that are implanted into the palate or gingiva, etc.

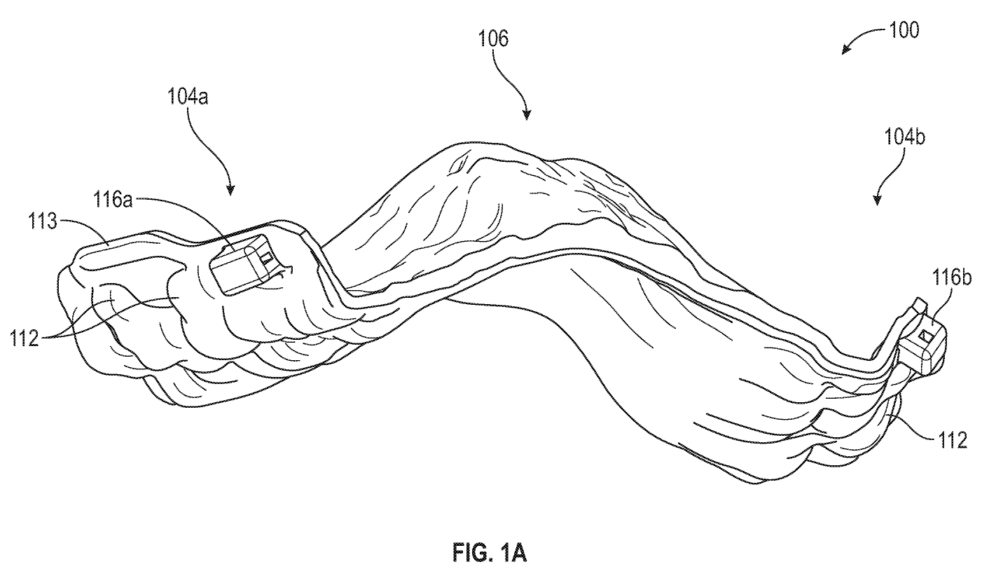

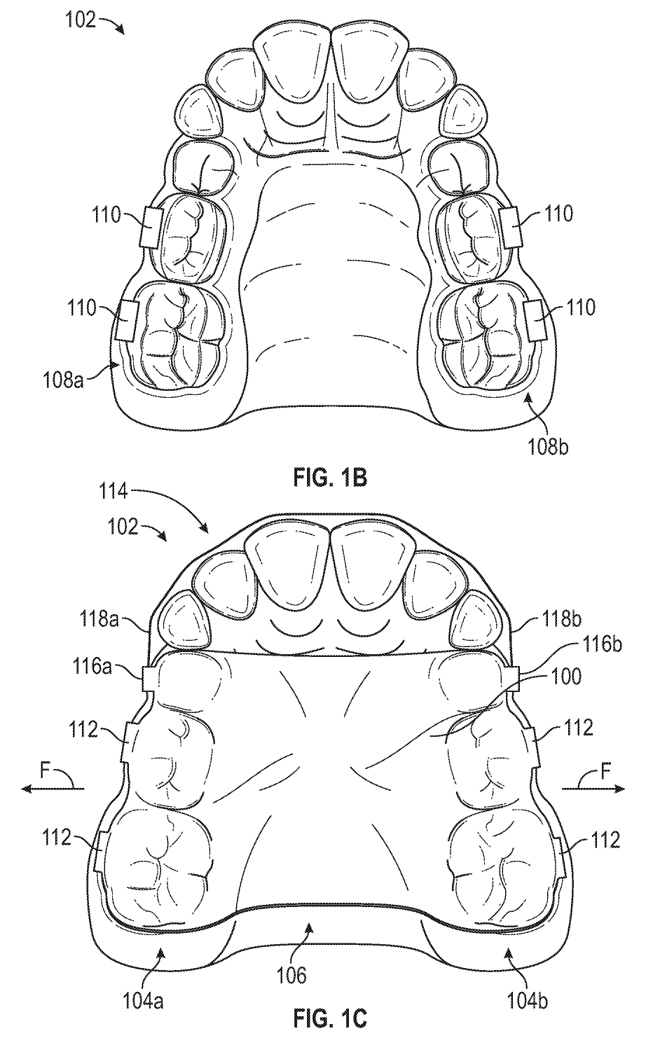

FIGS. 1A–1C illustrate a dental system for expanding a patient’s palate, in accordance with embodiments of the present technology. Specifically, FIG. 1A is a perspective view of a palatal expander 100, FIG. 1B is a bottom view of an upper dental arch 102 of a patient, and FIG. 1C illustrates the palatal expander 100 on the dental arch 102. The palatal expander 100 can be a polymeric dental appliance including a first tooth engagement portion 104a, a second tooth engagement portion 104b, and a palatal portion 106 between the first tooth engagement portion 104a and the second tooth engagement portion 104b. As best seen in FIGS. 1B and 1C, the first tooth engagement portion 104a is configured to receive one or more first teeth 108a at a first side of the dental arch 102, and the second tooth engagement portion 104b is configured to receive one or more second teeth 108b at a second, opposite side of the dental arch 102. The first teeth 108a and the second teeth 108b received by the first tooth engagement portion 104a and the second tooth engagement portion 104b, respectively, can include some or all of the posterior teeth, such as one or more molars and/or premolars. For example, the first teeth 108a and the second teeth 108b can be the three distalmost teeth on each side of the dental arch 102.

In the illustrated embodiment, the first tooth engagement portion 104a and the second tooth engagement portion 104b each include a set of cavities formed therein to receive the first teeth 108a and the second teeth 108b, respectively. An individual cavity may receive a tooth by, for example, receiving and/or extending over only a portion of the tooth, such as the crown of the tooth, a portion of the tooth proximate to the crown, a buccal surface of the tooth, a lingual surface of the tooth, etc. The interior surfaces of the cavity can conform to the occlusal, lingual, and/or buccal surfaces of the received tooth.

The palatal portion 106 is positioned between the first tooth engagement portion 104a and the second tooth engagement portion 104b to couple these components to each other. When the palatal expander 100 is worn on the dental arch 102, the palatal portion 106 can be positioned proximate to the palate of the patient (e.g., spaced apart from some or all of the palatal surface, or in direct contact with some or all of the palatal surface). The palatal portion 106 can be configured to apply expansion forces to the first tooth engagement portion 104a and the second tooth engagement portion 104b that are transmitted to the first teeth 108a and the second teeth 108b, respectively, to cause expansion of the patient’s palate. In some embodiments, the width of the palatal portion 106 is greater than the width of the dental arch 102 when the palatal expander 100 is worn on the patient’s teeth, and the stiffness of the palatal portion 106 (e.g., which may be defined based on the thicknesses and material properties of the palatal portion 106) is sufficiently high to generate and maintain a sufficient amount of expansion force to cause expansion of the palate. The expansion forces produced by the palatal portion 106 can be generally directed in a horizontal, outward (buccal) direction, e.g., as indicated by arrows F in FIG. 1C. In some embodiments, the palatal expander may be a passive device such that the palatal expander does not provide any expansion forces (e.g., the width of the palatal portion may be the same as the width of the dental arch). These passive palatal expanders may be used during a holding/retention phase of a palatal expansion treatment (where the patient’s palate is retained in an expanded configuration for a period of time), or may simply be used as an anchor point for a secondary device as described herein whether or not the patient is undergoing palatal expansion treatment.

In some embodiments, the palatal expander 100 is used in combination with one or more dental auxiliaries 110 that are coupled to one or more teeth of the dental arch 102 to engage the palatal expander 100, such as the first tooth engagement portion 104a and/or the second tooth engagement portion 104b. For example, the dental auxiliaries 110 can be dental attachments (e.g., prefabricated attachments or attachments formed in situ) that are bonded to the surfaces of the patient’s teeth to assist with retention of the palatal expander 100. Other types of dental auxiliaries 110 that may be used include buttons, brackets, pins, connectors, wires, etc. The engagement between the dental auxiliaries 110 and the palatal expander 100 can serve various purposes, such as facilitating retention of the palatal expander 100 on the dental arch, improving transfer of expansion forces from the palatal expander 100 to the underlying teeth, and/or counteracting undesirable tooth movements that might otherwise occur due to expansion forces (e.g., tipping).

The number and configuration of the dental auxiliaries 110 on the dental arch 102 can be varied as desired. For example, although the illustrated embodiment shows four dental auxiliaries 110 (e.g., two dental auxiliaries 110 on the first teeth 108a and two dental auxiliaries 110 on the second teeth 108b), in other embodiments, a different number of dental auxiliaries 110 can be used, such as one, two, three, five, six, seven, eight, or more dental auxiliaries 110. In some embodiments, multiple attachments may be placed on a single tooth. For example, two or three attachments (e.g., buccal attachments) may be placed on the terminal molar (e.g., the most distal molar of the patient) for balancing loads and providing increased retention. These attachments may be smaller in size relative to other attachments to enable placement on a single tooth. Moreover, although the dental auxiliaries 110 are depicted as being placed on the two distalmost teeth on each side of the dental arch 102, the dental auxiliaries 110 can alternatively or additionally be placed on any other teeth received by the palatal expander 100, either the first side or the second side of the dental arch 102 may not include any dental auxiliaries, etc. Furthermore, although the dental auxiliaries 110 are shown as being placed on the buccal surfaces of the teeth, the dental auxiliaries 110 can alternatively or additionally be placed on other suitable surfaces of the teeth, such as the lingual surfaces of the teeth, the occlusal surfaces of the teeth, or suitable combinations thereof. The geometry (e.g., shape, dimensions) of each dental auxiliary 110 can independently be varied as desired, e.g., some or all of the dental auxiliaries 110 may have different shapes, or some or all of the dental auxiliaries 110 can have the same shape.

In some embodiments, the palatal expander 100 includes one or more receptacles 112 (e.g., recesses, apertures, indentations, pockets) to receive and engage the dental auxiliaries 110. For example, the first tooth engagement portion 104a can include one or more first receptacles 112 formed therein to receive one or more dental auxiliaries 110 on the first teeth 108a, and/or the second tooth engagement portion 104b can include one or more second receptacles 112 formed therein to receive one or more dental auxiliaries 110 on the second teeth 108b. Each receptacle 112 can be formed in a sidewall of a cavity for a tooth having the corresponding dental auxiliary 110, such that when the tooth is received within the cavity, the dental auxiliary 110 on the tooth is positioned partially or entirely within the receptacle 112. The interior surface of the receptacle 112 can conform partially or entirely to the exterior surface of the received dental auxiliary 110 to provide mating engagement between the receptacle 112 and the dental auxiliary 110.

The number, geometry, and locations of the receptacles 112 in the palatal expander 100 can correspond to the number, geometry, and locations of the dental auxiliaries 110 on the dental arch 102. In the illustrated embodiment, for example, the palatal expander 100 includes four receptacles 112 at the buccal surface of the first tooth engagement portion 104a and the second tooth engagement portion 104b to receive the four dental auxiliaries 110 on the buccal surfaces of first teeth 108a and the second teeth 108b, respectively. In other embodiments, however, some or all of the receptacles 112 can be configured differently depending on the configuration of the corresponding dental auxiliaries 110, e.g., the palatal expander 100 can alternatively or additionally include one or more receptacles 112 on other surfaces of the first tooth engagement portion 104a and/or the second tooth engagement portion 104b (e.g., lingual surfaces, occlusal surfaces), the palatal expander 100 can include fewer or more receptacles 112, etc.

In some embodiments, the palatal expander 100 includes one or more handles 113 to facilitate placement of the palatal expander 100 on the dental arch 102 and/or removal of the palatal expander 100 from the dental arch 102. The handles 113 can be portions of the gingival edges of the first tooth engagement portion 104a and the second tooth engagement portion 104b that extend laterally (e.g., buccally) outward to facilitate gripping by the patient’s or clinician’s fingers. The handles 113 can extend in a mesial-distal direction along the receptacles 112 formed in the first tooth engagement portion 104a and second tooth engagement portion 104b, e.g., to facilitate pulling and/or bending of the buccal sidewalls of the first tooth engagement portion 104a and the second tooth engagement portion 104b laterally outward to fit over the dental auxiliaries 110 during placement and/or removal of the palatal expander 100. In other embodiments, however, the handles 113 are optional and may be omitted.

The palatal expander 100 can be one of a series of palatal expanders configured to incrementally expand the patient’s palate from a first width toward a second width in a plurality of treatment stages. Each palatal expander in the series can be generally similar to the palatal expander 100 shown in FIG. 1A–1C, but the design of the palatal expander can be customized to the particular treatment stage. For instance, different palatal expanders in the series can have palatal portions 106 with different geometries (e.g., widths, thicknesses) and/or different material properties, depending on the amount of expansion to be achieved during the corresponding treatment stage. Some or all of the palatal expanders in the series can be configured for use with the same dental auxiliaries 110 (e.g., some or all of the dental auxiliaries 110 can remain on the dental arch 102 across multiple treatment stages), or some or all of the palatal expanders in the series can be configured for use with different dental auxiliaries 110 (e.g., some or all of the dental auxiliaries 110 may be removed and/or replaced with other dental auxiliaries 110 for different treatment stages).

As shown in FIG. 1C, the palatal expander 100 can be configured to couple to a secondary dental appliance 114 to secure the secondary dental appliance 114 to the dental arch 102 and/or to facilitate application of force by the secondary dental appliance 114 onto the dental arch 102. The secondary dental appliance 114 can be any dental appliance that includes one or more wires (also referred to herein as a “wire-based appliance”), such as wire and bracket appliances (e.g., buccal braces, lingual braces), headgear, facemasks, retainers, and distalizers. Although FIG. 1C depicts the secondary dental appliance 114 as being placed on the same dental arch 102 as the palatal expander 100, in other embodiments, the secondary dental appliance 114 can be placed on the opposite (lower) dental arch (e.g., for interarch treatments).

Referring to FIGS. 1A and 1C together, the palatal expander 100 can include one or more wire interfaces 116a, 116b (collectively, “wire interfaces 116”) for coupling to one or more wire portions 118a, 118b (collectively, “wire portions 118”) of the secondary dental appliance 114. In the illustrated embodiment, the palatal expander 100 includes a first wire interface 116a for coupling to a first wire portion 118a of the secondary dental appliance 114, and a second wire interface 116b for coupling to a second wire portion 118b of the secondary dental appliance 114. For example, the first wire portion 118a and second wire portion 118b can be two ends of a single wire, or two ends of different wires, as discussed further herein. Although the illustrated embodiment depicts two wire interfaces 116 that couple to two wire portions 118, the number of wire interfaces 116 and wire portions 118 may be varied as desired, e.g., the palatal expander 100 may include a single wire interface 116 for coupling to a single wire portion 118, the palatal expander 100 may include three wire interfaces 116 for coupling to three wire portions 118, and so on.

The wire interfaces 116 can be located at any suitable portion of the palatal expander 100 to receive and accommodate the corresponding wire portions 118 of the secondary dental appliance 114. In the illustrated embodiment, the first wire interface 116a is located on the first tooth engagement portion 104a and the second wire interface 116b is located on the second tooth engagement portion 104b. Alternatively, one or both wire interfaces 116 may be located on the same tooth engagement portion, one or both wire interfaces 116 may be located on the palatal portion 106 instead of on a tooth engagement portion, etc. In the illustrated embodiment, the wire interfaces 116 are located at or near the anterior end of the palatal expander 100 (e.g., anterior to the receptacles 112 and the handles 113, and/or proximate to the mesialmost teeth received by the palatal expander 100). Alternatively, one or both of the wire interfaces 116 may be located at or near the posterior end of the palatal expander 100 (e.g., posterior to the receptacles 112 and/or handles 113, and/or proximate to the distalmost teeth received by the palatal expander 100), or may be located at any suitable position between the anterior and posterior ends of the palatal expander 100 (e.g., between the receptacles 112, on the receptacles 112, and/or above the handles 113). Further, in some embodiments, one or both of the wire interfaces 116 may be located on or near the handles 113. Moreover, although the wire interfaces 116 are depicted as being located on an outer surface of the palatal expander 100 (e.g., the surface facing away from the dental arch 102), one or both of the wire interfaces 116 may alternatively be located on an inner surface of the palatal expander 100 (e.g., the surface facing toward the dental arch 102). Further, although the wire interfaces 116 are shown as being located on the buccal side of the palatal expander 100, one or both of the wire interfaces 116 can instead be located on the lingual side of the palatal expander 100.

In some embodiments, the wire interfaces 116 are configured to removably couple to the wire portions 118 of the secondary dental appliance 114, such that each wire portion 118 may be coupled to and decoupled from the corresponding wire interface 116 when desired, e.g., to allow for removal of the palatal expander 100 and/or removal of the secondary dental appliance 114. Removal of the palatal expander 100 and/or the secondary dental appliance 114 may be desired, for example, to accommodate patient activities (e.g., eating, drinking, routine oral hygiene), for dental examination, when the palatal expander 100 is to be replaced with another palatal expander 100 in the series, when the secondary dental appliance 114 is to be adjusted by a clinician or to be replaced with another secondary dental appliance 114, etc. The palatal expander 100 and the secondary dental appliance 114 may be removed independently of each other (e.g., the palatal expander 100 remains on the dental arch 102 while the secondary dental appliance 114 is removed, or vice-versa), and/or the palatal expander 100 and the secondary dental appliance 114 may be removed together as a single unit. In some embodiments, the palatal expander 100 and the secondary dental appliance 114 are both patient removable. In other embodiments, the palatal expander 100 is patient removable while the secondary dental appliance 114 is not patient removable (e.g., is affixed to the dental arch 102 and/or requires a clinician or other individual besides the patient to remove).

In some embodiments, the coupling between the wire interface 116 and the wire portion 118 affixes the wire portion 118 to the wire interface 116, e.g., the wire portion 118 is maintained in a fixed position and orientation relative to the wire interface 116. Alternatively, the coupling between the wire interface 116 and the wire portion 118 may permit some motion between the wire portion 118 and the wire interface 116, e.g., the wire portion 118 may translate and/or rotate relative to the wire interface 116. The coupling may allow for certain types of movements while constraining other types of movements. For instance, the wire portion 118 may be allowed to translate, such as in a mesial direction only, in a distal direction only, in an occlusal direction only, in a gingival direction only, in a buccal direction only, in a lingual direction only, or suitable combinations thereof (e.g., the wire portion 118 may translate mesially and distally but not in other directions). Alternatively or in combination, the wire portion 118 may be allowed to rotate, such as inward only (e.g., in a buccal-to-lingual direction), outward only (e.g., in a lingual-to-buccal direction), or both.

The permitted movements of the wire portion 118 may be selected according to the dental treatment to be applied to the teeth by the palatal expander 100 and/or the secondary dental appliance 114. For instance, in embodiments where the secondary dental appliance 114 is used to correct a Class II malocclusion, the wire portion 118 may be movable relative to the palatal expander 100 in a distal direction but not in a mesial direction (e.g., to restrict anterior motion of the upper jaw relative to the lower jaw). As another example, in embodiments where the secondary dental appliance 114 is used to reposition the anterior teeth, the wire portion 118 may be movable relative to the palatal expander 100 to accommodate the movements of the anterior teeth during treatment. Moreover, the wire portion 118 can also be movable relative to the palatal expander 100 to accommodate changes in the shape (e.g., width) of the dental arch 102 due to palatal expansion. Control of the movement of the wire portion 118 can also be used to control the direction and/or magnitude of the forces applied to the dental arch 102 by the secondary dental appliance 114.

The wire interfaces 116 of the palatal expander 100 can be any component suitable for removably coupling to the wire portions 118 of the secondary dental appliance 114, e.g., via interference fit, snap fit, fasteners (e.g., elastics, brackets (such as self-ligating brackets), latches, springs, magnets), adhesives, or suitable combinations thereof. For example, the wire interfaces 116 may include one or more apertures (e.g., pockets, channels, slots, grooves, tubes, recesses, cutouts) for receiving the wire portions 118 therein to secure the wire portions 118 to the palatal expander 100. As another example, the wire interfaces 116 may include one or more projections (e.g., hooks, buttons, pegs, prongs, arms) that engage the wire portions 118 to secure the wire portions 118 to the palatal expander 100. If applicable, the wire interfaces 116 can be configured with clearances (e.g., gaps) for the wire portions 118 at the appropriate locations to permit the wire portions 118 to move relative to the wire interfaces 116 in certain directions, while also including interferences (e.g., obstructions) that contact the wire portion 118 at the appropriate locations to constrain movements of the wire portions 118 in other directions.

Similarly, the wire portions 118 of the secondary dental appliance 114 can have any geometry suitable for removably coupling to the wire interfaces 116 of the palatal expander 100. For instance, the wire portions 118 may be formed with hooks, loops, curves, and/or other structures for fitting into or otherwise engaging the wire interfaces 116 to secure the secondary dental appliance 114 thereto. If applicable, the shape of the wire portions 118 can be configured to permit certain movements of the wire portions 118 relative to the wire interfaces 116 while restricting other movements. In some embodiments, the shape of the wire portions 118 is used to apply certain forces to the teeth to control tooth movements, e.g., the wire portions 118 can include vertical loops to allow for vertical movement (e.g., extrusion, intrusion), rotation, etc. Optionally, the wire portions 118 can provide forces to facilitate palatal expansion and/or to improve retention of the dental auxiliary receptacles 112 on the dental auxiliaries 110, e.g., the wire portions 118 may be bent laterally inward and/or twisted axially to apply expansion and/or retention forces to the palatal expander 100. The wire portions 118 can also have a sufficient degree of flexibility and/or elasticity to allow the wire portions 118 to be temporarily deformed to facilitate coupling to or decoupling from the wire interfaces 116, and to allow the wire portions 118 to return to their initial designed shape after coupling/decoupling is complete.

The wire interfaces 116 of the palatal expander 100 may each have the same configuration (e.g., same shape, same coupling mechanism, same types of permitted/constrained movements), or some or all of the wire interfaces 116 may have different configurations (e.g., different shapes, different coupling mechanisms, and/or different types of permitted/constrained movements). Similarly, the wire portions 118 of the secondary dental appliance 114 may each have the same configuration (e.g., same shape, same coupling mechanism, same types of permitted/constrained movements), or some or all of the wire portions 118 may have different configurations (e.g., different shapes, different coupling mechanisms, and/or different types of permitted/constrained movements). The configuration of the wire interfaces 116 and wire portions 118 can be varied as desired, e.g., depending on the types of forces and/or dental treatments to be applied, the patient’s anatomy, clinician preferences, etc.

In embodiments where the palatal expander 100 is one of a series of palatal expanders configured to incrementally expand the patient’s palate, some or all of the palatal expanders in the series can include respective wire interfaces 116 for coupling to the wire portions 118 of the secondary dental appliance 114. Some or all of the palatal expanders in the series can be configured for use with the same secondary dental appliance 114 (e.g., the same secondary dental appliance 114 is used across multiple treatment stages), or some or all of the palatal expanders in the series can be configured for use with different secondary dental appliances 114 (e.g., the secondary dental appliance 114 may be removed and/or replaced with other secondary dental appliances 114 for different treatment stages).

The configuration (e.g., number, shape, location) of the wire interfaces 116 for each palatal expander can be customized to the particular treatment stage. For instance, the location of the wire interfaces 116 can be adjusted at different treatment stages to account for the changing position of the wire portions 118 as the palate is expanded and/or as the geometry of the dental arch 102 changes according to the treatment applied by the secondary dental appliance 114. As another example, the shape of the wire interfaces 116 can be adjusted for different treatment stages to accommodate for different secondary dental appliances 114 that are used in those stages. In a further example, different configurations of wire interfaces 116 can be used to control the degrees of freedom of the wire portions 118 and/or the stresses applied to the wire portions 118, which in turn can influence the forces that are applied to the dental arch 102 by the secondary dental appliance 114. In some embodiments, different palatal expanders in the series can have different wire interfaces 116 to adjust the stresses in the wire portions 118 as desired to enhance the treatment implemented by the secondary dental appliance 114.

In some embodiments, the palatal expander 100 (or a series of palatal expanders) are used to expand the patient’s palate while the secondary dental appliance 114 applies another dental treatment to the patient’s teeth. Examples of dental treatments that may be applied by the secondary dental appliance 114 include any of the following: repositioning of teeth (e.g., anterior teeth of the dental arch 102), correction of malocclusions (e.g., Class II or Class III malocclusions via headgear or interarch treatments), uprighting of teeth (e.g., lingual or buccal uprighting of molars of the lower dental arch), sagittal and/or transverse movements of the dental arch 102 relative to the lower dental arch, correction of posterior crossbite, correction of posterior torque and/or inclination, distalization, and combinations thereof.

The other dental treatment can be applied during any suitable stage of the palatal expansion treatment, such as during one or more stages in which the palate is rapidly expanded, during one or more stages in which the palate is slowly expanded, during one or more stages in which the palate is maintained at a current width, or suitable combinations thereof. In some embodiments, the other dental treatment is started before palatal expansion therapy is started, e.g., the secondary dental appliance 114 is used to treat the dental arch 102 for a time period before any palatal expanders are used. Alternatively, the other dental treatment can be started after palatal expansion therapy is started, e.g., one or more palatal expanders are used on their own before being used in combination with the secondary dental appliance 114. Alternatively, palatal expansion therapy can be started at the same time as the other dental treatment.

Optionally, the palatal expander 100 may be a passive device that is not designed to apply palatal expansion and/or maintenance forces, and instead serves solely provide an anchoring platform for the secondary dental appliance 114. In such embodiments, the only treatment applied to the patient’s teeth may be the dental treatment provided by the secondary dental appliance 114. As used herein, the term “palatal expander” encompasses both active devices that expand the palate and passive devices that serve solely as anchorage.

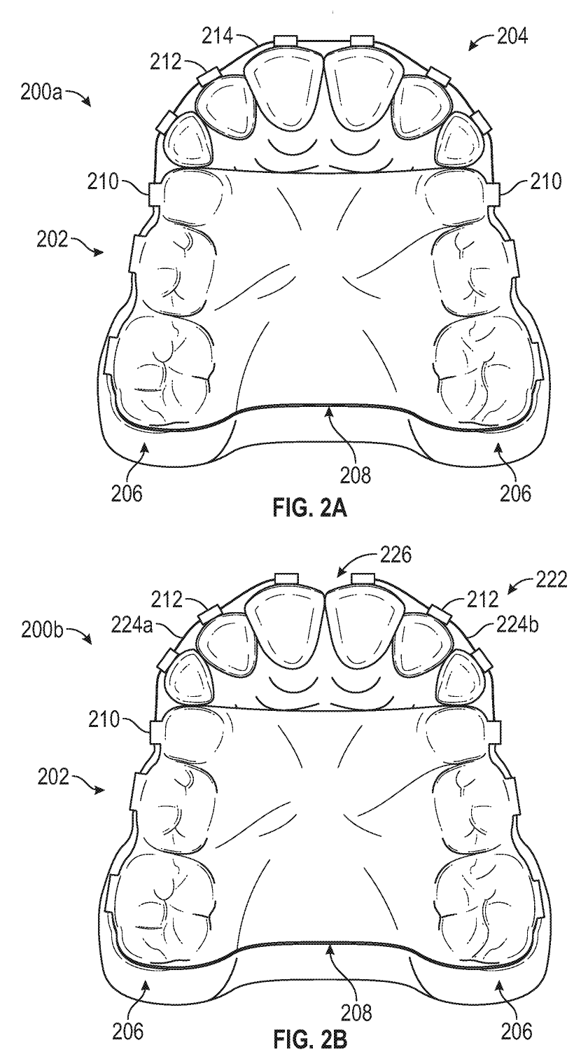

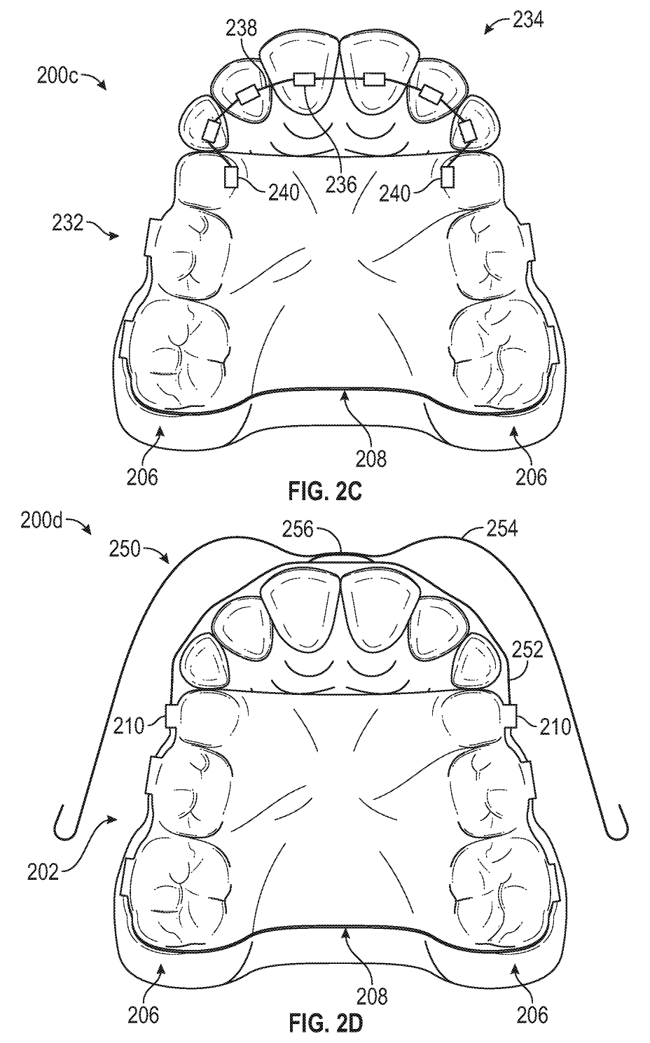

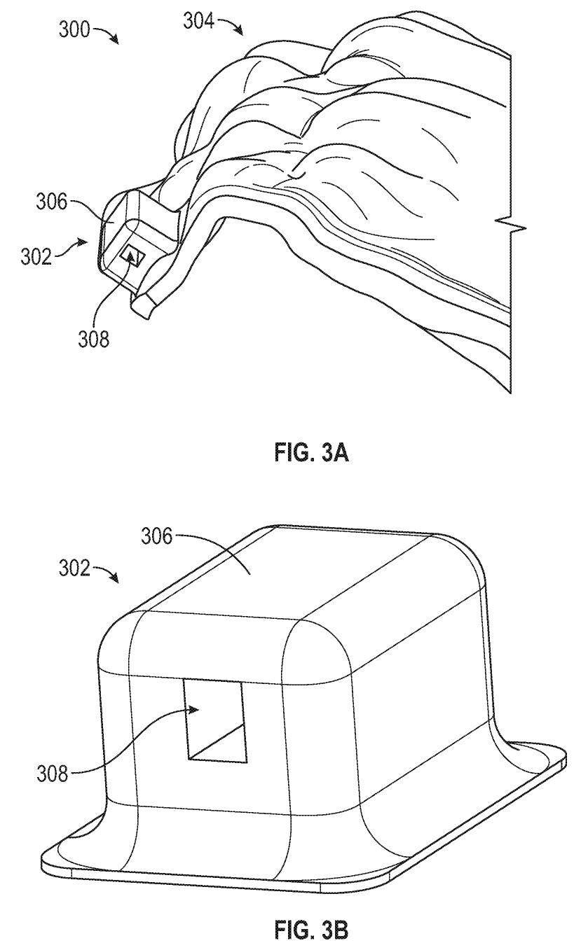

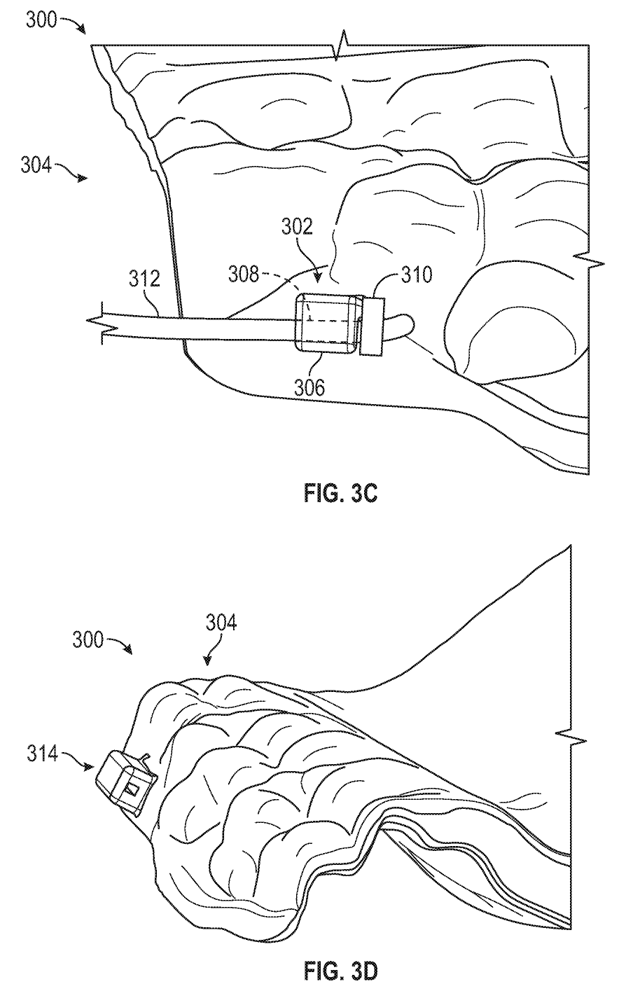

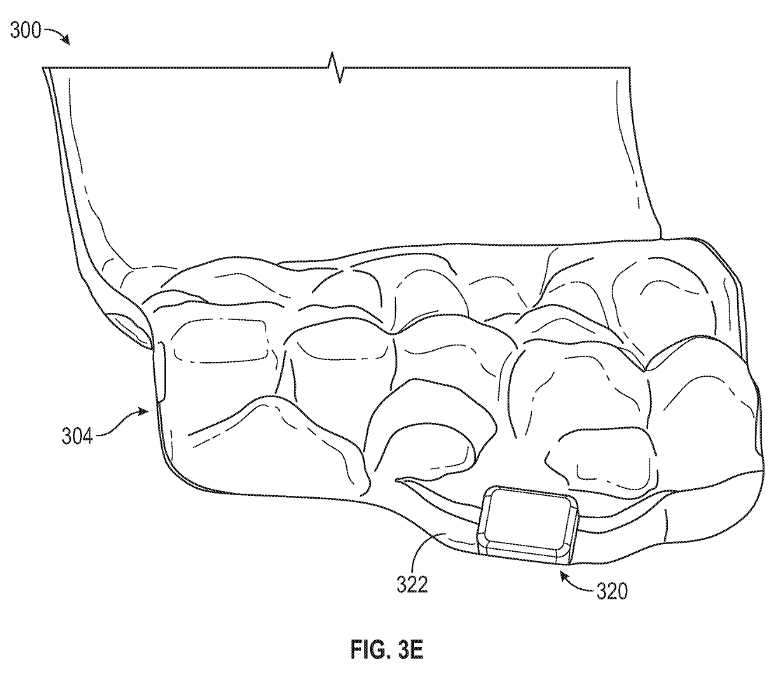

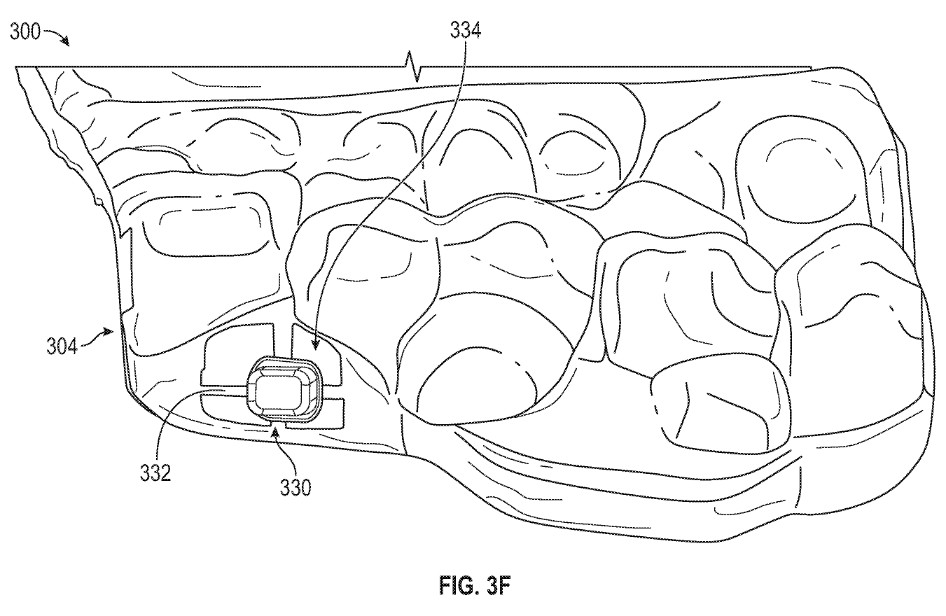

FIG. 2A–2D illustrate representative examples of wire-based appliances that may be used with a palatal expander, and FIG. 3A–11 illustrate representative examples of wire interfaces that may be used in a palatal expander to couple to a wire-based appliance. Any of the embodiments of FIG. 2A–11 may be combined with the embodiments of FIG. 1A–1C and/or with each other.

FIG. 2A is a bottom view of a system 200a including a palatal expander 202 and a wire and bracket appliance 204 on an upper dental arch, in accordance with embodiments of the present technology. The palatal expander 202 can be used to secure the wire and bracket appliance 204 to the dental arch, without requiring the use of molar bands or other non-patient removable anchorage devices. Moreover, the palatal expander 202 can provide palatal expansion therapy while the wire and bracket appliance 204 is used to reposition one or more teeth (e.g., one or more anterior teeth) of the patient’s dental arch.

The palatal expander 202 may be identical or generally similar to the palatal expander 100 of FIG. 1A–1C. For instance, the palatal expander 202 can include a pair of tooth engagement portions 206 configured to receive one or more posterior teeth (e.g., premolars and/or molars) at opposite sides of the dental arch, and a palatal portion 208 between the tooth engagement portions 206 that applies forces to expand the palate. The tooth engagement portions 206 can each include a respective wire interface 210 (e.g., an aperture or projection) for coupling to the wire and bracket appliance 204. The wire interfaces 210 can be located at the buccal sides of the tooth engagement portions 206.

The wire and bracket appliance 204 includes a plurality of brackets 212 bonded to the patient’s teeth and an archwire 214 coupled to the brackets 212. In the illustrated embodiment, the wire and bracket appliance 204 is configured as a set of buccal braces, with the brackets 212 being located on the buccal surfaces of the teeth and the archwire 214 extending along the buccal side of the dental arch.

As shown in FIG. 2A, the ends of the archwire 214 are removably coupled to the wire interfaces 210 of the palatal expander 202, thereby securing the archwire 214 to the palatal expander 202. The coupling between the archwire 214 cand wire interfaces 210 can permit movement of the archwire 214 relative to the palatal expander 202 as the palate expands and/or as the teeth are repositioned. For example, the wire interfaces 210 can be apertures (e.g., pockets, channels, tubes) that receive the ends of archwire 214 and allow the archwire 214 to move therethrough. Optionally, the coupling can be configured to constrain movement of the archwire 214 along certain directions. For instance, the wire interface 210 can include a blocking feature (e.g., a projection such as a peg) at the mesial side that contacts a corresponding obstruction formed in the archwire 214 (e.g., a bend) to constrain movement of the archwire 214 in an anterior direction. A blocking feature may alternatively or additionally be located at the distal side of the wire interface 210 to contact a corresponding obstruction formed in the archwire 214 (e.g., a bend) to constrain movement of the archwire 214 in a posterior direction. Optionally, the coupling may include ratchet features formed in the archwire 214 and/or the wire interface 210 that only allows motion in one direction (e.g., an anterior direction only or a posterior direction only).

In some embodiments, the wire interface 210 is configured to allow for adjustments to the length of the archwire 214 during the course of treatment, e.g., to control the forces applied to the teeth by the wire and bracket appliance 204. For example, the wire interface 210 can include an adjustable sliding coupling (e.g., a self-ligating bracket, a sliding spring clip mechanism, a slide mechanism) that allows the archwire 214 to be pulled and/or pushed through to the appropriate length. As another example, the wire interface 210 can include a channel or tube that allows the archwire 214 to be drawn therethrough and cut to the appropriate length. In a further example, the wire interface 210 can be or include a bracket that is coupled to the archwire 214 via a fastener (e.g., an elastic such as a ligature tie), such that the length of the archwire 214 can be adjusted by removing the fastener and repositioning the archwire 214 in the bracket.

FIG. 2B is a bottom view of a system 200b including a palatal expander 202 and a wire and bracket appliance 222 on an upper dental arch, in accordance with embodiments of the present technology. The palatal expander 202 and the wire and bracket appliance 222 can be identical or generally similar to the corresponding components discussed with respect to FIG. 2A, except that the wire and bracket appliance 222 is segmented into a first archwire 224a and a second archwire 224b (collectively, “archwires 224”). Each archwire 224 is coupled to one or more respective brackets 212 to apply repositioning forces to respective subsets of teeth of the dental arch. One end of each archwire 224 is removably coupled to a respective wire interface 210 at different sides of the palatal expander 202, e.g., the distal end of the first archwire 224a is coupled to the wire interface 210 at the right side of the palatal expander 202 and the distal end of the second archwire 224b is coupled to the wire interface 210 at the left side of the palatal expander 202. The mesial ends of the archwires 224 can be spaced apart from each other to form a gap 226.

The system 200b can allow the anterior teeth of the dental arch to separate transversely outward as the palate is expanded by the palatal expander 202, since diastema formation may be expected and/or optimal for palatal expansion. In some situations, use of a wire and bracket appliance that is not segmented (e.g., includes a single unitary archwire, e.g., as depicted in FIG. 2A) may limit the outward movements of the anterior teeth and thus may constrain palatal expansion. However, a segmented wire and bracket appliance such as the wire and bracket appliance 222 of FIG. 2B can also be used for other purposes, e.g., to allow for independent movements of different subsets of anterior teeth in combination with palatal expansion.

Although FIG. 2B illustrates the wire and bracket appliance 222 as being segmented symmetrically down the middle (e.g., the gap 226 between the archwires 224 is aligned with the midline of the dental arch and the archwires 224 have equal lengths), in other embodiments, the wire and bracket appliance 222 may be segmented asymmetrically (e.g., the gap 226 is offset from the midline of the dental arch and/or the archwires 224 have different lengths). Asymmetrical segmentation may be desirable, for example, to produce a controlled skew in tooth alignment and/or palatal expansion.

Additionally, although FIG. 2B illustrates a segmented archwire configuration having only two segments (e.g., a left segment and a right segment), in some embodiments, there may be more than two segments to allow for greater flexibility and customization in tooth movements during an expansion. For example, there may be three segments (e.g., with one corresponding wire interface on the left side and two corresponding wire interfaces on the right side), four segments (e.g., with two corresponding wire interfaces on the left side and two corresponding wire interfaces on the right side), etc., depending on the patient’s dentition and treatment plan.

In some embodiments, the wire and bracket appliance 222 can include three, four, five, or more separate archwires 224. Each archwire 224 may be coupled to a different subset of teeth and to a respective wire interface 210 at either the left side or the right side of the palatal expander 202. For instance, the palatal expander 202 can include a first wire interface 210 at either the left or right side that is coupled to the distal end of a first archwire 224 that is coupled to a first subset of teeth, a second wire interface 210 at either the left or right side that is coupled to the distal end of a second archwire 224 that is coupled to a second subset of teeth, a third wire interface 210 at either the left or right side that is coupled to the distal end of a third archwire 224 that is coupled to a third subset of teeth, etc. This configuration allows for independent movements ofmultiple teeth that are individually coupled to the palatal expander 202 and/or can be used to reduce reactionary movements between adjacent teeth that are not coupled to the same archwire 224.

FIG. 2C is a bottom view of a system 200c including a palatal expander 232 and a wire and bracket appliance 234 on an upper dental arch, in accordance with embodiments of the present technology. The palatal expander 232 and the wire and bracket appliance 234 can be identical or generally similar to the corresponding components discussed with respect to FIGS. 2A and 2B, except that the wire and bracket appliance 234 is located on the lingual side of the dental arch instead of the buccal side. For instance, the wire and bracket appliance 234 can be a set of lingual braces with lingual brackets 236 on the lingual surfaces of one or more anterior teeth and a lingual archwire 238 extending along the lingual side of the dental arch. Accordingly, the wire interfaces 240 of the palatal expander 232 can be located at the lingual sides of the tooth engagement portions 206 to couple to the distal ends of the lingual archwire 238. In some embodiments, the wire interfaces 240 can be designed to facilitate access and coupling to the lingual archwire 238 by the patient and/or clinician, e.g., the wire interfaces 240 can be vertical tubes or snap fit features, and/or can include increased clearances.

Although FIG. 2C depicts a single lingual archwire 238, in other embodiments, the wire and bracket appliance 234 can be segmented into a plurality of separate lingual archwires 238, with each lingual archwire 238 including one end that is coupled to a respective wire interface 240, e.g., similar to the embodiment of FIG. 2B.

FIG. 2D is a bottom view of a system 200d including a palatal expander 202 and a facebow 250 of a headgear on an upper dental arch, in accordance with embodiments of the present technology. The palatal expander 202 can be used to secure the facebow 250 to the dental arch, without requiring the use of molar bands or other non-patient removable anchorage devices. Moreover, the palatal expander 202 can provide palatal expansion therapy while the facebow 250 applies another treatment to the dental arch. For example, the facebow 250 can be part of a dental headgear configured to adjust (e.g., retract or advance) the upper dental arch relative to the lower dental arch.

In the illustrated embodiment, the facebow 250 includes an inner bow 252 and an outer bow 254 that are connected to each other via a joint 256. The inner bow 252 can be a curved wire that is configured to be positioned in the patient’s mouth proximate to the dental arch. As shown in FIG. 2D, the inner bow 252 can be secured to the dental arch via the palatal expander 202, with the distal ends of the inner bow 252 being removably coupled to the wire interfaces 210 of the palatal expander 202. Optionally, the inner bow 252 can also be coupled to one or more anterior teeth of dental arch (e.g., via brackets, buccal tubes, etc.—not shown). The outer bow 254 can be a curved wire that is configured to be positioned outside of the patient’s mouth and along the patient’s face. The ends of the outer bow 254 can be configured to couple to an external headgear (e.g., a cervical strap or high pull strap) that is worn on the patient’s head.

In some embodiments, the system 200d is used to retract the upper dental arch relative to the lower dental arch to correct a Class II malocclusion. In such embodiments, when the facebow 250 is worn by the patient, the headgear exerts forces on the outer bow 254 in a posterior direction, which are then transmitted to the inner bow 252 via the joint 256, and subsequently to the dental arch via the coupling with wire interfaces 210 of the palatal expander 202. In some embodiments, the coupling between the inner bow 252 and the wire interfaces 210 permits some movement of the inner bow 252 relative to the palatal expander 202 (e.g., sliding to accommodate the expansion of the patient’s palate while the upper dental arch is being retracted).

The geometry of the inner bow 252 and wire interfaces 210 can be configured to facilitate insertion/removal of the inner bow 252, to adjust the forces applied to the upper dental arch via the inner bow 252 and palatal expander 202, and/or to improve patient comfort For example, the wire interface 210 can include a lead in taper to make it easier to guide and insert the ends of the inner bow 252 into the wire interfaces 210. As another example, the inner bow 252 can be bent outwards to increase its transverse width, which can increase palatal expansion forces when the inner bow 252 is coupled to the wire interfaces 210. Alternatively or in combination, the wire interfaces 210 can be shifted closer to buccal sides of the palatal expander 202 to narrow the overall transverse width between the wire interfaces 210, which can further increase palatal expansion forces by compressing the inner bow 252 in a transverse direction. In a further example, the locations of the wire interfaces 210 can be shifted away from the gingival edges and toward the occlusal surfaces of the palatal expander 202 to improve patient comfort, e.g., by providing a better vertical position of the inner bow 252 and the outer bow 254 with respect to the patient’s lips and/or to keep the inner bow 252 away from the patient’s gingiva.

Although FIG. 2D depicts a facebow 250 that is generally used for correction of Class II malocclusions, the palatal expander 202 can also be used with devices for correction of other types of malocclusions, such as facemasks and/or headgear for treating Class III malocclusions. Representative examples of devices for correction of Class III malocclusions suitable for use with the present technology are provided in U.S. Patent Application Publication No. 2024/0299137, the disclosure of which is incorporated by reference herein in its entirety.

Any of the embodiments of FIG. 2A–2D may be combined with each other. For example, a palatal expander can be used with buccal braces (e.g., FIG. 2A) and lingual braces (e.g., FIG. 2C) to apply forces to both the buccal and lingual sides of teeth concurrently. As another example, a palatal expander can be used with braces (e.g., FIG. 2A–2C) and a headgear (e.g., FIG. 2D) to concurrently reposition the teeth while also adjusting the positions of the jaws.

FIG. 3A is a perspective view of a portion of a palatal expander 300 including a wire interface 302 configured as a pocket, and FIG. 3B is a perspective view of the wire interface 302, in accordance with embodiments of the present technology. Referring first to FIG. 3A, the palatal expander 300 may be identical or generally similar to the palatal expander 100 of FIG. 1A–1C. For instance, the palatal expander 300 can include a pair of tooth engagement portions 304 configured to receive one or more posterior teeth at opposite sides of the dental arch, and a palatal portion between the tooth engagement portions that applies forces to expand the palate (only a single tooth engagement portion 304 is shown in FIG. 3A for purposes of simplicity).

The tooth engagement portion 304 includes a wire interface 302 that is configured to couple to a corresponding wire portion of a secondary dental appliance (not shown). In the illustrated embodiment, the wire interface 302 is located on the outer surface of the anterior end of the palatal expander 300. The wire interface 302 can be positioned on the buccal sidewall of the mesialmost tooth receiving cavity of the tooth engagement portion 304, e.g., on the occlusal portion or the gingival portion of the sidewall. In other embodiments, however, the wire interface 302 can be positioned at a different location, such as at the posterior end of the palatal expander 300. For instance, the wire interface 314 can be positioned on the buccal sidewall of the distalmost tooth receiving cavity of the tooth engagement portion 304, e.g., on the occlusal portion or the gingival portion of the sidewall. This configuration can provide more space along the length of the palatal expander 300 to accommodate the wire portion, e.g., if the wire portion includes bends, loops, or other features with a relatively large footprint (such as the U loops in an inner bow of a facebow).

Referring to FIGS. 3A and 3B together, the wire interface 302 includes a body 306 that protrudes outward from the surrounding surface of the palatal expander and an aperture 308 formed in the body 306, thereby defining a pocket for receiving the wire portion of the secondary dental appliance. As best seen in FIG. 3A, the aperture 308 is oriented toward the anterior end of the palatal expander 300, such that the wire portion can be inserted into the aperture 308 in a mesial to distal direction. The geometry of the body 306 and the aperture 308 may be varied as desired. For example, although the body 306 is depicted as having a rectangular prismatic shape, in other embodiments, the body 306 may have a different shape, such as a square prismatic shape, a hexagonal prismatic shape, a cylindrical shape, an oblong shape, etc. The body 306 may be rounded to improve patient comfort. Similarly, although the aperture 308 is depicted as having a rectangular cross-sectional shape (which may be beneficial, e.g., to prevent undesired rotation of the wire portion), the aperture 308 may alternatively have a square cross-sectional shape, a hexagonal cross-sectional shape, a circular cross-section shape, an oval cross-sectional shape, etc. The aperture 308 may extend through the entire mesial to distal length of the body 306 (in which case both ends of the body 306 are open), or may extend only partially through the length of the body 306 (in which case the distal end of the body 306 is closed). In the latter embodiment, the closed distal end of the body 306 may serve as a stop for the wire portion to push against and/or may improve patient comfort by enclosing the end of the wire portion.

In some embodiments, the cross-sectional shape and size of the aperture 308 is selected to conform to the cross-sectional shape and size of the wire portion to be inserted into the aperture 308, e.g., the aperture 308 can have the same shape as the wire portion with a slightly larger size (e.g., height, width, and/or diameter) to provide sufficient clearance for insertion/removal of the wire without slipping. Optionally, the aperture 308 can have the same size or a slightly smaller size (e.g., height, width, and/or diameter) compared to the wire portion to allow for retention of the wire portion via interference fit. In such embodiments, the aperture 308 may not be fully enclosed, but can instead be connected to a thin groove formed in an external surface of the body 306 (e.g., a buccal surface) to facilitate the interference fit. In embodiments where the aperture 308 is rectangular (e.g., to receive a rectangular wire) the aperture 308 can have a height and a width that are each independently selected from the following ranges: from 0.1 mm to 1 mm, 0.1 mm to 0.2 mm, 0.2 mm to 0.4 mm, 0.4 mm to 0.6 mm, 0.6 mm to 0.8 mm, or 0.8 mm to 1 mm. As another example, in embodiments where the aperture 308 is circular (e.g., to receive a round wire), the aperture 308 can have a diameter within a range from 0.5 mm to 2 mm, 0.5 mm to 0.8 mm, 0.8 mm to 1 mm, 1 mm to 1.15 mm, 1.15 mm to 1.5 mm, or 1.5 mm to 2 mm. The mesial to distal length of the aperture 308 can be sufficiently long to ensure secure retention of the wire portion without making it too difficult to insert and remove the wire portion. For example, the length can be within a range from 2 mm to 12 mm, 2 mm to 10 mm, 2 mm to 8 mm, 2 mm to 5 mm, 2 mm to 3 mm, 3 mm to 12 mm, 3 mm to 10 mm, 3 mm to 8 mm, 3 mm to 5 mm, 5 mm to 12 mm, 5 mm to 10 mm, 5 mm to 8 mm, 8 mm to 12 mm, 8 mm to 10 mm, or 10 mm to 12 mm.

FIG. 3C is a side view of the palatal expander 300 and the wire interface 302 with a fastener 310 for securing a wire portion 312, in accordance with embodiments of the present technology. The fastener 310 can be used to prevent the wire portion 312 from slipping out of the aperture 308. In the illustrated embodiment, the aperture 308 extends entirely through the body 306 of the wire interface 302, such that the end of the wire portion 312 protrudes out of the distal side of the body 306. The fastener 310 can be a nut, cap, or other device that locks onto the wire portion 312 to obstruct movement of the wire portion 312 via contact with the body 306. Alternatively, the fastener 310 can be an integral part of (or permanently fixed to) the palatal expander 300 that can be latched over the wire portion 312.

In the illustrated embodiment, the fastener 310 is a distal fastener 310 that is coupled to the wire portion distal to the body 306, thereby preventing the wire portion 312 from moving in a mesial direction relative to the wire interface 302. In such embodiments, the distal fastener 310 can be coupled to the wire portion 312 after the wire portion 312 has been inserted into the aperture 308. Alternatively or in combination, a mesial fastener 310 can be coupled to the wire portion 312 mesial to the body 306 to prevent the wire portion 312 from moving in a distal direction relative to the wire interface 302. In such embodiments, the mesial fastener 310 can be attached to the wire portion 312 before the wire portion 312 is inserted into the aperture 308.

FIG. 3D is a perspective view of a portion of a palatal expander 300 including a reversed wire interface 314, in accordance with embodiments of the present technology. The wire interface 314 can be generally similar to the wire interface 302 of FIG. 3A–3C, except that the wire interface 314 is “reversed” with an aperture 316 facing the posterior end of the palatal expander 300 instead of the anterior end. Thus, a wire portion may be inserted into the aperture 316 in a distal to mesial direction. This configuration may be used in embodiments where the secondary dental appliance pulls against the palatal expander 300 in an anterior direction, such as an archwire or headgear that advances the upper dental arch relative to the lower dental arch for correction of Class III malocclusions. In some embodiments, the wire interface 314 is used with a rectangular wire portion to provide more precise movement and/or reduced tipping of teeth, e.g., compared to conventional Class III treatment devices.

FIG. 3E is a perspective view of a portion of a palatal expander 300 including a wire interface 320 on a handle 322 of the palatal expander 300, in accordance with embodiments of the present technology. The wire interface 320 may be identical or generally similar to the embodiments described with respect to FIG. 3A–3D, except that the wire interface 320 is positioned on the handle 322. As previously described, the handle 322 can be configured to facilitate placement of the palatal expander 300 on the dental arch and/or removal of the palatal expander 300 from the dental arch. For instance, the handle 322 can be a portion of the gingival edge of the tooth engagement portion 304 that is flared laterally (e.g., buccally) outward to facilitate gripping by the patient’s or clinician’s fingers. Because the wire interface 320 is incorporated into the handle 322, the overall prominence of the wire interface 320 may be reduced. Moreover, this configuration can reduce the total number of protruding features present in the palatal expander 300, which may improve patient comfort.

FIG. 3F is a perspective view of a portion of a palatal expander 300 including a wire interface 330 connected to flexible struts 332, in accordance with embodiments of the present technology. The wire interface 330 may be identical or generally similar to the embodiments described with respect to FIG. 3A–3E, except that the wire interface 330 is coupled to the rest of the palatal expander 300 via the struts 332, rather than being formed directly on a surface of the palatal expander 300. Specifically, a window 334 (e.g., a cutout) can be formed in the palatal expander 300 (e.g., in a buccal surface of the tooth engagement portion 304), the wire interface 330 can be positioned in the window 334, and the struts 332 can extend over the window 334 to connect the wire interface 330 to the edges of the palatal expander 300 around the window 334. Although FIG. 3F illustrates four struts 332 connecting the upper, lower, and lateral sides of the wire interface 330 to the surrounding portions of the palatal expander 300, in other embodiments, the number and configuration of struts 332 can be varied as desired (e.g., the palatal expander 300 may include fewer or more struts 332, the struts 332 can connect to different portions of the wire interface 330).

In some embodiments, the struts 332 are elastic spring-like members that confer a controlled degree of stiffness to the wire interface 330, thereby allowing the wire interface 330 to be elastically displaced by a desired amount in response to an applied force. Conversely, the forces generated by elastic resistance of the wire interface 330 to displacement can be transmitted to the palatal expander 300 and/or to the secondary dental appliance coupled to the wire interface 330, and subsequently to the patient’s upper dental arch. The stiffness of the wire interface 330 may be controlled, for example, by adjusting the geometry of the struts 332 (e.g., thickness, length, cross-sectional shape), locations of the struts 332, geometry of the window 334 (e.g., size, shape), geometry of the surrounding portions of the palatal expander 300 (e.g., thickness), geometry of the wire interface 330 (e.g., the shape of the aperture in the wire interface 330 that receives the wire portion), and/or the position and orientation of the wire interface 330 with respect to the window 334 and struts 332. This controlled stiffness can affect how the wire interface 330 engages and interacts with the wire portion of the secondary dental appliance. For example, a lower stiffness can reduce the amount of force needed to insert the wire portion into the wire interface 330 and/or remove the wire portion from the wire interface 330, thereby making it easier to couple and decouple the secondary dental appliance from the palatal expander 300. Moreover, the stiffness of the wire interface 330 can be used to control the magnitude and direction of the forces that are applied to the upper dental arch via the palatal expander 300 and secondary dental appliance. For instance, in embodiments where the palatal expander 300 and secondary dental appliance are used to treat a Class II malocclusion, the stiffness of the wire interface 330 can be used to produce forces that inhibit anterior motion of the upper dental arch relative to the lower dental arch and/or to control the degree of rotation of the upper dental arch.

In embodiments where the palatal expander 300 is one of a series of palatal expanders that are sequentially applied to the upper dental arch, the configuration of the wire interface 330 can be customized for each palatal expander, depending on the forces and treatment goals for the corresponding treatment stage. For instance, the position of the wire interface 330 relative to the rest of the palatal expander 300 can be adjusted to account for movements of the upper dental arch over time (e.g., anterior/posterior movements, vertical movements, lateral movements) to ensure that the desired force is maintained across different treatment stages. As another example, the forces produced by the wire interface 330 can be adjusted depending on the movements to be achieved for a particular treatment stage (e.g., posterior movement only versus combined posterior and vertical movements). In a further example, the forces produced by the wire interface 330 can be varied over time. In some embodiments, the magnitude of the force increases over time to correlate with the biological response of the tissues of the upper dental arch to treatment. Optionally, patient monitoring data such as sensor data, intraoral scan data, image data, etc., can be used to evaluate the biological response to treatment, which in turn may be used to adjust the design of palatal expanders used for subsequent treatment stages.

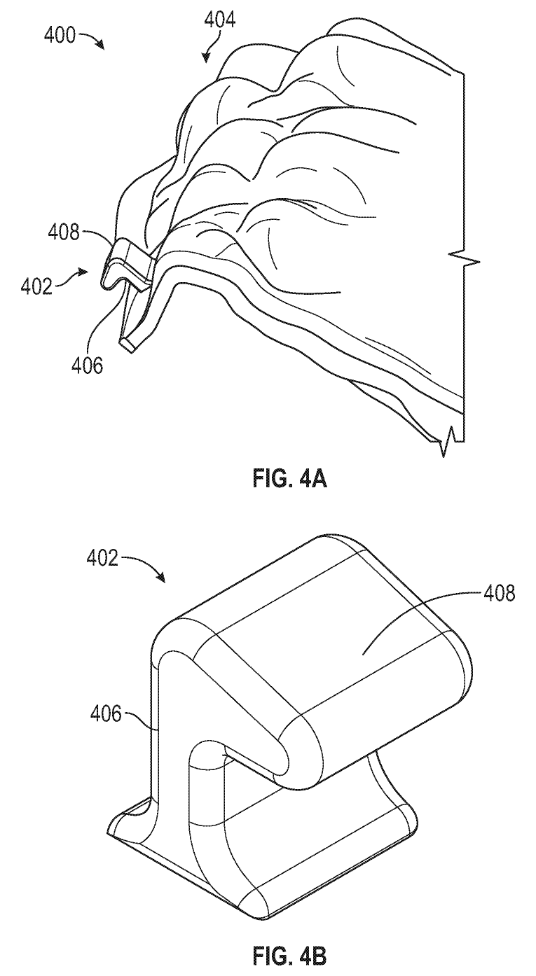

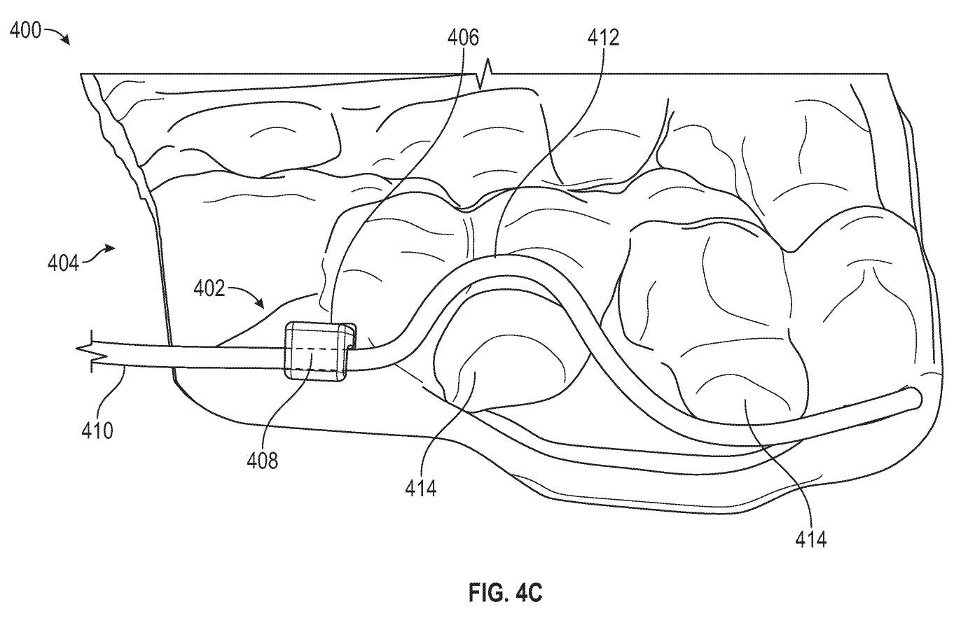

FIG. 4A is a perspective view of a portion of a palatal expander 400 including a wire interface 402 configured as a snap fit feature, and FIG. 4B is a perspective view of the wire interface 402, in accordance with embodiments of the present technology. Referring first to FIG. 4A, the palatal expander 400 may be identical or generally similar to the palatal expander 100 of FIG. 1A–1C. For instance, the palatal expander 400 can include a pair of tooth engagement portions configured to receive one or more posterior teeth at opposite sides of the dental arch, and a palatal portion between the tooth engagement portions that applies forces to expand the palate (only a single tooth engagement portion 404 is shown in FIG. 4A for purposes of simplicity).

The tooth engagement portion 404 includes a wire interface 402 that is configured to couple to a corresponding wire portion of a secondary dental appliance (not shown). In the illustrated embodiment, the wire interface 402 is located on the outer surface of the anterior end of the palatal expander 400. The wire interface 402 can be positioned on the buccal sidewall of the mesialmost tooth receiving cavity of the tooth engagement portion 404, e.g., on the occlusal portion or the gingival portion of the sidewall. In other embodiments, however, the wire interface 402 may be positioned differently, as discussed elsewhere herein.

Referring to FIGS. 4A and 4B together, the wire interface 402 includes a projection 406 that protrudes outward from the surrounding surface of the palatal expander 400. The end of the projection 406 is formed into a hook 408 for engaging the wire portion of the secondary dental appliance via snap fit. Accordingly, the wire portion can be coupled to the wire interface 402 by placing the wire portion into the opening under the hook 408 and then pulling upward to engage the snap fit. The geometry of the hook 408 (e.g., shape, size) can be adjusted as desired to conform to the cross-sectional shape of the wire portion and/or to provide sufficient clearance for easy coupling/decoupling without unwanted slipping. Although FIG. 4A displays the projection 406 and hook 408 oriented such that the opening of the hook 408 is toward the gingival direction, the projection 406 and hook 408 may be oriented in any suitable direction (e.g., such that the opening is toward the occlusal direction).

FIG. 4C is a side view of the palatal expander 400 and the wire interface 402, in accordance with embodiments of the present technology. In the illustrated embodiment, the secondary dental appliance coupled to the palatal expander 400 includes a wire portion 410 having a bend 412 formed therein (e.g., such as an inner bow with a U loop). The section of the wire portion 410 mesial to the bend 412 can be coupled to the palatal expander 400 via snap fit with the hook 408, as discussed above. As shown in FIG. 4C, in some embodiments, when the wire portion 410 is engaged with the hook 408, the bend 412 can wrap around one or more dental auxiliary receptacles (e.g., the distalmost dental auxiliary receptacles 414) in the palatal expander 400, thereby further securing the wire portion 410 to the palatal expander 400.

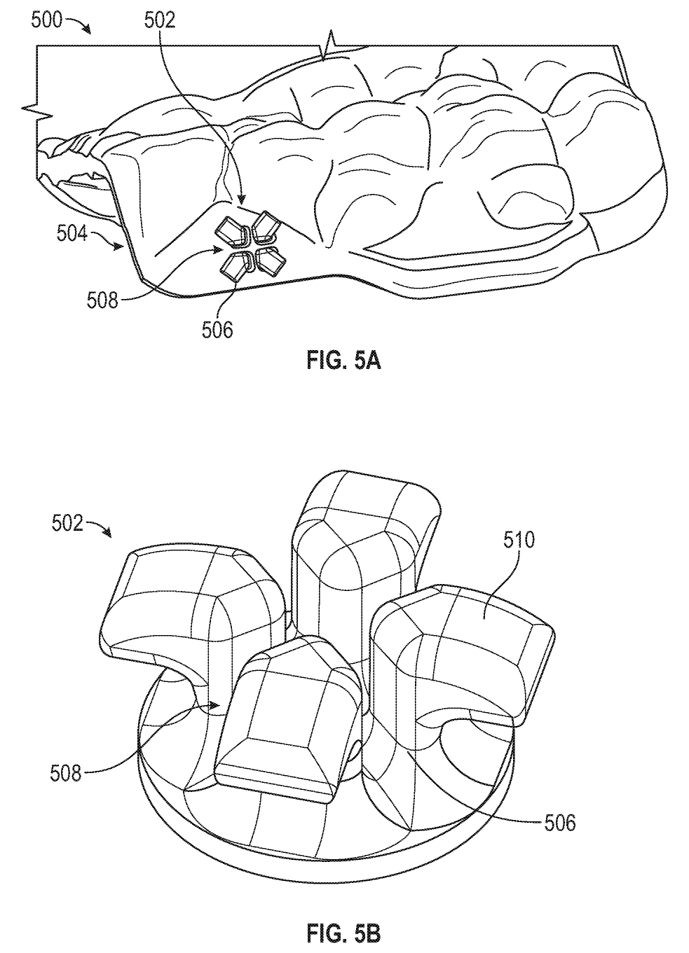

FIG. 5A is a side view of a portion of a palatal expander 500 including a wire interface 502 configured to receive an elastic, and FIG. 5B is a perspective view of the wire interface 502, in accordance with embodiments of the present technology. Referring first to FIG. 5A, the palatal expander 500 may be identical or generally similar to the palatal expander 100 of FIG. 1A–1C. For instance, the palatal expander 500 can include a pair of tooth engagement portions configured to receive one or more posterior teeth at opposite sides of the dental arch, and a palatal portion between the tooth engagement portions that applies forces to expand the palate (only a single tooth engagement portion 504 is shown in FIG. 5A for purposes of simplicity).

The tooth engagement portion 504 includes a wire interface 502 that is configured to couple to a corresponding wire portion of a secondary dental appliance (not shown). In the illustrated embodiment, the wire interface 502 is located on the outer surface of the anterior end of the palatal expander 500. The wire interface 502 can be positioned on the buccal sidewall of the mesialmost tooth receiving cavity of the tooth engagement portion 504, e.g., on the occlusal portion or the gingival portion of the sidewall. In other embodiments, however, the wire interface 502 may be positioned differently, as discussed elsewhere herein.

Referring to FIGS. 5A and 5B together, the wire interface 502 includes a plurality of projections 506 that protrude outward from the surrounding surface of the palatal expander 500. For example, the projections 506 can include a pair of upper projections 506 and a pair of lower projections 506. The upper projections 506 can be spaced apart from the lower projections 506 to define a groove 508 that extends in a mesial to distal direction. The groove 508 can be sized to receive the wire portion of the secondary dental appliance, e.g., the width of the groove 508 can be substantially similar to the width/diameter of the wire portion. As best seen in FIG. 5B, each of the projections 506 can include an outward-facing hook 510. After the wire portion is placed in the groove 508, an elastic can be wrapped around the projections 506 under the hooks 510 to secure the wire portion into the wire interface 502, e.g., similar to a dental ligature. Although FIG. 5B illustrates four projections 506, any suitable number of projections may be used (e.g., three projections, five projections). And although FIG. 5B illustrates hooks 510 to secure the wire portion, any suitable securing mechanism may be used.

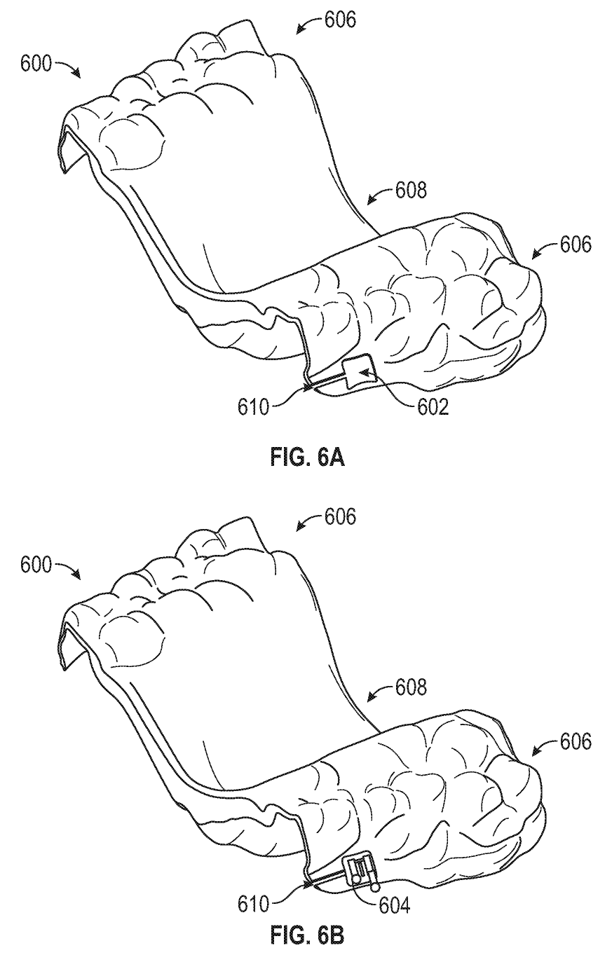

FIGS. 6A and 6B are perspective views of a palatal expander 600 including an aperture 602 for receiving a bracket 604, in accordance with embodiments of the present technology. The palatal expander 600 may be identical or generally similar to the palatal expander 100 of FIG. 1A–1C. For instance, the palatal expander 600 can include a pair of tooth engagement portions 606 configured to receive one or more posterior teeth at opposite sides of the dental arch, and a palatal portion 608 between the tooth engagement portion 606 that applies forces to expand the palate.

Referring first to FIG. 6A, one or both of the tooth engagement portions 606 includes an aperture 602 (e.g., a slot or recess) formed therein. In the illustrated embodiment, the aperture 602 is located at the anterior end of the palatal expander 600. The aperture 602 can be positioned on the buccal sidewall of the mesialmost tooth receiving cavity of the tooth engagement portion 606, e.g., on the occlusal portion or the gingival portion of the sidewall. In other embodiments, however, the aperture 602 may be positioned differently, as discussed elsewhere herein.

The geometry (e.g., size, shape) of the aperture 602 can be configured to receive a bracket 604 (FIG. 6B) that serves as a wire interface for coupling to a wire portion of a secondary dental appliance (not shown). For example, a patient may be able to flex the palatal expander 600 over the bracket 604 (which may be bonded to one of the patient’s teeth), positioning the aperture 602 over the bracket 604, and release the palatal expander 600 such that the bracket 604 is positioned within the aperture 602 (e.g., with the bracket 604 extending buccally outward from the palatal expander surface to allow for access and use as a wire interface). Optionally, the palatal expander 600 can include a notch 610 connected to the aperture 602, where the notch 610 receives the wire portion of the secondary dental appliance so that the palatal expander 600 can be placed and removed without interfering with (e.g., contacting) the wire portion.

The bracket 604 can be a self-ligating bracket or other similar device suitable for removably coupling to the wire portion (e.g., with or without elastics). In some embodiments, the palatal expander 600 is fabricated with the aperture 602 (e.g., via additive manufacturing). The bracket 604 may be placed into the aperture 602 in a subsequent assembly process (e.g., by the manufacturer of the palatal expander 600 or by the clinician). The bracket 604 can be secured to the aperture 602 via interference fit, snap fit, adhesives, bonding, fasteners, etc. Alternatively, the bracket 604 can be mounted on a tooth instead of being incorporated into the palatal expander 600. Under either approach, the palatal expander 600 can be used with customized or off-the-shelf brackets (e.g., metal brackets customarily used for braces), which may secure the wire portion with less risk of shifting or sliding compared to other coupling techniques.

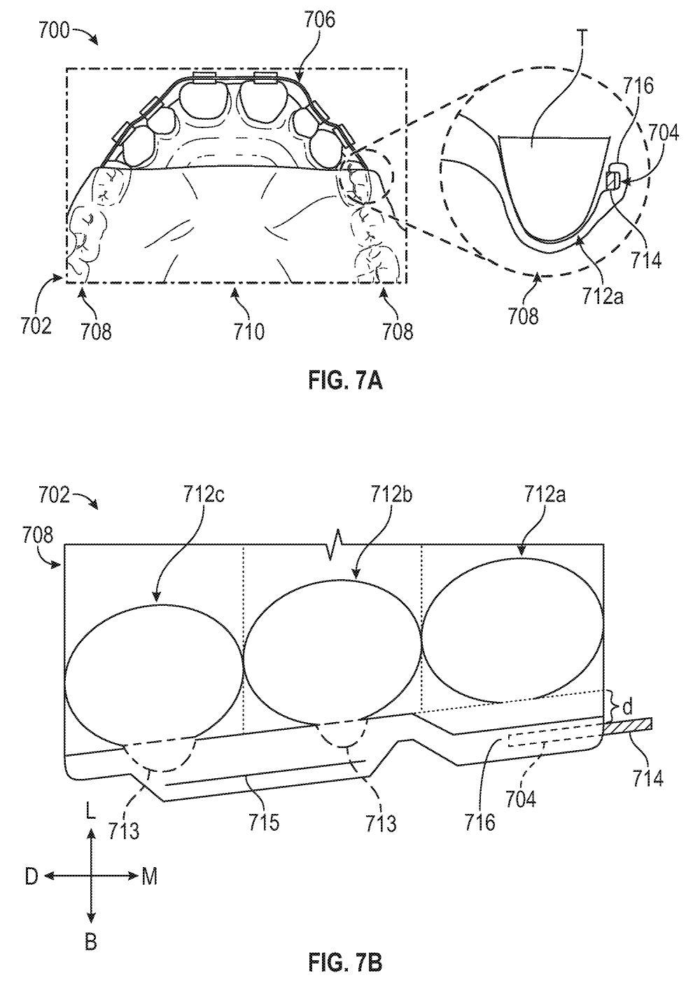

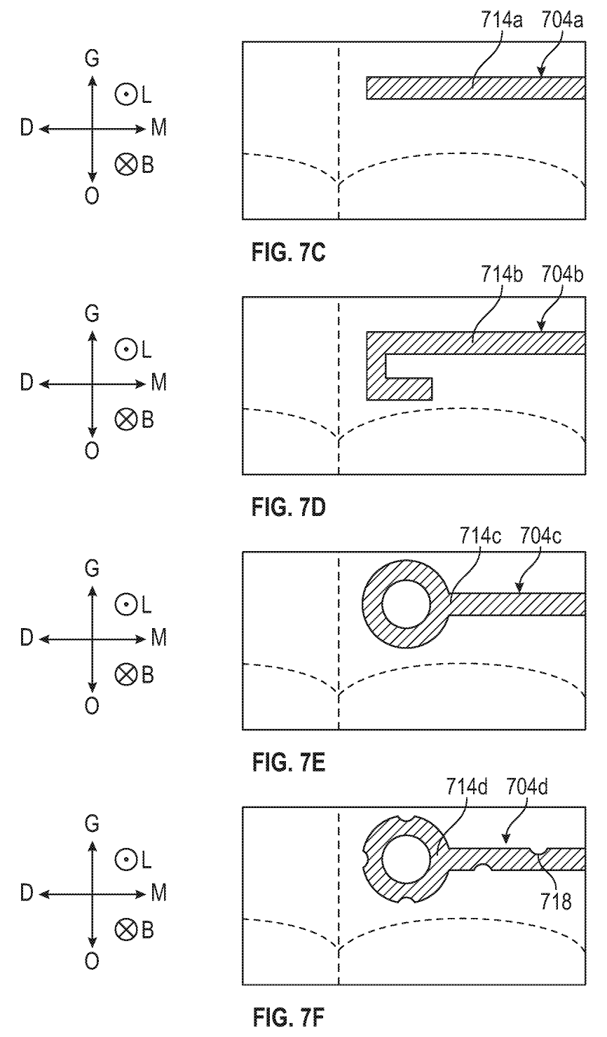

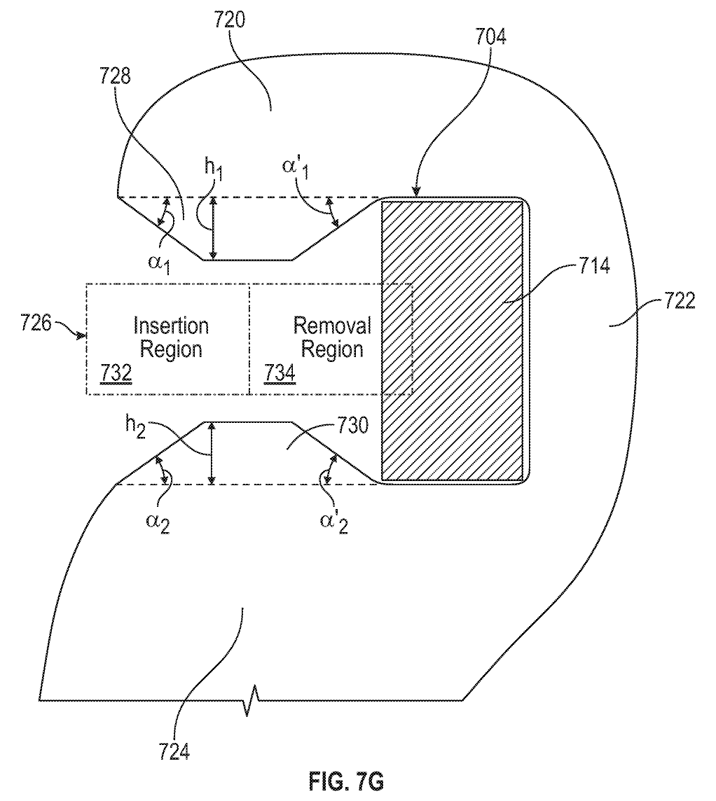

FIG. 7A–7G illustrate a system 700 including a palatal expander 702 with a longitudinal internal channel 704 for coupling to a secondary dental appliance 706, in accordance with embodiments of the present technology. Specifically, FIG. 7A is a bottom view of the palatal expander 702 and the secondary dental appliance 706 on a dental arch, FIG. 7B is a partially schematic top view of an occlusal portion of the palatal expander 702, and FIG. 7C–7G illustrate example geometries for the channel 704 of the palatal expander 702.

Referring first to FIG. 7A, the palatal expander 702 can be identical or generally similar to the palatal expander 100 of FIGS. 1A–1C. For instance, the palatal expander 702 can include a pair of tooth engagement portions 708 configured to receive one or more posterior teeth at opposite sides of the dental arch, and a palatal portion 710 between the tooth engagement portion 708 that applies forces to expand the palate. The palatal expander 702 can include one or more wire interfaces for removably coupling to the secondary dental appliance 706, which may be a wire and bracket appliance (e.g., as depicted in FIG. 7A) or any of the other wire-based appliances described herein.

As best seen in the inset of FIG. 7A (showing a front cross-sectional view of the tooth engagement portion 708), the wire interface can be a channel 704 located in an inner surface of the tooth engagement portion 708 of the palatal expander 702. In the illustrated embodiment, the channel 704 is located in the buccal side of the tooth engagement portion 708, at the inner surface of the buccal sidewall of a cavity 712a for a tooth T.

Referring next to FIG. 7B, the channel 704 can be formed in the anterior end of the palatal expander 702 and can extend longitudinally in a mesial (M) to distal (D) direction toward the distal end of the palatal expander 702. In the illustrated embodiment, the channel 704 extends along the mesialmost cavity 712a only, and terminates before the middle cavity 712b and distalmost cavity 712c (e.g., to avoid interfering with the dental auxiliary receptacles 713 of the middle cavity 712b and the distalmost cavity 712c and/or with the handle 715 of the tooth engagement portion 708). In other embodiments, however, the channel 704 can also extend along the middle cavity 712b and/or the distalmost cavity 712c (e.g., at a location that does not intersect the dental auxiliary receptacles 713 and/or the handle 715).

The channel 704 can be configured to receive and couple to a wire portion 714 of the secondary dental appliance 706 (e.g., an end of an archwire or facebow of a headgear). When the wire portion 714 is inserted into the channel 704, the wire portion 714 can be positioned between the buccal surface of the tooth T and the inner surface of the buccal sidewall of the tooth engagement portion 708. The channel 704 can be located above the gingival line of the cavity 712a so that the wire portion 714 does not contact the patient’s gingiva when the wire portion 714 is received within the channel 704. The upper (gingival) side of the channel 704 can be bounded by an overhang 716 (e.g., which may be part of the gingival edge of the palatal expander 702) to retain the wire portion 714 within the channel 704 and prevent slipping in a gingival direction.

Optionally, as shown in FIG. 7B, the channel 704 can be designed to provide a clearance distance d (e.g., a gap or offset) between the wire portion 714 and the tooth T. The clearance distance d can be any suitable amount, such as within a range from 0.1 mm to 2 mm, 0.1 mm to 0.25 mm, 0.25 mm to 0.5 mm, 0.5 mm to 0.75 mm, 0.75 mm to 1.5 mm, or 1.5 mm to 2 mm. The presence of the clearance distance d may be advantageous for avoiding patient discomfort due to rubbing of the wire portion 714 against the tooth surface. Moreover, the clearance distance d can allow the palatal expander 702 to provide control of rotation of the wire portion 714 around its longitudinal axis, since the palatal expander 702 can push against the wire portion 714 rather than pushing against the tooth T. In other embodiments, however, the clearance distance d is optional and may be omitted (e.g., the wire portion 714 can be in direct contact with the tooth T when received within the channel 704).

The geometry of the channel 704 can be selected to conform to the geometry of the wire portion 714. For example, the channel 704 can have substantially the same size (e.g., height, width, and/or depth) as the wire portion 714, e.g., with sufficient clearance to allow the wire portion 714 to be inserted therein without slipping (e.g., via interference fit or snap fit). The shape of the channel 704 can also match or be substantially similar to the shape of the wire portion 714. In some embodiments, the geometry of the channel 704 is also used to control the movement of the wire portion 714 and/or to control the forces exerted onto the wire portion 714 by the palatal expander 702. For instance, the channel 704 can be designed with interferences that contact the wire portion 714 at certain locations to restrict movement of the wire portion 714 and/or to apply force to the wire portion 714, e.g., contact between the distal sidewall of the channel 704 and the distal end of the wire portion 714 can prevent the wire portion 714 from moving in a distal direction and/or can push the wire portion 714 in a mesial direction; contact between the upper sidewall of the channel 704 and the upper surface of the wire portion 714 can prevent the wire portion 714 from moving upward and/or can push the wire portion 714 downward, etc.

FIG. 7C–7G illustrate example geometries that may be used for the channel 704 and wire portion 714, in accordance with embodiments of the present technology. For instance, FIG. 7C is a partially schematic side view of a straight channel 704a for receiving a straight wire portion 714a, in accordance with embodiments of the present technology. This configuration can allow the palatal expander 702 to exert forces onto the wire portion 714a in up to four directions: in a gingival (G) direction, in an occlusal (O) direction, in a mesial (M) direction, and in a lingual (L) direction (the direction out of the sheet in FIG. 7C).

FIG. 7D is a partially schematic side view of a curved (e.g., hooked) channel 704b for receiving a curved (e.g., hooked) wire portion 714b, in accordance with embodiments of the present technology. This configuration can allow the palatal expander 702 to exert forces on the wire portion 714b in up to five directions: in a gingival direction, in an occlusal direction, in a mesial direction, in a distal (D) direction, and in a lingual direction (the direction out of the sheet in FIG. 7D).

FIG. 7E is a partially schematic side view of a channel 704c with an annular end for receiving a wire portion 714c with an annular end, in accordance with embodiments of the present technology. This configuration can allow the palatal expander 702 to exert forces on the wire portion 714c in up to five directions: in a gingival direction, in an occlusal direction, in a mesial direction, in a distal direction, and in a lingual direction (the direction out of the sheet in FIG. 7E).

FIG. 7F is a partially schematic side view of a channel 704d with a plurality of protrusions 718 for receiving a wire portion 714d, in accordance with embodiments of the present technology. The protrusion 718 can serve as snap fit features for retaining the wire portion 714d in the channel 704d. The configuration (e.g., location, size, spacing, shape) of the protrusions 718 can also be selected to balance ease of insertion/removal of the wire portion 714d with secure retention of the wire portion 714d in the channel 704d. Moreover, the configuration of the protrusions 718 can be selected to apply forces to the wire portion 714d in any desired direction. Although the channel 704d and wire portion 714d are illustrated as being similar to the channel 704c and wire portion 714c of FIG. 7E, it will be appreciated that the protrusions 718 can be implemented with any of the other embodiments described herein, such as the embodiments of FIGS. 7C and 7D.

FIG. 7G is a front cross-sectional view of the channel 704 and wire portion 714, in accordance with embodiments of the present technology. In the illustrated embodiment, the channel 704 is designed to couple to the wire portion 714 via snap fit. As shown in FIG. 7G, the channel 704 is defined by an upper sidewall 720, a lateral sidewall 722, and a lower sidewall 724. The wire portion 714 can be inserted into the channel 704 via a lateral opening 726 between the upper sidewall 720 and the lower sidewall 724 that is opposite the lateral sidewall 722. The interior corners of the channel 704 may be rounded to reduce stress concentration.

In the illustrated embodiment, the upper sidewall 720 includes an upper projection 728 and the lower sidewall 724 includes a lower projection 730. The upper projection 728 and the lower projection 730 can extend partially into the lateral opening 726, such that the size and shape of the upper projection 728 and lower projection 730 control the resistance to insertion and removal of the wire portion 714 into and out of the channel 704, e.g., depending on the amount of interference between the upper projection 728 and the lower projection 730 with the wire portion 714 during the insertion and removal process. Specifically, the features of the upper projection 728 and the lower projection 730 that are proximate to the outer side of the lateral opening 726 (e.g., “insertion region 732”) may affect insertion of the wire portion 714 into the channel 704, since these features may come into contact with the wire portion 714 during the insertion process. Similarly, the features of the upper projection 728 and the lower projection 730 that are proximate to the inner side of the lateral opening 726 (e.g., “removal region 734”) may affect removal of the wire portion 714 from the channel 704, since these features may come into contact with the wire portion 714 during the removal process. That is, the projections enable a snap-fit securing of the wire portion 714, providing a resistance to insertion based at least in part on α₁and α₂ and a resistance to removal based on α’₁and α’₂.

In the illustrated embodiment, the upper projection 728 and the lower projection 730 are chamfered and/or tapered (e.g., trapezoidal) structures. The height h₁ of the upper projection 728 and the height h₂ of the lower projection 730 can determine the clearance for the wire portion 714 and/or the amount of bending of the palatal expander 702 to insert/remove the wire portion 714 from the channel 704. The angle α₁ of the upper projection 728 and the angle α₂ of the lower projection 730 can determine the resistance to (and thus ease of) insertion of the wire portion 714 into the channel 704, and can be within a range from 0° to 90°, 0° to 15°, 15° to 30°, 30° to 45°, 45° to 60°, 60° to 75°, or 75° to 90°; and/or can be less than 90°. Optionally, the outer surface of the upper projection 728 proximate to the angle α₁ can be configured as a ramp to guide the wire portion 714 into the channel 704. The angle α’₁ of the upper projection 728 and the angle α’₂ of the lower projection 730 can determine the resistance to (and thus ease of) removal of the wire portion 714 into the channel 704, and can be within a range from 0° to 90°, 0° to 15°, 15° to 30°, 30° to 45°, 45° to 60°, 60° to 75°, or 75° to 90°; and/or can be less than 90°.

Although the upper projection 728 and the lower projection 730 are depicted as having the same geometry, in other embodiments, the upper projection 728 and the lower projection 730 may have different geometries (e.g., different heights and/or angles). Moreover, although the upper projection 728 and the lower projection 730 are illustrated as being symmetrical (e.g., the features at the insertion side are identical to the features at the removal side), in other embodiments, the upper projection 728 and/or the lower projection 730 may instead be asymmetrical.

Referring again to FIG. 7A, in some embodiments, coupling of the palatal expander 702 to the secondary dental appliance 706 is performed as follows. The secondary dental appliance 706 can already be in place on the dental arch before the palatal expander 702 is applied to the teeth. To place the palatal expander 702 on the teeth, one or both handles 715 of the palatal expander 702 can be pulled laterally outward and over the teeth and wire portion 714 at the corresponding side of the dental arch. The palatal expander 702 can be adjusted by manipulating the handle 715 until the wire portion 714 at each side is aligned with and slots into the respective channel 704, at which point the handle 715 can be released to leave the palatal expander 702 in place on the dental arch and coupled to the secondary dental appliance 706. Optionally, pressure may be applied to the outer surfaces of the buccal sidewalls of the tooth engagement portions 708 to engage the wire portions 714 within the channels 704 via snap fit or interference fit.

To decouple the palatal expander 702 from the secondary dental appliance 706, one or both handles 715 of the palatal expander 702 can be pulled laterally outward until the wire portion 714 at each side disengages from the respective channel 704. The palatal expander 702 can then be removed from the dental arch while leaving the secondary dental appliance 706 in place. In some embodiments, a second palatal expander 702 can then be applied to the dental arch and coupled to the secondary dental appliance 706 (e.g., the next palatal expander in the series of palatal expanders), where the different palatal expander 702 may or may not have the same channel geometry as the initial palatal expander 702, as discussed elsewhere herein.

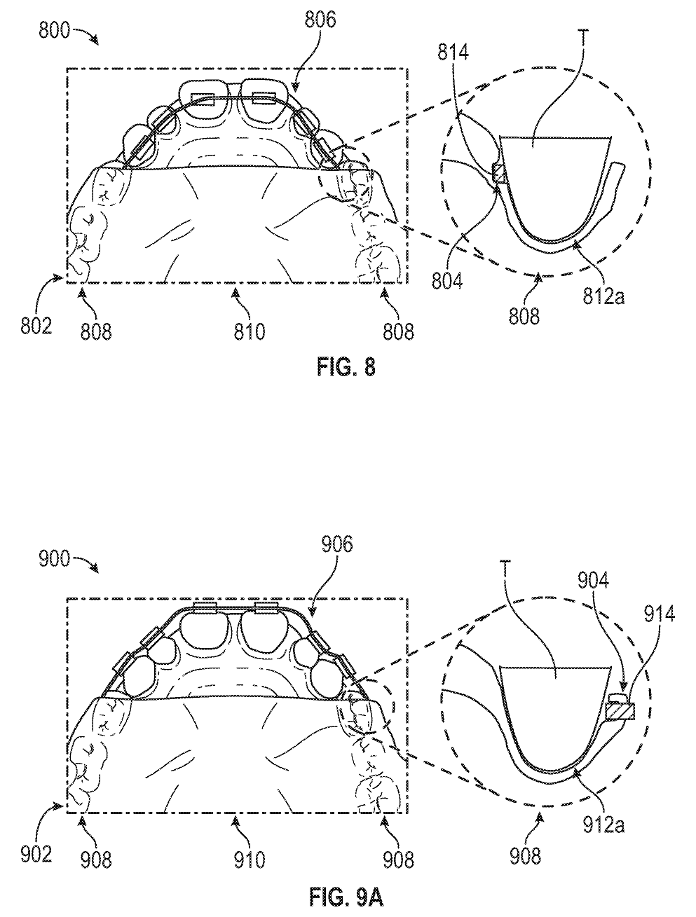

FIG. 8 is a bottom view of a system 800 including a palatal expander 802 with a longitudinal internal channel 804 for coupling to a secondary dental appliance 806, in accordance with embodiments of the present technology. The system 800 can be generally similar to the system 700 of FIG. 7A–7G, except that channel 804 is located in the lingual side of the inner surface of the tooth engagement portion of the palatal expander 802, rather than at the buccal side.

The palatal expander 802 can be identical or generally similar to the palatal expander 100 of FIG. 1A–1C. For instance, the palatal expander 802 can include a pair of tooth engagement portions 808 configured to receive one or more posterior teeth at opposite sides of the dental arch, and a palatal portion 810 between the tooth engagement portion 808 that applies forces to expand the palate. As best seen in the inset of FIG. 8 (showing a front cross-sectional view of the tooth engagement portion 808), the wire interface of the palatal expander 802 can be a channel 804 located in an inner surface of the tooth engagement portion 808 of the palatal expander 802. In the illustrated embodiment, the channel 804 is located in the lingual side of the tooth engagement portion 808, at the inner surface of the lingual sidewall of a cavity 812a for a tooth T.

In the illustrated embodiment, the secondary dental appliance 806 includes a wire portion 814 located at the lingual side of the dental arch. For instance, the secondary dental appliance 806 can be lingual braces and the wire portion 814 can be a lingual archwire. Accordingly, the channel 804 can serve as a wire interface for removably coupling to the wire portion 814 at the lingual side of the dental arch to secure the secondary dental appliance 806 to the palatal expander 802. The channel 804 and the wire portion 814 can include any of the features described herein, e.g., in connection with the embodiments of FIG. 7A–7G.

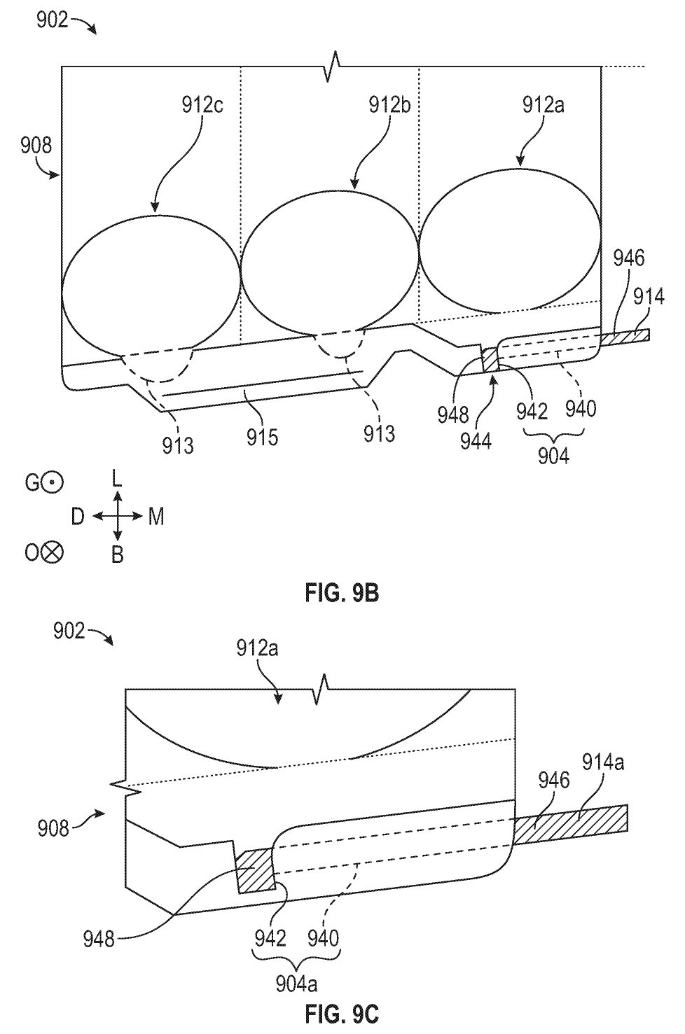

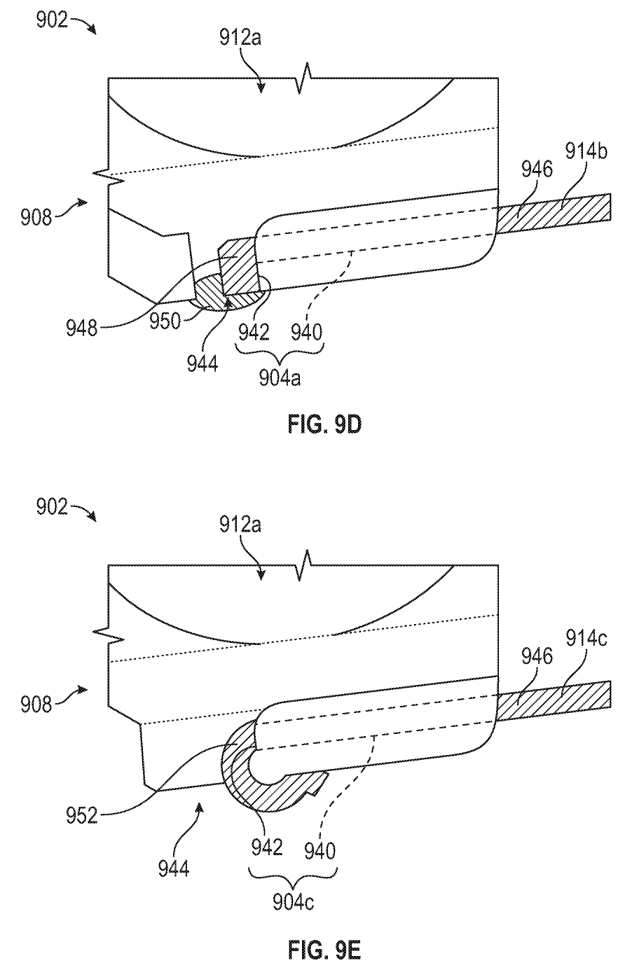

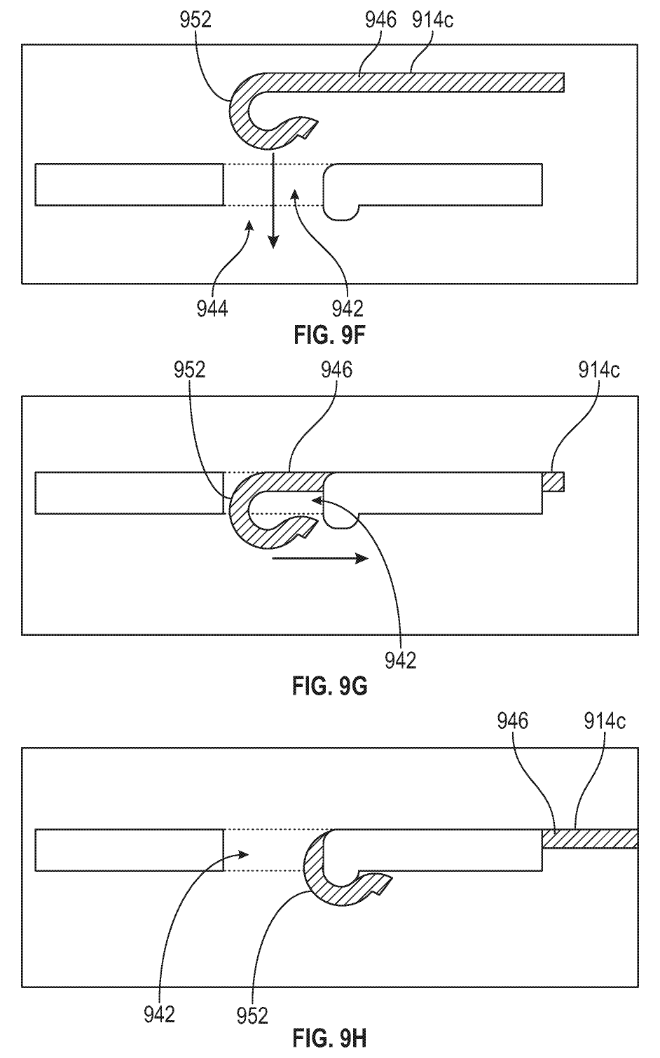

FIG. 9A–9H illustrate a system 900 including a palatal expander 902 with a longitudinal and transverse internal channel 904 for coupling to a secondary dental appliance 906, in accordance with embodiments of the present technology. Specifically, FIG. 9A is a bottom view of the palatal expander 902 and the secondary dental appliance 906 on a dental arch, FIG. 9B–9E are partially schematic top views of the palatal expander 902 illustrating example geometries for the channel 904, and FIG. 9F–9H illustrate a process for coupling the secondary dental appliance 906 to the channel 904 of the palatal expander 902.

The system 900 may be generally similar to the system 700 described above with respect to FIG. 7A–7G. Accordingly like reference numbers (e.g., palatal expander 902 versus palatal expander 702) are used to identify similar or identical components, and the following discussion of the system 900 will be limited to those features that differ from the system 700.

Referring to FIGS. 9A and 9B together, the palatal expander 902 can include a channel 904 that serves as a wire interface for coupling to the wire portion 914 of the 906. The channel 904 can be located in an inner surface of the tooth engagement portion 908 of the palatal expander 902, e.g., at the inner surface of the buccal sidewall of a cavity 912a for a tooth T. As best seen in FIG. 9B, the channel 904 can include a longitudinal section 940 extending in a mesial (M) to distal (D) direction and a transverse section 942 extending in a buccal (B) to lingual (L) direction. The longitudinal section 940 may be similar to the longitudinal channel 704 described with respect to FIG. 7A–7G, in that the longitudinal section 940 extends along the mesialmost cavity 912a only, and terminates before the middle cavity 912b and distalmost cavity 912c (e.g., to avoid interfering with the dental auxiliary receptacles 913 of the middle cavity 912b and the distalmost cavity 912c and/or with the handle 915 of the tooth engagement portion 908). The transverse section 942 can extend through the entire thickness of the buccal sidewall of the cavity 912a and can terminate in an opening 944 at the outer buccal surface of the tooth engagement portion 908.

The geometry of the wire portion 914 can be similar or substantially the same as the geometry of the channel 904. As shown in FIG. 9B, the wire portion 914 can include a straight segment 946 that fits into the longitudinal section 940 of the channel 904, and a bent segment 948 that fits into the transverse section 942 of the channel 904. Thus, when the wire portion 914 is fully inserted within the channel 904, the bent segment 948 can hook against the buccal sidewall of the tooth engagement portion 908, thereby further securing the wire portion 914 to the palatal expander 902.

The geometry of the channel 904 can be used to control the movement of the wire portion 914 and/or to control the forces exerted onto the wire portion 914 by the palatal expander 902. For instance, if the width of the transverse section 942 is greater than the thickness of the wire portion 914, the wire portion 914 may be permitted to slide longitudinally relative to the palatal expander 902. Alternatively, if the width of the transverse section 942 is substantially the same as thickness of the wire portion 914, the wire portion 914 may be fixed longitudinally relative to the palatal expander 902. In some embodiments, the configuration of the channel 904 shown in FIGS. 9A and 9B allows the palatal expander 902 to exert forces on the wire portion 914 in up to five directions: in a gingival direction (the direction out of the sheet in FIG. 9B), in an occlusal direction (the direction into the sheet in FIG. 9B), in a mesial direction, in a distal direction, and in a lingual direction.

FIG. 9C–9E illustrate other geometries that may be used for the channel 904 and wire portion 914, in accordance with embodiments of the present technology. For instance, FIG. 9C illustrates a channel 904a in which the transverse section 942 extends only partially through the thickness of the buccal sidewall of the cavity 912a, such that there is no opening in the outer buccal surface of the tooth engagement portion 908 and the end of the wire portion 914a is not exposed, which may improve patient comfort. In some embodiments, the configuration of the channel 904a shown in FIG. 9C allows the palatal expander 902 to exert forces on the wire portion 914a in up to five directions: in a gingival direction (the direction out of the sheet in FIG. 9C), in an occlusal direction (the direction into the sheet in FIG. 9C), in a mesial direction, in a distal direction, and in a lingual direction.

FIG. 9D illustrates a channel 904b with a cover 950 (e.g., a plug) that fits into the transverse section 942 of the channel 904b. In the illustrated embodiment, the transverse section 942 extends entirely through the thickness of the buccal sidewall of the cavity 912a, thereby forming an opening 944 in the outer buccal surface of the tooth engagement portion 908. The cover 950 can be inserted into the opening 944 to cover the exposed end of the wire portion 914b, which may improve patient comfort. The transverse section 942 can be wider than the thickness of the wire portion 914b to provide space to receive at least a portion of the cover 950 therein to secure the cover 950 to the palatal expander 902, e.g., via interference fit. Moreover, depending on the geometry (e.g., shape, size) of the cover 950, the cover 950 may be used in combination with the channel 904b to exert forces onto the wire portion 914b in any desired direction.

FIG. 9E illustrates a channel 904c and a wire portion 914c with a hook 952, and FIG. 9F–9H illustrate a process for inserting the hook 952 into the channel 904c (some components of the palatal expander 902 are omitted in FIG. 9F–9H for simplicity). Referring first to FIG. 9E, the transverse section 942 of the channel 904c extends entirely through the thickness of the buccal sidewall of the cavity 912a, thereby forming an opening 944 in the outer buccal surface of the tooth engagement portion 908. The width of the transverse section 942 of the channel 904c can be greater than the length of the hook 952 to allow the hook 952 to be inserted through the transverse section 942 and out the opening 944 (FIG. 9F). To secure the hook 952 to the palatal expander 902, the hook 952 can be pulled distally (FIG. 9G) until the hook 952 engages the sidewall of the tooth engagement portion 908 adjacent to the transverse section 942 of the channel 904 (FIG. 9H), which may be shaped to mate with the geometry of the hook 952. Thus, when fully inserted and coupled to the palatal expander 902, the hook 952 extends transversely through the thickness of the buccal sidewall of the cavity 912a and then extends longitudinally in a distal-to-mesial direction around the outer buccal surface of the tooth engagement portion 908. Optionally, a cover may be inserted into the transverse section 942 to cover the exposed hook 952 (e.g., similar to the cover 950 of FIG. 9D). The configuration shown in FIG. 9E–9H may be used to exert forces onto the wire portion 914c in any desired direction, and/or to affix the position of the wire portion 914c relative to the palatal expander 902.

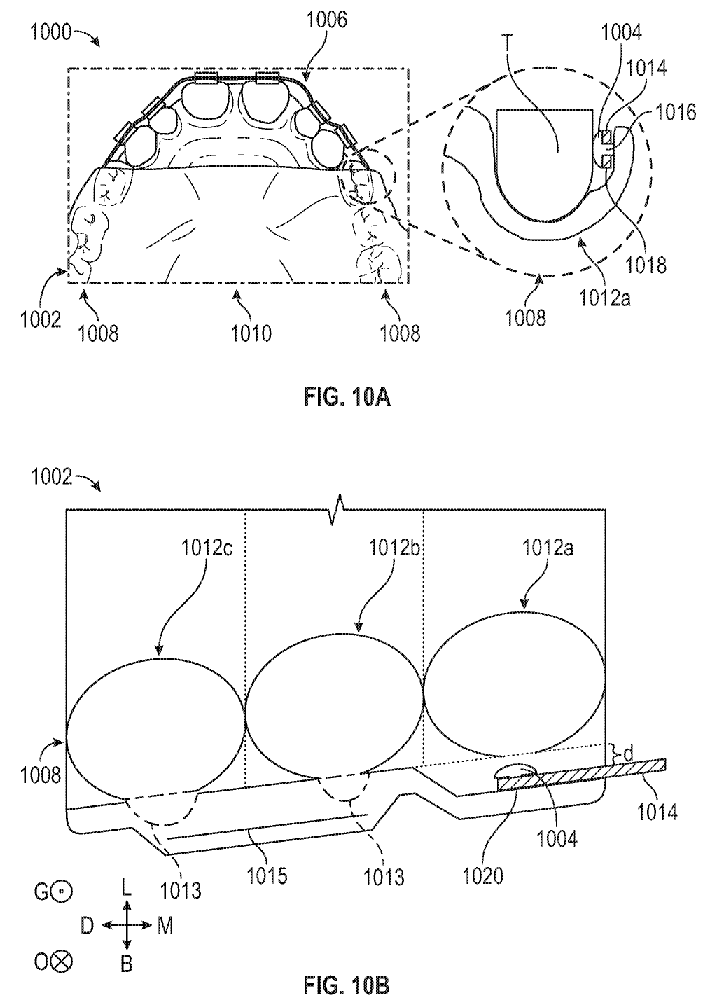

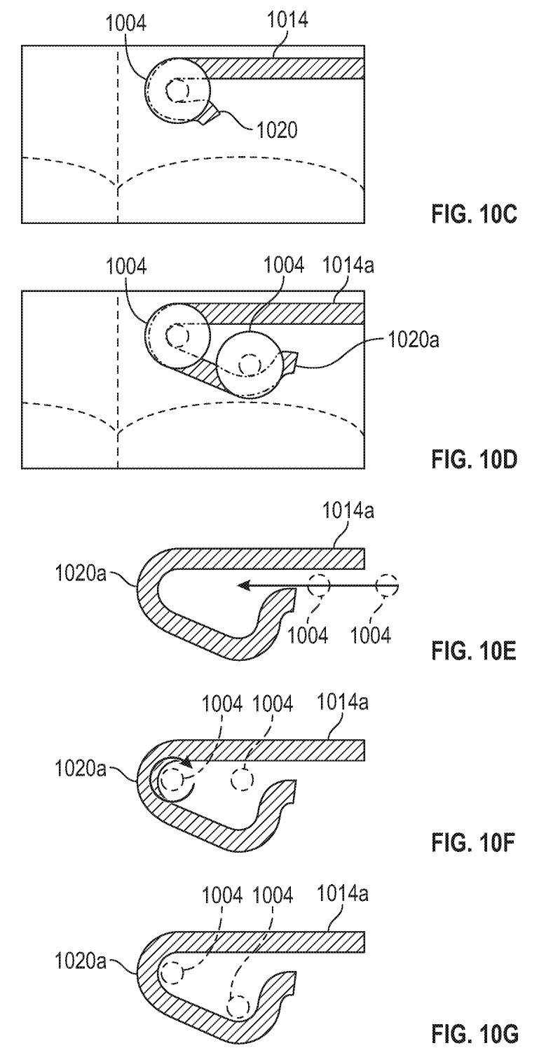

FIG. 10A–10G illustrate a system 1000 including a palatal expander 1002 with internal projections 1004 for coupling to a secondary dental appliance 1006, in accordance with embodiments of the present technology. Specifically, FIG. 10A is a bottom view of the palatal expander 1002 and the secondary dental appliance 1006 on a dental arch, FIG. 10B is a partially schematic top view of a portion of the palatal expander 1002, and FIG. 10C–10G illustrate example configurations for the projections 1004.

Referring first to FIG. 10A, the palatal expander 1002 can be identical or generally similar to the palatal expander 100 of FIG. 1A–1C. For instance, the palatal expander 1002 can include a pair of tooth engagement portions 1008 configured to receive one or more posterior teeth at opposite sides of the dental arch, and a palatal portion 1010 between the tooth engagement portion 1008 that applies forces to expand the palate. The palatal expander 1002 can include one or more wire interfaces for removably coupling to the secondary dental appliance 1006, which may be a wire and bracket appliance (e.g., as depicted in FIG. 10A) or any of the other wire-based appliances described herein.

As best seen in the inset of FIG. 10A (showing a front cross-sectional view of the tooth engagement portion 1008), the wire interface can be one or more projections 1004 (e.g., pegs, buttons, posts) located in an inner surface of the tooth engagement portion 1008 of the palatal expander 1002. In the illustrated embodiment, the projection 1004 is located in the buccal side of the tooth engagement portion 1008, at the inner surface of the buccal sidewall of a cavity 1012a for a tooth T.

Referring next to FIG. 10B, the projection 1004 can be located in the anterior end of the palatal expander 1002. In the illustrated embodiment, the projection 1004 is located proximate to the mesialmost cavity 1012a only (e.g., to avoid interfering with the dental auxiliary receptacles 1013 of the middle cavity 1012a and the distalmost cavity 1012c and/or with the handle 1015 of the tooth engagement portion 1008). In other embodiments, however, one or more projections 1004 can alternatively or additionally be located proximate to the middle cavity 1012b and/or the distalmost cavity 1012c (e.g., at a location that does not intersect the dental auxiliary receptacles 1013 and/or the handle 1015).

The projection 1004 can be configured to receive and couple to a wire portion 1014 of the secondary dental appliance (e.g., an end of an archwire or headgear). As best seen in FIG. 10A, the projection 1004 can have a narrower neck 1016 and a wider cap 1018, with the neck 1016 being connected to the inner surface of the tooth engagement portion 1008 and the cap 1018 being spaced apart from the inner surface of the tooth engagement portion 1008. Referring next to FIG. 10A–10C together, the wire portion 1014 can include a hook 1020 (FIG. 10F) that is configured to wrap around the neck 1016 of the projection 1004 to secure the wire portion 1014 to the palatal expander 1002. When coupled to the projection 1004, the hook 1020 can be positioned between the cap 1018 of the projection 1004 and the inner surface of the tooth engagement portion 1008, thus preventing the wire portion 1014 from slipping in a lingual direction off the projection 1004.

Optionally, as shown in FIG. 10B, the projection 1004 can be designed to provide a clearance distance d (e.g., a gap or offset) between the wire portion 1014 and the tooth T. The clearance distance d can also be sufficiently large so the projection 1004 does not contact the tooth T. The clearance distance d can be any suitable amount, such as within a range from 0.1 mm to 2 mm, 0.1 mm to 0.25 mm, 0.25 mm to 0.5 mm, 0.5 mm to 0.75 mm, 0.75 mm to 1.5 mm, or 1.5 mm to 2 mm. The presence of the clearance distance d may be advantageous for avoiding patient discomfort due to rubbing of the projection 1004 and/or the wire portion 1014 against the tooth surface. Moreover, the clearance distance d can allow the palatal expander 1002 to provide control of rotation of the wire portion 1014 around its longitudinal axis, since the palatal expander 1002 can push against the wire portion 1014 rather than pushing against the tooth T. In other embodiments, however, the clearance distance d is optional and may be omitted (e.g., the projection 1004 and/or the wire portion 1014 can be in direct contact with the tooth T when engaged with the projection 1004).

The location and/or geometry (e.g., size, shape) of the projection 1004 can be used to control the movement of the wire portion 1014 and/or to control the forces exerted onto the wire portion 1014 by the palatal expander 1002. For instance, the projection 1004 can prevent the wire portion 1014 from moving mesially relative to the palatal expander 1002. Optionally, the projection 1004 can allow the palatal expander 1002 to exert forces onto the wire portion 1014 in any desired direction.

Although FIG. 10A–10C illustrate a single projection 1004, this is not intended to be limiting, and any suitable number of projections 1004 can be used, such as two, three, four, five, or more projections 1004. In some embodiments, a plurality of projections 1004 may provide a more secure coupling compared to a single projection 1004.

FIG. 10D is a partially schematic side view of a wire portion 1014a with a hook 1020a for coupling to two projections 1004, and FIG. 10E–10G illustrate a process for coupling the hook 1020a to the projections 1004 (only the narrower necks of the projections 1004 are shown in FIG. 10E–10G) for simplicity. Referring first to FIG. 10G, the projections 1004 can be vertically and/or horizontally offset from each other, such that each projection 1004 engages a different section of the hook 1020a. To couple the hook 1020a to the projections 1004, the palatal expander 1002 can be tilted at an angle so that both projections 1004 are aligned with the opening in the hook 1020a. The palatal expander 1002 can then be pushed distally to slide the projections 1004 through the opening in the hook 1020a (FIG. 10E), until the distal projection 1004 engages the hook 1020a (FIG. 10F). The palatal expander 1002 can then be rotated around the distal projection 1004 until the mesial projection 1004 also engages the hook 1020a (FIG. 10G), thereby securing the wire portion 1014a to the palatal expander 1002. The rotation process may also engage the dental auxiliary receptacles 1013 of the palatal expander 1002 with the corresponding dental auxiliaries on the teeth.

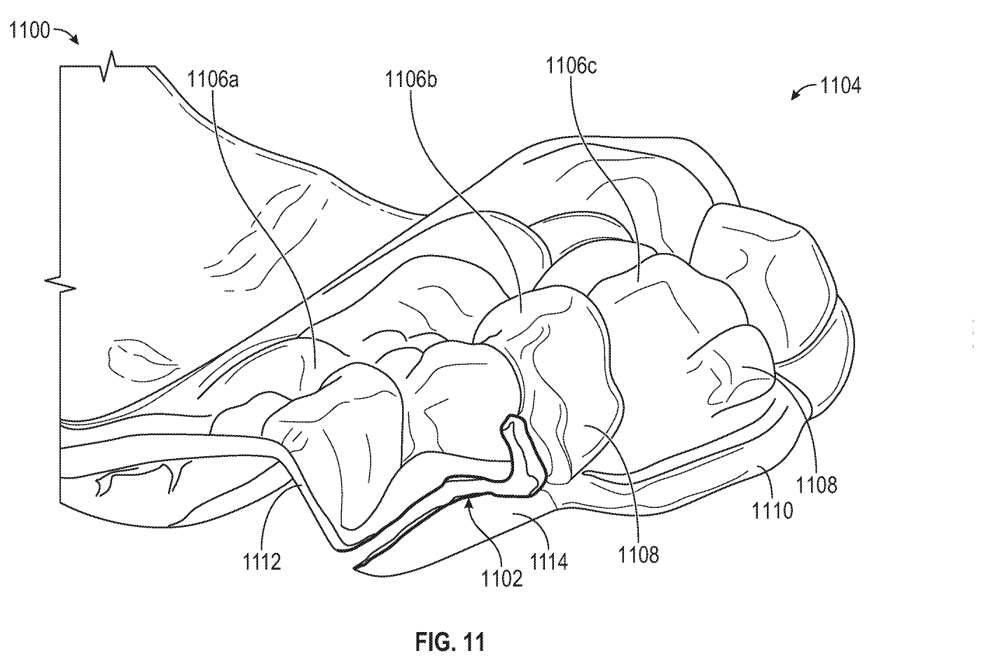

FIG. 11 is a perspective view of a portion of a palatal expander 1100 including a slot 1102 for coupling to a wire portion of a secondary dental appliance, in accordance with embodiments of the present technology. The palatal expander 1100 may be identical or generally similar to the palatal expander 100 of FIG. 1A–1C. For instance, the palatal expander 1100 can include a pair of tooth engagement portions configured to receive one or more posterior teeth at opposite sides of the dental arch, and a palatal portion between the tooth engagement portions that applies forces to expand the palate (only a single tooth engagement portion 1104 is shown in FIG. 11 for purposes of simplicity).

The tooth engagement portion 1104 includes a slot 1102 that is configured to couple to a corresponding wire portion of a secondary dental appliance (not shown). The slot 1102 can be a cutout having a geometry that conforms to the geometry of the wire portion (e.g., an L-shaped cutout to match an L-shaped wire). The slot 1102 can be formed in the anterior portion of the tooth engagement portion 1104, e.g., proximate to the mesialmost cavity 1106a and away from the distalmost cavities 1106b, 1106c (e.g., to avoid interfering with the dental auxiliary receptacles 1108 and handle 1110 of the cavities 1106b, 1106c).

The presence of the slot 1102 can divide the anterior buccal sidewall into two regions: an anterior occlusal region 1112 located above (occlusal to) the slot 1102 and an anterior gingival region 1114 that is located below (gingival to) to the slot 1102. The anterior occlusal region 1112 can be a fixed, relatively stiff component that remains in place on the teeth to facilitate alignment of the wire portion with the slot 1102. The anterior gingival region 1114 can be a movable, relatively flexible component that deflects outward to allow for insertion of the wire portion into the slot 1102, and then can be bent back inward to lock the wire portion in place in the slot 1102. The geometry and properties of the anterior occlusal region 1112 and the anterior gingival region 1114 can be adapted to the different functions of these components. For instance, the anterior occlusal region 1112 can have a higher stiffness and/or thickness than the anterior gingival region 1114. Moreover, the bendable section of the anterior gingival region 1114 can be less stiff and/or thick to provide flexibility for bending outward, whereas the rest of the anterior gingival region 1114 can be stiffer and/or thicker to serve as a rigid clamp to secure the wire portion in the slot 1102. Optionally, as shown in FIG. 11, the anterior gingival region 1114 can be connected to the handle 1110 so these components can be deflected outward together.

In some embodiments, the process of coupling the palatal expander 1100 to the secondary dental appliance is performed as follows. The secondary dental appliance can already be in place on the dental arch, with the wire portion exposed and extending along the posterior teeth. The patient can then place the palatal expander 1100 on the dental arch, sliding the anterior occlusal region 1112 over the teeth so that the slot 1102 is aligned with the wire portion. The patient can then bend the anterior gingival region 1114 and handle 1110 laterally outward around the wire portion and dental auxiliaries on the posterior teeth, respectively. The anterior gingival region 1114 and handle 1110 can then be pushed back inward to capture the wire portion within the slot 1102 while fitting the dental auxiliaries into the receptacles 1108.

Although certain embodiments of the present technology are described in connection with coupling of palatal expanders to wire-based appliances, this is not intended to be limiting, and the palatal expanders herein may be used with other types of secondary dental appliances, including dental appliances that do not include wires as well as dental appliances that are coupled to a palatal expander via a component that is not a wire (e.g., an elastic, a spring, a piston, a polymeric shell section). Accordingly, any structure described herein as being a “wire interface” may alternatively or additionally be adapted for coupling to other types of components and/or to a non-wire-based dental appliance. Representative examples of dental appliances that may be used with the palatal expanders described herein include elastics (e.g., bands, powerchains), splints, polymeric shell appliances (e.g., an anterior aligner segment with a portion that couples to the palatal expander, such as a wire, spring, or polymeric extension), mandibular/maxillary advancement devices, and Herbst appliances.

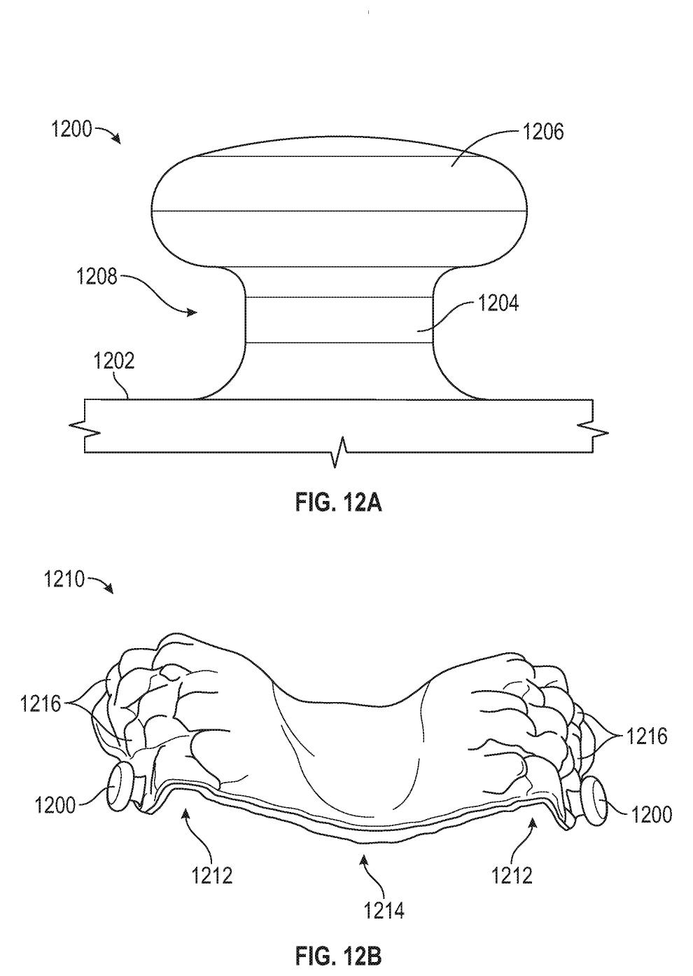

FIG. 12A–14B illustrate representative examples of devices and systems for coupling a palatal expander to a secondary dental appliance via elastics, in accordance with embodiments of the present technology. Any of the embodiments of FIG. 12A–14B may be combined with any of the other embodiments described herein (e.g., the embodiments of FIG. 1A–11) and/or with each other.

FIG. 12A is a side view of a button 1200 for removably coupling to an elastic, in accordance with embodiments of the present technology. The button 1200 can be located on a surface 1202 of a palatal expander for coupling the palatal expander to a secondary dental appliance via an elastic (not shown). For example, the surface 1202 can be an outer surface, an inner surface, a buccal surface, a lingual surface, an occlusal surface, a surface of a tooth engagement portion, a surface of a palatal portion, etc.

The button 1200 includes a narrower neck 1204 and a wider cap 1206, with the neck 1204 being connected to the surface 1202 and the cap 1206 being spaced apart from the surface 1202. As shown in FIG. 12A, the cap 1206 can be centered and coaxial with the neck 1204, thereby defining a symmetric annular space 1208 underneath the cap 1206 for receiving an elastic. Accordingly, many different directionalities of elastic coupling are possible with the button 1200, whereas other types of interface shapes (e.g., hooks) may be limited to unidirectional couplings.

To couple an elastic to the button 1200, the elastic can be looped around the neck 1204, with the wider cap 1206 preventing the elastic from slipping upward off the button 1200. The geometry of the button 1200 (e.g., cap prominence, cap diameter, cap corner thickness, cap corner fillet radius, neck diameter, total button height) can be configured to securely retain the elastic while also providing an ergonomic surface profile. For example, the neck 1204 and cap 1206 can each have a rounded shape to reduce or avoid sharp corners that might cause patient discomfort, such as a circular or oval cross-sectional shape. In some examples, the neck 1204 may have a non-rounded cross-section to allow for increased grip with an elastic and/or directional control of the force vector generated by the elastic on the palatal expander 1210. For example, the neck 1204 may have a cross-section that is rectangular, square, hexagonal, octagonal, etc. In some instances, there may be a tradeoff between round edges and overall prominence of the cap 1206, in that increasing the cap fillet radius can distribute pressure from the elastic across a larger area, but may also require an increase in cap prominence. The cap 1206 can be sufficiently large to prevent the elastic from slipping off, while also being sufficiently small to avoid being obtrusive to the patient. For instance, the cap 1206 can have a diameter within a range from 1 mm to 10 mm, 1 mm to 4.5 mm, 1 mm to 5 mm, 2 mm to 4 mm, 4 mm to 6 mm, 6 mm to 8 mm, or 8 mm to 10 mm; and/or a diameter of about 2 mm, 3 mm, 4 mm, 5 mm, 6 mm, 7 mm, or 8 mm. The button 1200 can be sufficiently tall for easy coupling to the elastic, while also being sufficiently short to avoid being obtrusive to the patient. For instance, the total height of the button 1200 above the surface 1202 can be within a range from 1 mm to 10 mm, 2 mm to 4 mm, 4 mm to 6 mm, 6 mm to 8 mm, or 8 mm to 10 mm; and/or about 2 mm, 2.5 mm, 3 mm, 3.5 mm, 4 mm, 4.5 mm, or 5 mm.

FIG. 12B is a perspective view of a palatal expander 1210 including buttons 1200 for coupling to a secondary dental appliance via elastics, in accordance with embodiments of the present technology. The palatal expander 1210 may be identical or generally similar to the palatal expander 100 of FIG. 1A–1C. For instance, the palatal expander 1210 can include a pair of tooth engagement portions 1212 configured to receive one or more posterior teeth at opposite sides of the dental arch, and a palatal portion 1214 between the tooth engagement portions 1212 that applies forces to expand the palate.

In the illustrated embodiment, the buttons 1200 are located at the anterior end of the palatal expander 1210, with each button 1200 being positioned on the outer surface of the buccal sidewall of the mesialmost tooth receiving cavity of the tooth engagement portion 1212. In other embodiments, however, the buttons 1200 can be at a different location, such as at the posterior end of the palatal expander 1210, or between the anterior and posterior ends of the palatal expander 1210. Moreover, although the buttons 1200 are depicted as being located away from the dental auxiliary receptacles 1216 of the tooth engagement portions 1212, in other embodiments, the buttons 1200 may be located on the receptacles 1216, which may provide better directional force for certain treatments (e.g., Class III interarch treatments, lower buccal uprighting).

Due to the symmetric shape of the buttons 1200, the palatal expander 1210 may be used with many different directionalities of elastics, such as elastics that apply forces anteriorly, posteriorly, laterally, etc. For example, the buttons 1200 may be coupled to elastics that pull the palatal expander 1210 anteriorly (e.g., via attachment to a facemask or an appliance on the lower dental arch for correction of Class III malocclusions). As another example, the buttons 1200 may be coupled to elastics that pull the palatal expander 1210 posteriorly (e.g., via attachment to a headgear or an appliance on the lower dental arch for correction of Class II malocclusions). In either case, it may be desirable to position the buttons 1200 as close to the anterior (mesial) edge of the palatal expander 1210 as possible to increase or maximize the translational component of the forces applied by the elastics. For instance, the location of the buttons 1200 may be determined by identifying one or more points on the anterior edge of the palatal expander 1210, then setting the location of the buttons 1200 to be within a predetermined distance (e.g., radius) from the identified point(s) (e.g., a distance that is sufficiently large to ensure that the buttons 1200 are stably supported on the surface of the palatal expander 1210).

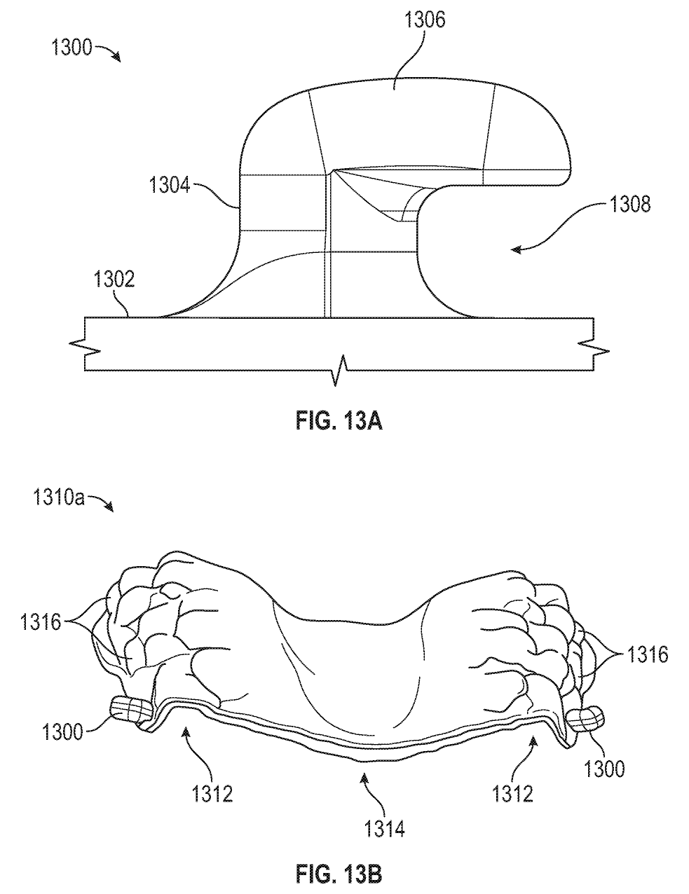

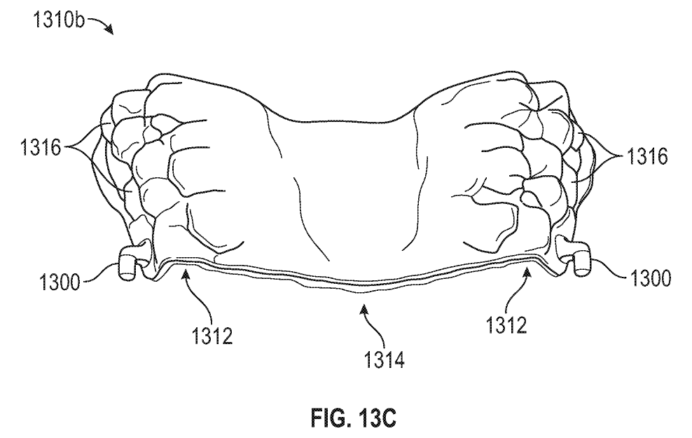

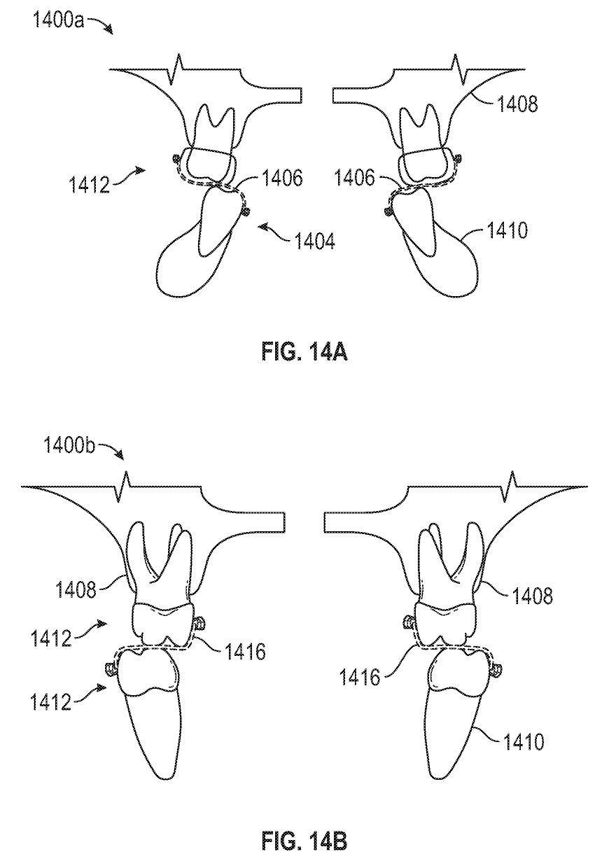

FIG. 13A is a side view of a hook 1300 for removably coupling to an elastic, in accordance with embodiments of the present technology. The hook 1300 can be located on a surface 1302 of a palatal expander for coupling the palatal expander to a secondary dental appliance via an elastic (not shown). For example, the surface 1302 can be an outer surface, an inner surface, a buccal surface, a lingual surface, an occlusal surface, a surface of a tooth engagement portion, a surface of a palatal portion, etc.

The hook 1300 includes a narrower neck 1304 and a wider cap 1306, with the neck 1304 being connected to the surface 1302 and the cap 1306 being spaced apart from the surface 1302. The cap 1306 can be offset relative to the neck 1304 instead of being centered on the neck 1204, such that a space 1308 for receiving the elastic is present at one side of the neck 1304 only. Accordingly, the hook 1300 can have a reduced spatial footprint (e.g., cap size) compared to other interfaces shapes (e.g., buttons), while maintaining substantially the same engagement area for coupling to the elastic. Thus, the hook 1300 may be advantageous at locations where space is constrained and/or to improve patient comfort. For instance, there may be limited space for an elastic coupling interface near a dental auxiliary receptacle, e.g., depending on the premolar width, gingival angle, auxiliary positioning, etc.

To couple an elastic to the hook 1300, the elastic can be looped around the neck 1304, with the wider cap 1306 preventing the elastic from slipping upward off the hook 1300 as long as the direction of the elastic is substantially opposite the direction of the cap 1306. The geometry of the hook 1300 (e.g., cap prominence, cap diameter/width, cap corner thickness, cap corner fillet radius, neck diameter, total hook height) can be configured to securely retain the elastic while also providing an ergonomic surface profile. For example, the neck 1304 and cap 1306 can each have a rounded shape to reduce or avoid sharp corners that might cause patient discomfort, such as a circular or oval cross-sectional shape. The cap 1306 can be sufficiently large to prevent the elastic from slipping off, while also being sufficiently small to avoid being obtrusive to the patient. For instance, the cap 1306 can have a diameter/width within a range from 0.5 mm to 8 mm, 1 mm to 8 mm, 1 mm to 2 mm, 2 mm to 4 mm, 4 mm to 6 mm, 6 mm to 8 mm; and/or a diameter/width of about 0.5 mm, 1 mm, 2 mm, 3 mm, 4 mm, 5 mm, 6 mm, 7 mm, or 8 mm. The hook 1300 can be sufficiently tall for easy coupling to the elastic, while also being sufficiently short to avoid being obtrusive to the patient. For instance, the total height of the hook 1300 above the surface 1202 can be within a range from 1 mm to 10 mm, 2 mm to 4 mm, 4 mm to 6 mm, 6 mm to 8 mm, or 8 mm to 10 mm; and/or about 2 mm, 2.5 mm, 3 mm, 3.5 mm, 4 mm, 4.5 mm, or 5 mm.

The hook 1300 can be formed on the surface 1302 in any desired orientation, e.g., depending on the intended direction of the elastic and/or the force vector to be applied by the elastic. In some embodiments, the orientation of the hook 1300 is determined by identifying the direction of the elastic to be coupled to the hook 1300 and/or the direction of the force vector to be applied to the hook 1300 by the elastic, and then setting the orientation of the hook 1300 to be substantially opposite (e.g., rotated by an angle less than or equal to 180°, 120°, 100°, or 90°; and/or an angle within a range from 60° to 100°, 70° to 100°, or 90° to 70°) to the identified direction.

FIG. 13B is a perspective view of a palatal expander 1310a including posteriorly-oriented hooks 1300 for coupling to a secondary dental appliance via elastics, in accordance with embodiments of the present technology. The palatal expander 1310a may be identical or generally similar to the palatal expander 100 of FIG. 1A–1C. For instance, the palatal expander 1310a can include a pair of tooth engagement portions 1312 configured to receive one or more posterior teeth at opposite sides of the dental arch, and a palatal portion 1314 between the tooth engagement portions 1312 that applies forces to expand the palate.

In the illustrated embodiment, the hooks 1300 are located at the anterior end of the palatal expander 1310a, with each hook 1300 being positioned on the outer surface of the buccal sidewall of the mesialmost tooth receiving cavity of the tooth engagement portion 1312. In other embodiments, however, the hooks 1300 can be at a different location, such as at the posterior end of the palatal expander 1310a, or between the anterior and posterior ends of the palatal expander 1310a. Moreover, although the hooks 1300 are depicted as being located away from the dental auxiliary receptacles 1316 of the tooth engagement portions 1312, in other embodiments, the hooks 1300 may be located on the receptacles 1316, which may provide better directional force for certain treatments (e.g., Class III interarch treatments, lower buccal uprighting).

The hooks 1300 are oriented in a posterior direction, such that the space for receiving the elastic is posterior to the neck of each hook 1300. Thus, the hooks 1300 can be coupled to elastics that pull the palatal expander 1310a anteriorly (e.g., via attachment to a facemask or other device for correction of Class III malocclusions).

FIG. 13C is a perspective view of a palatal expander 1310b including anteriorly-oriented hooks 1300 for coupling to a secondary dental appliance via elastics, in accordance with embodiments of the present technology. The palatal expander 1310b can be identical to the palatal expander 1310a of FIG. 13B, except that the hooks 1300 are oriented in an anterior direction, such that the space for receiving the elastic is anterior to the neck of each hook 1300. Thus, the hooks 1300 can be coupled to elastics that pull the palatal expander 1310b posteriorly (e.g., via attachment to a headgear or other device for correction of Class II malocclusions).

FIG. 14A is partially schematic front cross-sectional view of a system 1400a for interarch treatment using a palatal expander 1402 coupled to a secondary dental appliance 1404 via elastics 1406, in accordance with embodiments of the present technology. In the illustrated embodiment, the palatal expander 1402 is placed on an upper dental arch 1408 and the secondary dental appliance 1404 is placed on a lower dental arch 1410 (only the elastics interfaces of the palatal expander 1402 and the secondary dental appliance 1404 are shown for purposes of simplicity). The elastics 1406 are used to connect the left and right buccal sides of the palatal expander 1402 to the left and right lingual sides of the secondary dental appliance 1404, respectively. This configuration may be used to achieve buccal uprighting of teeth of the lower dental arch 1410 (e.g., the lower molars).

The palatal expander 1402 can be coupled to the elastics 1406 via respective interfaces at the left and right sides of the palatal expander 1402, such as buttons, hooks, etc. In some embodiments, the interfaces are located on the outer surfaces of the buccal sidewalls of the tooth engagement portions of the palatal expander 1402.

The secondary dental appliance 1404 can be any dental appliance that can be placed on the lower dental arch 1410, such as a wire and bracket appliance, polymeric shell appliance (e.g., aligner, retainer), splints, etc. The secondary dental appliance 1404 can be coupled to the elastics 1406 via respective interfaces at the left and right sides of the secondary dental appliance 1404, such as buttons, hooks, etc. Optionally, the secondary dental appliance 1404 can be buttons, hooks, or other structures that are mounted directly on the teeth of the lower dental arch 1410.

FIG. 14B is partially schematic front cross-sectional view of a system 1400b for interarch treatment using a palatal expander 1412 coupled to a secondary dental appliance 1414 via elastics 1416, in accordance with embodiments of the present technology (only the elastics interfaces of the palatal expander 1412 and the secondary dental appliance 1414 are shown for purposes of simplicity). The palatal expander 1412, secondary dental appliance 1414, and elastics 1416 can be identical or generally similar to the corresponding components of FIG. 14A, except that the elastics 1416 are used to connect the left and right lingual sides of the palatal expander 1412 to the left and right buccal sides of the secondary dental appliance 1414, respectively. This configuration may be used to achieve lingual uprighting of teeth of the lower dental arch 1410 (e.g., the lower molars).

The palatal expander 1412 can be coupled to the elastics 1416 via respective interfaces at the left and right sides of the palatal expander 1412, such as buttons, hooks, etc. In some embodiments, the interfaces are located on the outer surfaces of the lingual sidewalls of the tooth engagement portions of the palatal expander 1412. Alternatively, the interfaces can be located on the outer surfaces of the palatal portion of the palatal expander 1412.

Although certain embodiments of the present technology are described herein with respect to palatal expanders with interfaces for coupling to a secondary dental appliance, the present technology also encompasses other types of dental appliances that can be coupled to a secondary dental appliance, such as aligners or retainers. Accordingly, any description herein that references coupling of a palatal expander to a secondary dental appliance can also be applied to coupling of another type of dental appliance to a secondary dental appliance.

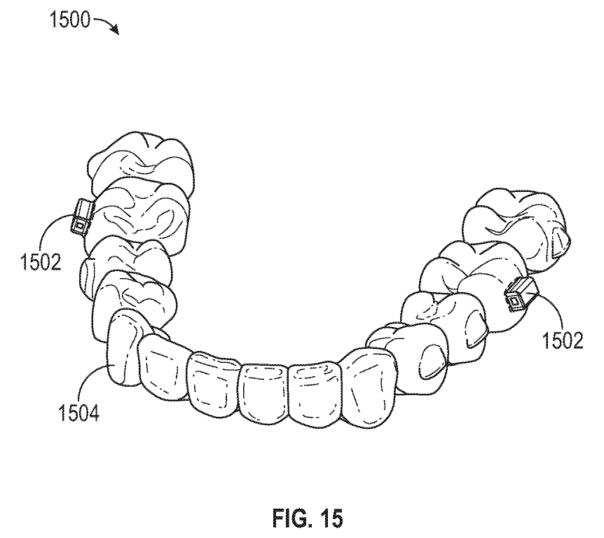

FIG. 15 is a perspective view of a dental appliance 1500 including interfaces 1502 for coupling to a secondary dental appliance, in accordance with embodiments of the present technology. The dental appliance 1500 can be an aligner, retainer, or other similar device having a shell 1504 with a plurality of cavities for receiving teeth of a patient’s arch. The shell 1504 can include one or more interfaces 1502 for coupling the dental appliance 1500 to a secondary dental appliance, e.g., via wires, elastics, springs, pistons, polymeric shell segments, etc. For instance, the interfaces 1502 can include any of the features of the embodiments described herein, e.g., in connection with FIG. 1A–14B. The interfaces 1502 can be located at any suitable portion of the shell 1504, such as on an outer surface, on an inner surface, on a buccal surface, on a lingual surface, on an occlusal surface, at a left side, at a right side, etc. Moreover, although FIG. 15 illustrates two interfaces 1502 at the left and right sides of the shell 1504, in other embodiments, the dental appliance 1500 can include any suitable number of interfaces 1502, such as one, three, four, five, or more interfaces 1502.

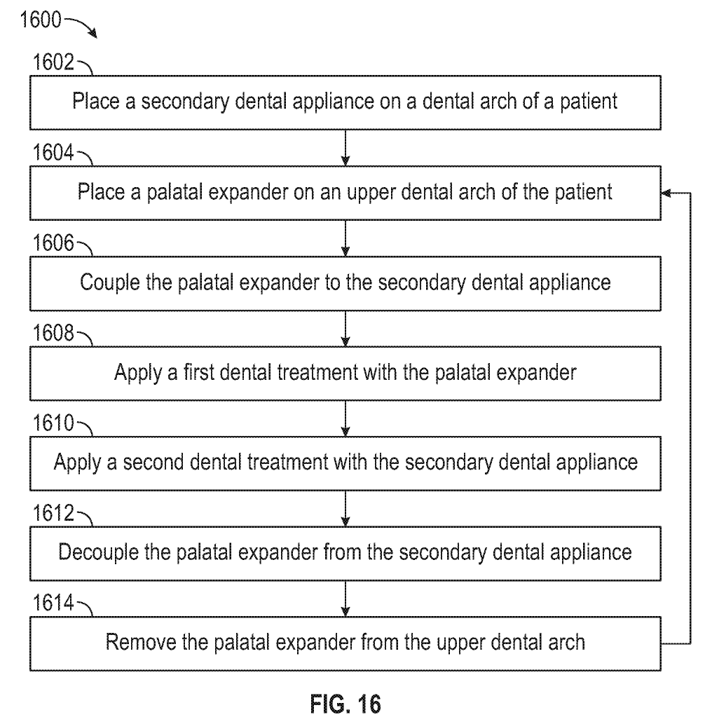

FIG. 16 is a flow diagram illustrating a method 1600 for treating a patient’s teeth, in accordance with embodiments of the present technology. The method 1600 can be performed using any of the systems and devices described herein, such as any of the embodiments of FIG. 1A–15.

The method 1600 can begin at block 1602 with placing a secondary dental appliance on a dental arch of a patient. The secondary dental appliance can be any of the appliance types described herein, such as a wire and bracket appliance, a headgear, a facemask, a retainer, a distalizer, an elastic, a splint, a polymeric shell appliance, a mandibular/maxillary advancement device, a Herbst appliance, etc. The secondary dental appliance may be placed on the upper dental arch, on the lower dental arch, or on both arches. The secondary dental appliance may be placed by the patient or by a clinician. In some embodiments, the secondary dental appliance is not patient removable (e.g., the appliance is affixed to the dental arch), while in other embodiments, the secondary dental appliance is patient removable.

At block 1604, the method 1600 can continue with placing a palatal expander on an upper dental arch of the patient. The palatal expander can be a patient-removable appliance including a pair of tooth engagement portions and a palatal portion, e.g., as discussed above with respect to FIG. 1A–1C. The palatal expander may be placed on the upper dental arch after the secondary dental appliance is placed, before the secondary dental appliance is placed, or concurrently with the placement of the secondary dental appliance. The palatal expander may be placed by the patient or by the clinician.

At block 1606, the method 1600 can include coupling the palatal expander to the secondary dental appliance. The coupling can be performed using one or more wires, elastics, springs, pistons, polymeric shell segments, etc. For example, the palatal expander may include one or more wire interfaces for coupling to one or more corresponding wire portions of the secondary dental appliance, e.g., as discussed above with respect to FIG. 1A–11. Alternatively or in combination, the palatal expander may include one or more interfaces for coupling to the secondary dental appliance via one or more elastics, e.g., as discussed above with respect to FIG. 12A–14B. The coupling between the palatal expander and the secondary dental appliance can secure the secondary dental appliance to the dental arch, e.g., without using molar bands, skeletal anchorage devices, or other devices that are not removable by the patient.

At block 1608, the method 1600 can include applying a first dental treatment with the palatal expander. The first dental treatment can include expanding the patient’s palate or can include maintaining the patient’s palate at a current width. For instance, the palatal expander can be one of a series of palatal expanders configured to incrementally adjust the patient’s palate from an initial width to a target width. In some embodiments, the process of block 1608 is optional, e.g., the palatal expander can be a passive device that is not intended to apply any dental treatment to the teeth and serves solely as an anchoring platform for the secondary dental appliance.

At block 1610, the method 1600 can include applying a second dental treatment with the secondary dental appliance. The second dental treatment can include repositioning of teeth (e.g., anterior teeth of the dental arch), correction of malocclusions (e.g., Class II or Class III malocclusions via headgear or interarch treatments), uprighting of teeth (e.g., lingual or buccal uprighting of molars of the lower dental arch), sagittal and/or transverse movements of the dental arch relative to the lower dental arch, correction of posterior crossbite, correction of posterior torque and/or inclination, distalization, and combinations thereof.

The second dental treatment can be performed before, concurrently with, and/or after the first dental treatment. In some embodiments, the coupling between the palatal expander and the secondary dental appliance produces forces that facilitate the second dental treatment, e.g., the palatal expander provides anchorage for the secondary dental appliance to apply forces to the patient’s teeth. Optionally, the palatal expander can control tooth movements elicited by the secondary dental appliance, e.g., by preventing movements in undesired directions, limiting the extent of movement along certain directions, etc. Moreover, the coupling between the palatal expander and the secondary dental appliance can produce forces that facilitate the first dental treatment, e.g., the secondary dental appliance can apply forces to the teeth that enhance palatal expansion.

In some embodiments, the method 1600 continues to block 1612 with decoupling the palatal expander from the secondary dental appliance, and to block 1614 with removing the palatal expander from the upper dental arch. Removal of the palatal expander may be desired, for example, when the patient is performing certain activities (e.g., eating, drinking, routine oral hygiene), for dental examination, upon termination of palatal expansion therapy, etc. Optionally, the method 1600 can subsequently return to block 1604 with placing a palatal expander on the upper dental arch, which may be the same palatal expander or a different palatal expander. In the latter case, the different palatal expander may be another palatal expander in a series of palatal expanders for treating the patient’s teeth (e.g., the palatal expander for the next treatment stage). Alternatively, the different palatal expander may be designed for the same treatment stage as the previous palatal expander, but may have a different interface for coupling to the secondary dental appliance to adjust the second dental treatment applied by the secondary dental appliance (e.g., the coupling between the new palatal expander and the secondary dental appliance may produce different forces on the teeth compared to the coupling between the previous palatal expander and the secondary dental appliance). The processes of blocks 1604–1614 can be repeated until the first and second dental treatments are complete.

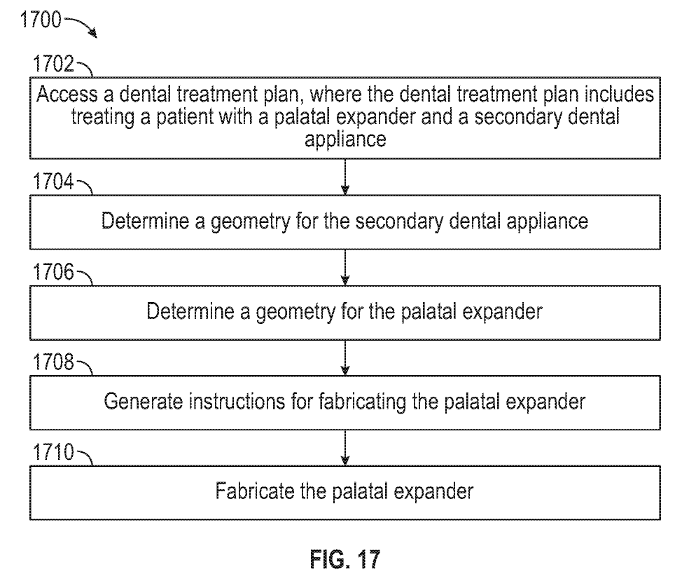

FIG. 17 is a flow diagram illustrating a method 1700 for designing a palatal expander, in accordance with embodiments of the present technology. The method 1700 can be used to fabricate any embodiment of the palatal expanders described herein, such as any of the embodiments described with respect to FIG. 1A–15. In some embodiments, some or all of the processes of the method 1700 are implemented as computer-readable instructions (e.g., program code) that are configured to be executed by one or more processors of a computing device (e.g., a mobile device, laptop, personal computer, workstation, remote server).

The method 1700 can begin at block 1702 with accessing a dental treatment plan, where the dental treatment plan includes treating a patient with a palatal expander and a secondary dental appliance. The palatal expander can be worn on the patient’s teeth concurrently with the secondary dental appliance to secure the secondary dental appliance to the teeth and, optionally, to adjust the dental treatment applied by the secondary dental appliance. In some embodiments, the palatal expander is one of a series of palatal expanders configured to incrementally adjust the patient’s palate from an initial width to a target width. Alternatively, the palatal expander can be passive device that serves solely as an anchoring platform for the secondary dental appliance.

The secondary dental appliance can be any of the appliance types described herein, such as a wire and bracket appliance, a headgear, a facemask, a retainer, a distalizer, an elastic, a splint, a polymeric shell appliance, a mandibular/maxillary advancement device, a Herbst appliance, etc. The secondary dental appliance can be configured to implement one or more of the following dental treatments: repositioning of teeth (e.g., anterior teeth of the dental arch), correction of malocclusions (e.g., Class II or Class III malocclusions via headgear or interarch treatments), uprighting of teeth (e.g., lingual or buccal uprighting of molars of the lower dental arch), sagittal and/or transverse movements of the dental arch relative to the lower dental arch, correction of posterior crossbite, correction of posterior torque and/or inclination, distalization, or combinations thereof.

In some embodiments, the dental treatment plan is configured to account for cross-impacts between the palatal expansion treatment implemented by the palatal expander (if applicable) and the dental treatment implemented by the secondary dental appliance. For example, in embodiments where the secondary dental appliance is used to reposition the anterior teeth, the anterior repositioning forces could impact the palatal expansion forces, and vice-versa. Thus, the repositioning and expansion forces can be adjusted to account for such effects, e.g., by changing thickness of the palatal expander, by changing archwire forces, etc. In other embodiments, however, such adjustments may not be needed, e.g., if the expansion forces are expected to be significantly higher than the forces applied by the secondary dental appliance or vice-versa.

At block 1704, the method 1700 can optionally include determining a geometry for the secondary dental appliance. The geometry can include information characterizing the 3D size and/or shape of the entire secondary dental appliance, or of only a portion of the secondary dental appliance (e.g., the portion to be coupled to the palatal expander). For instance, the geometry can include information regarding one or more wire portions of the secondary dental appliance, such as the wire thickness, wire length, wire shape, etc.

The determination of the geometry can be performed in various ways. For instance, the dental treatment plan may already include a digital representation (e.g., a 3D model) of the geometry of the secondary dental appliance, in which case the geometry for the secondary dental appliance may simply be determined from the digital representation of the treatment plan. Alternatively, if the dental treatment plan does not include a digital representation of the geometry of the secondary dental appliance, the geometry can be designed as part of the process of block 1704, e.g., using rule-based algorithms, machine learning algorithms, simulations, etc. Alternatively, if the secondary dental appliance is already fabricated, the geometry of the secondary dental appliance can be determined through scanning, images, physical measurements, and/or other techniques. Optionally, if the secondary dental appliance is an off-the-shelf appliance or an appliance that otherwise has a known geometry (e.g., selected from a set of prefabricated appliances), the known geometry can be retrieved from a database, library, look-up table, or other data store with the relevant information.

In other embodiments, however, the process of block 1704 is optional and may be omitted (e.g., if the geometry of the secondary dental appliance is not necessary for designing the palatal expander).

At block 1706, the method 1700 can include determining a geometry for the palatal expander. The process of block 1706 can include determining the 3D size and/or shape for one or more portions of the palatal expander, such as the tooth engagement portions, palatal portion, dental auxiliary receptacles, and/or interfaces for coupling to the secondary dental appliance. The geometry of the palatal expander may depend on the arrangement of the patient’s teeth, the treatment to be implemented by the palatal expander (e.g., the desired amount of palatal expansion), the treatment to be implemented by the secondary dental appliance, and/or the geometry of the secondary dental appliance. The geometry may be determined using various techniques, such as rule-based algorithms, machine learning algorithms, simulations, etc.

In some embodiments, the process of block 1706 involves determining a geometry for one or more interfaces of the palatal expander that are configured to couple to the secondary dental appliance. For instance, the palatal expander can include one or more wire interfaces for coupling to one or more wire portions of the secondary dental appliance. The geometry of the wire interfaces may conform to the geometry of the wire portions, may be designed to constrain the movement of the wire portions, and/or may be designed to apply certain forces to the wire portions. As another example, the palatal expander can include one or more buttons or hooks for coupling to an elastic that is connected to the secondary dental appliance, where the position and/or orientation of the buttons/hooks is selected based on the direction of the elastics and/or the forces to be applied by the elastics. The process of block 1706 can optionally include determining a location for the one or more interfaces, where the location may be based on the location of the secondary dental appliance, as well as other considerations such as creating a desired distribution of forces across the teeth.

At block 1708, the method 1700 can include generating instructions for fabricating the palatal expander with the determined geometry. The instructions can be any data type that can be used by a system for fabricating the object, such as instructions for an additive manufacturing system. For example, the fabrication instructions can include a digital representation of the palatal expander (e.g., a 3D model) and/or other data generated based on the digital representation, such as a toolpath file (e.g., G-code file).

At block 1710, the method 1700 can optionally include fabricating the palatal expander, based on the generated instructions. The fabrication of the palatal expander can be performed using any suitable technique, such as an additive manufacturing technique. Examples of additive manufacturing techniques include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

Although the method 1700 is described above with respect to a single palatal expander, the method 1700 can be used to fabricate any number of palatal expanders, such as some or all of a series of palatal expanders for incrementally expanding the patient’s palate while also providing anchorage for the secondary dental appliance.

Furthermore, in some embodiments, the method 1700 can further include generating instructions for fabricating the secondary dental appliance and/or fabricating the secondary dental appliance. For example, certain types of secondary dental appliances (or portions thereof) may be fabricated via additive manufacturing of metals, polymers, or combinations thereof, such as headgear, facemasks, or archwires.

### II.Dental Appliances and Associated Methods

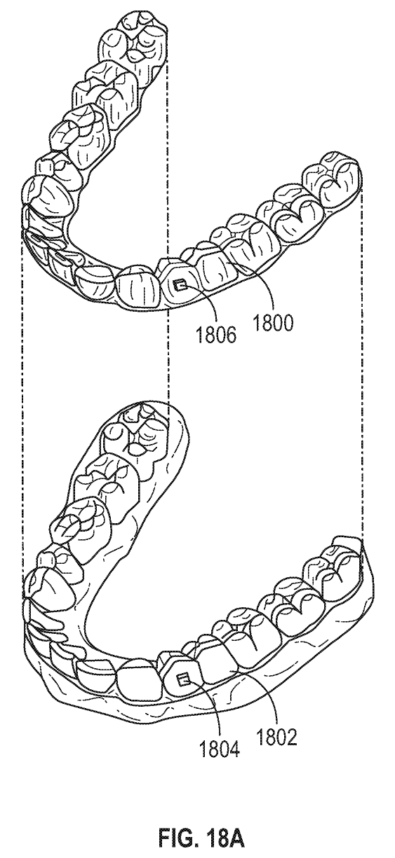

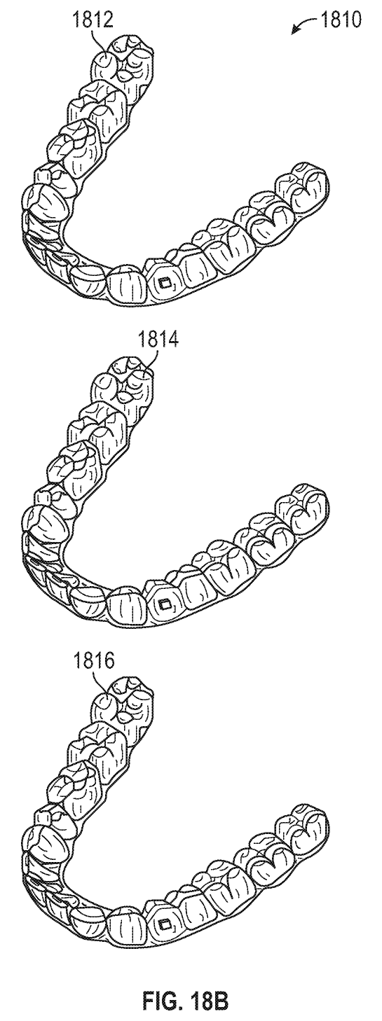

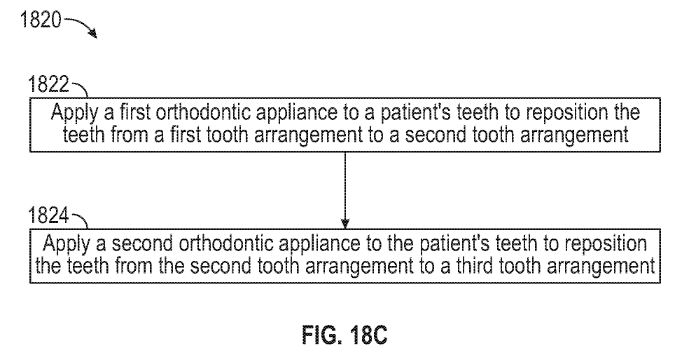

FIG. 18A illustrates a representative example of a tooth repositioning appliance 1800 configured in accordance with embodiments of the present technology. The appliance 1800 can be used in combination with any of the systems, methods, and devices described herein. The appliance 1800 (also referred to herein as an “aligner”) can be worn by a patient in order to achieve an incremental repositioning of individual teeth 1802 in the jaw. The appliance 1800 can include a shell (e.g., a continuous polymeric shell or a segmented shell) having teeth-receiving cavities that receive and resiliently reposition the teeth. The appliance 1800 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1800 can fit over all teeth present in an upper or lower jaw, or less than all of the teeth. The appliance 1800 can be designed specifically to accommodate the teeth of the patient (e.g., the topography of the tooth-receiving cavities matches the topography of the patient’s teeth), and may be fabricated based on positive or negative models of the patient’s teeth generated by impression, scanning, and the like. Alternatively, the appliance 1800 can be a generic appliance configured to receive the teeth, but not necessarily shaped to match the topography of the patient’s teeth. In some cases, only certain teeth received by the appliance 1800 are repositioned by the appliance 1800 while other teeth can provide a base or mounting region for holding the appliance 1800 in place as it applies force against the tooth or teeth targeted for repositioning. In some cases, some, most, or even all of the teeth can be repositioned at some point during treatment. Teeth that are moved can also serve as a base or mounting region for holding the appliance as it is worn by the patient. In preferred embodiments, no wires or other means are provided for holding the appliance 1800 in place over the teeth. In some cases, however, it may be desirable or necessary to provide individual attachments 1804 or other anchoring elements on teeth 1802 with corresponding receptacles 1806 or apertures in the appliance 1800 so that the appliance 1800 can apply a selected force on the tooth. Representative examples of appliances, including those utilized in the Invisalign® system, are described in numerous patents and patent applications assigned to Align Technology, Inc. including, for example, in U.S. Patent Nos. 6,450,807, and 5,975,893, as well as on the company’s website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Patent Nos. 6,309,215 and 6,830,450.

FIG. 18B illustrates a tooth repositioning system 1810 including a plurality of appliances 1812, 1814, 1816, in accordance with embodiments of the present technology. Any of the appliances described herein can be designed and/or provided as part of a set of a plurality of appliances used in a tooth repositioning system. Each appliance may be configured so a tooth- receiving cavity has a geometry corresponding to an intermediate or final tooth arrangement intended for the appliance. The patient’s teeth can be progressively repositioned from an initial tooth arrangement to a target tooth arrangement by placing a series of incremental position adjustment appliances over the patient’s teeth. For example, the tooth repositioning system 1810 can include a first appliance 1812 corresponding to an initial tooth arrangement, one or more intermediate appliances 1814 corresponding to one or more intermediate arrangements, and a final appliance 1816 corresponding to a target arrangement. A target tooth arrangement can be a planned final tooth arrangement selected for the patient’s teeth at the end of all planned orthodontic treatment. Alternatively, a target arrangement can be one of some intermediate arrangements for the patient’s teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient’s teeth that follows one or more incremental repositioning stages. Likewise, an initial tooth arrangement can be any initial arrangement for the patient’s teeth that is followed by one or more incremental repositioning stages.

FIG. 18C illustrates a method 1820 of orthodontic treatment using a plurality of appliances, in accordance with embodiments of the present technology. The method 1820 can be practiced using any of the appliances or appliance sets described herein. In block 1822, a first orthodontic appliance is applied to a patient’s teeth in order to reposition the teeth from a first tooth arrangement to a second tooth arrangement. In block 1824, a second orthodontic appliance is applied to the patient’s teeth in order to reposition the teeth from the second tooth arrangement to a third tooth arrangement. The method 1820 can be repeated as necessary using any suitable number and combination of sequential appliances in order to incrementally reposition the patient’s teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

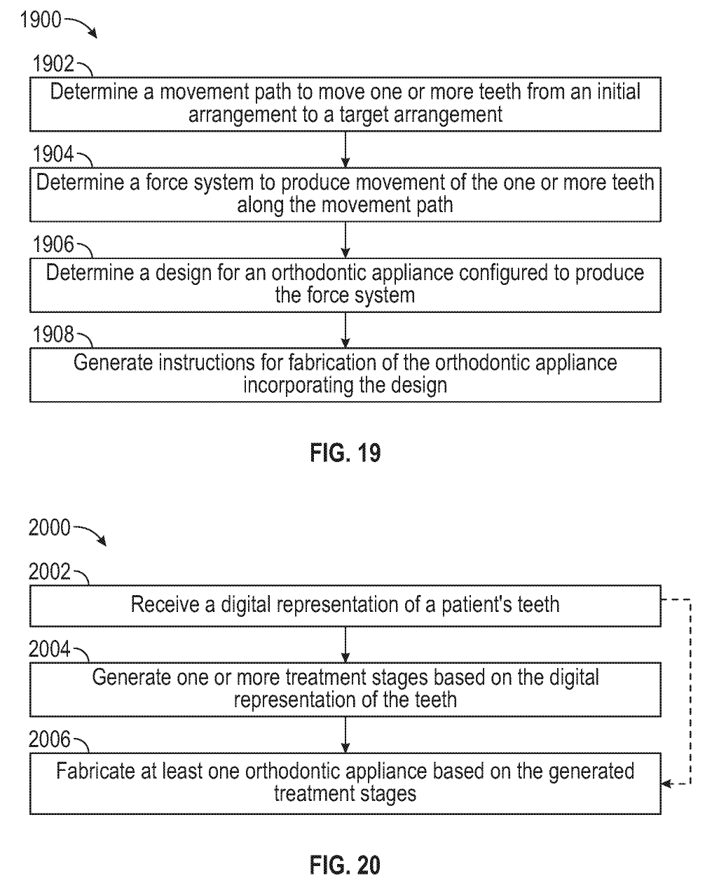

FIG. 19 illustrates a method 1900 for designing an orthodontic appliance, in accordance with embodiments of the present technology. The method 1900 can be applied to any embodiment of the orthodontic appliances described herein. Some or all of the steps of the method 1900 can be performed by any suitable data processing system or device, e.g., one or more processors configured with suitable instructions.

In block 1902, a movement path to move one or more teeth from an initial arrangement to a target arrangement is determined. The initial arrangement can be determined from a mold or a scan of the patient’s teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient’s teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth’s motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1904, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1904 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient’s mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient’s age—for example, young juvenile patients can require lower forces to expand the suture than older patients, as the suture has not yet fully formed.

In block 1906, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1908, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1900 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1900 may be performed with any suitable fabrication system or device, such as the embodiments described herein. Some of the steps may be optional, e.g., the process of block 1904 can be omitted, such that the orthodontic appliance is designed based on the desired tooth movements and/or determined tooth movement path, rather than based on a force system. Moreover, the order of the steps can be varied as desired.

FIG. 20 illustrates a method 2000 for digitally planning an orthodontic treatment and/or design or fabrication of an appliance, in accordance with embodiments. The method 2000 can be applied to any of the treatment procedures described herein and can be performed by any suitable data processing system.

In block 2002, a digital representation of a patient’s teeth is received. The digital representation can include surface topography data for the patient’s intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 2004, one or more treatment stages are generated based on the digital representation of the teeth. The treatment stages can be incremental repositioning stages of an orthodontic treatment procedure designed to move one or more of the patient’s teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 2006, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 20, design and/or fabrication of an orthodontic appliance, and perhaps a particular orthodontic treatment, may include use of a representation of the patient’s teeth (e.g., including receiving a digital representation of the patient’s teeth (block 2002)), followed by design and/or fabrication of an orthodontic appliance based on a representation of the patient’s teeth in the arrangement represented by the received representation.

As noted herein, the techniques described herein can be used with dental appliances, such as aligners and/or a series of aligners with tooth-receiving cavities configured to move a person’s teeth from an initial arrangement toward a target arrangement in accordance with a treatment plan. Aligners can include mandibular repositioning elements, such as those described in U.S. Patent No. 10,912,629, entitled “Dental Appliances with Repositioning Jaw Elements,” filed November 30, 2015; U.S. Patent No. 10,537,406, entitled “Dental Appliances with Repositioning Jaw Elements,” filed September 19, 2014; and U.S. Patent No. 9,844,424, entitled “Dental Appliances with Repositioning Jaw Elements,” filed February 21, 2014; all of which are incorporated by reference herein in their entirety.

The techniques used herein can also be applied to attachment placement devices, e.g., appliances used to position prefabricated attachments on a person’s teeth in accordance with one or more aspects of a treatment plan. Examples of attachment placement devices (also known as “attachment placement templates” or “attachment fabrication templates”) can be found at least in: U.S. Application No. 17/249,218, entitled “Flexible 3D Printed Orthodontic Device,” filed February 24, 2021; U.S. Application No. 16/366,686, entitled “Dental Attachment Placement Structure,” filed March 27, 2019; U.S. Application No. 15/674,662, entitled “Devices and Systems for Creation of Attachments,” filed August 11, 2017; U.S. Patent No. 11,103,330, entitled “Dental Attachment Placement Structure,” filed June 14, 2017; U.S. Application No. 14/963,527, entitled “Dental Attachment Placement Structure,” filed December 9, 2015; U.S. Application No. 14/939,246, entitled “Dental Attachment Placement Structure,” filed November 12, 2015; U.S. Application No. 14/939,252, entitled “Dental Attachment Formation Structures,” filed November 12, 2015; and U.S. Patent No. 9,700,385, entitled “Attachment Structure,” filed August 22, 2014; all of which are incorporated by reference herein in their entirety.

The techniques described herein can be used with incremental palatal expanders and/or a series of incremental palatal expanders used to expand a person’s palate from an initial position toward a target position in accordance with one or more aspects of a treatment plan. Examples of incremental palatal expanders can be found at least in: U.S. Application No. 16/380,801, entitled “Releasable Palatal Expanders,” filed April 10, 2019; U.S. Application No. 16/022,552, entitled “Devices, Systems, and Methods for Dental Arch Expansion,” filed June 28, 2018; U.S. Patent No. 11,045,283, entitled “Palatal Expander with Skeletal Anchorage Devices,” filed June 8, 2018; U.S. Application No. 15/831,159, entitled “Palatal Expanders and Methods of Expanding a Palate,” filed December 4, 2017; U.S. Patent No. 10,993,783, entitled “Methods and Apparatuses for Customizing a Rapid Palatal Expander,” filed December 4, 2017; and U.S. Patent No. 7,192,273, entitled “System and Method for Palatal Expansion,” filed August 7, 2003; all of which are incorporated by reference herein in their entirety.

### Examples

The following examples are included to further describe some aspects of the present technology, and should not be used to limit the scope of the technology.

Example 1. A palatal expander for treating a patient in combination with a secondary dental appliance, the palatal expander comprising:

a first tooth engagement portion configured to receive one or more first teeth at a left side of an upper dental arch of the patient, wherein the first tooth engagement portion includes a first wire interface configured to removably couple to a first wire portion of the secondary dental appliance;

a second tooth engagement portion configured to receive one or more second teeth at a right side of the upper dental arch of the patient, wherein the second tooth

engagement portion includes a second wire interface configured to removably couple to a second wire portion of the secondary dental appliance; and

a palatal portion between the first and second tooth engagement portions, wherein the palatal portion is configured to apply forces to the first and second tooth engagement portions to expand the palate of the patient.

Example 2. The palatal expander of Example 1, wherein the palatal expander is configured to secure the secondary dental appliance to the upper dental arch via the coupling between the first wire interface and the first wire portion and the coupling between the second wire interface and the second wire portion.

Example 3. The palatal expander of Example 2, wherein the palatal expander is configured to secure the secondary dental appliance to the upper dental arch without any molar bands or skeletal anchorage devices.

Example 4. The palatal expander of any one of Examples 1 to 3, wherein the secondary dental appliance comprises a headgear, and the first and second wire portions are part of the headgear.

Example 5. The palatal expander of Example 4, wherein the headgear is configured to retract the upper dental arch relative to a lower dental arch of the patient concurrently with the expansion of the palate of the patient.

Example 6. The palatal expander of any one of Examples 1 to 3, wherein the secondary dental appliance comprises a wire and bracket appliance, and the first and second wire portions are part of the wire and bracket appliance.

Example 7. The palatal expander of Example 6, wherein the wire and bracket appliance comprises a plurality of brackets configured to be positioned on one or more teeth of the upper dental arch, and at least one archwire coupled to the plurality of brackets, and wherein the first and second wire portions are part of the at least one archwire.

Example 8. The palatal expander of Example 6 or 7, wherein the wire and bracket appliance is configured to reposition one or more teeth of the upper dental arch concurrently with the expansion of the palate of the patient.

Example 9. The palatal expander of any one of Examples 1 to 8, wherein the first and second wire portions are part of the same wire.

Example 10. The palatal expander of any one of Examples 1 to 8, wherein the first wire portion is part of a first wire, and the second wire portion is part of a second wire separate from the first wire.

Example 11. The palatal expander of any one of Examples 1 to 10, wherein:

the first tooth engagement portion comprises a first receptacle configured to receive a first dental auxiliary on one of the first teeth, and the first wire interface is positioned anterior to the first receptacle, and

the second tooth engagement portion comprises a second receptacle configured to receive a second dental auxiliary on one of the second teeth, and the second wire interface is positioned anterior to the second receptacle.

Example 12. The palatal expander of any one of Examples 1 to 11, wherein the first and second wire interfaces are each located on an outer surface of the respective first and second tooth engagement portion.

Example 13. The palatal expander of any one of Examples 1 to 11, wherein the first and second wire interfaces are each located on an inner surface of the respective first and second tooth engagement portion.

Example 14. The palatal expander of any one of Examples 1 to 13, wherein the first and second wire interfaces are each located on a buccal side of the respective first and second tooth engagement portion.

Example 15. The palatal expander of any one of Examples 1 to 14, wherein at least one of the first or second wire interfaces comprises an aperture formed in the respective first or second tooth engagement portion, and wherein the aperture is configured to receive the respective first or second wire portion of the secondary dental appliance.

Example 16. The palatal expander of Example 15, wherein the aperture comprises a longitudinal channel formed in an inner surface of the respective first or second tooth engagement portion, the longitudinal channel extending in a mesial-distal direction.

Example 17. The palatal expander of Example 15 or 16, wherein the aperture comprises a transverse channel formed in the respective first or second tooth engagement portion, the transverse channel extending from an inner surface of the respective first or second tooth engagement portion toward an outer surface of the respective first or second tooth engagement portion.

Example 18. The palatal expander of any one of Examples 1 to 17, wherein at least one of the first or second wire interfaces comprises a projection formed in the respective first or second tooth engagement portion, and wherein the projection is configured to engage the respective first or second wire portion of the secondary dental appliance.

Example 19. The palatal expander of any one of Examples 1 to 18, wherein at least one of the first or second wire interfaces is configured to removably couple to the respective first or second wire portion of the secondary dental appliance via one or more of the following: interference fit, snap fit, an elastic, or a bracket.

Example 20. A system for treating a patient, the system comprising the palatal expander and the secondary dental appliance of any one of Examples 1 to 19.

Example 21. A series of palatal expanders having a sequence and configured to be sequentially worn by a patient in combination with a secondary dental appliance, the series of palatal expanders comprising the palatal expander of any one of Examples 1 to 19.

Example 22. A method for treating a patient’s teeth, the method comprising:

placing a first palatal expander on the patient’s teeth, wherein the first palatal expander comprises:

a first tooth engagement portion configured to receive one or more first teeth at a left side of an upper dental arch of the patient,

a second tooth engagement portion configured to receive one or more second teeth at a right side of the upper dental arch of the patient, and

a palatal portion between the first and second tooth engagement portions;

coupling a first wire portion of a secondary dental appliance to the first tooth engagement portion; and

coupling a second wire portion of the secondary dental appliance to the second tooth engagement portion.

Example 23. The method of Example 22, further comprising:

applying a first dental treatment to the patient’s teeth with the first palatal expander, wherein the first dental treatment comprises expanding a palate of the patient, and

applying a second dental treatment to the patient’s teeth with the secondary dental appliance.

Example 24. The method of Example 23, wherein the first and second dental treatments are applied concurrently.

Example 25. The method of Example 23 or 24, wherein the second dental treatment comprises retracting the upper dental arch relative to a lower dental arch of the patient.

Example 26. The method of Example 25, wherein the secondary dental appliance comprises a headgear, and the first and second wire portions are part of the headgear.

Example 27. The method of Example 23 or 24, wherein the second dental treatment comprises repositioning one or more teeth of the upper dental arch.

Example 28. The method of Example 27, wherein the secondary dental appliance comprises a wire and bracket appliance, and the first and second wire portions are part of the wire and bracket appliance.

Example 29. The method of Example 28, wherein the wire and bracket appliance comprises a plurality of brackets configured to be positioned on the one or more teeth of the upper dental arch, and at least one archwire coupled to the plurality of brackets, and wherein the first and second wire portions are part of the at least one archwire.

Example 30. The method of any one of Examples 22 to 29, further comprising securing the secondary dental appliance to the upper dental arch via the coupling between the first wire portion and the first tooth engagement portion and the coupling between the second wire portion and the second tooth engagement portion.

Example 31. The method of Example 30, wherein the secondary dental appliance is secured to the upper dental arch without any molar bands or skeletal anchorage devices.

Example 32. The method of any one of Examples 22 to 31, further comprising placing the secondary dental appliance on the patient’s teeth before placing the first palatal expander on the patient’s teeth.

Example 33. The method of any one of Examples 22 to 31, further comprising placing the secondary dental appliance on the patient’s teeth after placing the first palatal expander on the patient’s teeth.

Example 34. The method of any one of Examples 22 to 33, wherein the first and second wire portions are part of the same wire.

Example 35. The method of any one of Examples 22 to 33, wherein the first wire portion is part of a first wire, and the second wire portion is part of a second wire separate from the first wire.

Example 36. The method of any one of Examples 22 to 35, at least one of the first or second tooth engagement portions comprises an aperture configured to receive the respective first or second wire portion.

Example 37. The method of any one of Examples 22 to 36, wherein at least one of the first or second tooth engagement portions comprises a projection configured to engage the respective first or second wire portion.

Example 38. The method of any one of Examples 22 to 37, wherein at least one of the first or second wire portions is coupled to the respective first or second tooth engagement portion via one or more of the following: interference fit, snap fit, an elastic, or a bracket.

Example 39. The method of any one of Examples 22 to 38, further comprising:

decoupling the first wire portion of the secondary dental appliance from the first tooth engagement portion, and

decoupling the second wire portion of the secondary dental appliance from the second tooth engagement portion.

Example 40. The method of Example 39, further comprising:

removing the first palatal expander from the patient’s teeth,

placing a second palatal expander on the patient’s teeth, wherein the second palatal expander is a subsequent palatal expander in a series of sequential palatal expanders, and wherein the second palatal expander comprises:

a first tooth engagement portion configured to receive the one or more first teeth at the left side of the upper dental arch of the patient,

a second tooth engagement portion configured to receive the one or more second teeth at the right side of the upper dental arch of the patient, and

a palatal portion between the first and second tooth engagement portions of the second palatal expander,

coupling the first wire portion of the secondary dental appliance to the first tooth engagement portion of the second palatal expander, and

coupling the second wire portion of the secondary dental appliance to the second tooth engagement portion of the second palatal expander.

Example 41. A computer-implemented method for designing a palatal expander, the computer-implemented method comprising, by one or more processors:

accessing a dental treatment plan for the patient, wherein the dental treatment plan comprises expanding the patient’s palate with a palatal expander and treating the patient’s teeth with a secondary dental appliance;

determining a geometry for the palatal expander, wherein the palatal expander comprises:

a first tooth engagement portion configured to receive one or more first teeth at a left side of an upper dental arch of the patient, wherein the first tooth engagement portion includes a first wire interface configured to removably couple to a first wire portion of the secondary dental appliance,

a second tooth engagement portion configured to receive one or more second teeth at a right side of the upper dental arch of the patient, wherein the second tooth engagement portion includes a second wire interface configured to removably couple to a second wire portion of the secondary dental appliance, and

a palatal portion between the first and second tooth engagement portions; and

generating instructions for fabricating the palatal expander with the determined geometry.

Example 42. The computer-implemented method of Example 41, wherein the dental treatment comprises expanding the patient’s palate with a series of palatal expanders including the palatal expander.

Example 43. The computer-implemented method of Example 41 or 42, further comprising accessing a digital representation of the secondary dental appliance, wherein the

geometry for the palatal expander is determined based on the digital representation of the secondary dental appliance.

Example 44. The computer-implemented method of any one of Examples 41 to 43, further comprising fabricating the palatal expander with the determined geometry.

Example 45. The computer-implemented method of Example 44, wherein the palatal expander is fabricated via an additive manufacturing process.

Example 46. A palatal expander for treating a patient, the palatal expander comprising:

a first tooth engagement portion configured to receive one or more first teeth at a left side of an upper dental arch of the patient, wherein the first tooth engagement portion includes a first interface configured to removably couple to a first elastic, wherein the first elastic is coupled to a left side of a lower dental arch of the patient;

a second tooth engagement portion configured to receive one or more second teeth at a right side of the upper dental arch of the patient, wherein the second tooth engagement portion includes a second interface configured to removably couple to a second elastic, wherein the second elastic is coupled to a right side of the lower dental arch of the patient; and

a palatal portion between the first and second tooth engagement portions, wherein the palatal portion is configured to apply forces to the first and second tooth engagement portions to expand a palate of the patient.

Example 47. The palatal expander of Example 46, wherein the first and second interfaces are each located at a lingual side of the respective first and second tooth engagement portion.

Example 48. The palatal expander of Example 46, wherein the first and second interfaces are each located at a buccal side of the respective first and second tooth engagement portion.

Example 49. The palatal expander of any one of Examples 46 to 48, wherein the first and second interfaces are each located on an outer surface of the respective first and second tooth engagement portion.

Example 50. The palatal expander of any one of Examples 46 to 49, wherein the first and second elastics are each coupled to a lingual side of the lower dental arch.

Example 51. The palatal expander of any one of Examples 46 to 49, wherein the first and second elastics are each coupled to a buccal side of the lower dental arch.

Example 52. The palatal expander of any one of Examples 46 to 51, wherein at least one of the first and second interfaces comprises a button or a hook.

Example 53. The palatal expander of any one of Examples 46 to 52, wherein:

the first tooth engagement portion comprises a first receptacle configured to receive a first dental auxiliary on one of the first teeth, and the first interface is positioned anterior to the first receptacle, and

the second tooth engagement portion comprises a second receptacle configured to receive a second dental auxiliary on one of the second teeth, and the second wire interface is positioned anterior to the second receptacle.

Example 54. A series of palatal expanders having a sequence and configured to be sequentially worn by a patient, the series of palatal expanders comprising:

for one or more palatal expanders in the series:

a first tooth engagement portion configured to receive one or more first teeth at a left side of an upper dental arch of the patient, wherein the first tooth engagement portion includes a first interface configured to removably couple to a first elastic, wherein the first elastic is coupled to a left side of a lower dental arch of the patient;

a second tooth engagement portion configured to receive one or more second teeth at a right side of the upper dental arch of the patient, wherein the second tooth engagement portion includes a second interface configured to removably couple to a second elastic, wherein the second elastic is coupled to a right side of the lower dental arch of the patient; and

a palatal portion between the first and second tooth engagement portions, wherein the palatal portion is configured to apply forces to the first and second tooth engagement portions to expand a palate of the patient.

Example 55. A method for treating a patient’s teeth, the method comprising:

placing a first palatal expander on the patient’s teeth, wherein the first palatal expander comprises:

a first tooth engagement portion configured to receive one or more first teeth at a left side of an upper dental arch of the patient,

a second tooth engagement portion configured to receive one or more second teeth at a right side of the upper dental arch of the patient, and

a palatal portion between the first and second tooth engagement portions;

coupling a first elastic to the first tooth engagement portion and to a left side of a lower dental arch of the patient; and

coupling a second elastic to the second tooth engagement portion and to a right side of the lower dental arch of the patient.

Example 56. The method of Example 55, further comprising:

decoupling the first elastic from the first tooth engagement portion, and

decoupling the second elastic from the second tooth engagement portion.

Example 57. The method of Example 56, further comprising:

removing the first palatal expander from the patient’s teeth,

placing a second palatal expander on the patient’s teeth, wherein the second palatal expander is a subsequent palatal expander in a series of sequential palatal expanders, and wherein the second palatal expander comprises:

a first tooth engagement portion configured to receive the one or more first teeth at the left side of the upper dental arch of the patient,

a second tooth engagement portion configured to receive one or more second teeth at the right side of the upper dental arch of the patient, and

a palatal portion between the first and second tooth engagement portions;

coupling the first elastic to the first tooth engagement portion of the second palatal expander, and

coupling the second elastic to the second tooth engagement portion of the second palatal expander.

Example 58. A series of palatal expanders having a sequence and configured to be sequentially worn by a patient in combination with a secondary dental appliance, the series of palatal expanders comprising:

for one or more palatal expanders in the series:

a first tooth engagement portion configured to receive one or more first teeth at a left side of an upper dental arch of the patient, wherein the first tooth engagement portion includes a first wire interface configured to removably couple to a first wire portion of the secondary dental appliance;

a second tooth engagement portion configured to receive one or more second teeth at a right side of the upper dental arch of the patient, wherein the second tooth engagement portion includes a second wire interface configured to removably couple to a second wire portion of the secondary dental appliance; and

a palatal portion between the first and second tooth engagement portions, wherein the palatal portion is configured to apply forces to the first and second tooth engagement portions to expand the palate of the patient.

Example 59. The series of palatal expanders of Example 58, wherein the one or more palatal expanders are each configured to secure the secondary dental appliance to the upper dental arch via the coupling between the first wire interface and the first wire portion and the coupling between the second wire interface and the second wire portion.

Example 60. The series of palatal expanders of Example 59, wherein the one or more palatal expanders are each configured to secure the secondary dental appliance to the upper dental arch without any molar bands or skeletal anchorage devices.

Example 61. The series of palatal expanders of any one of Examples 58 to 60, wherein the secondary dental appliance comprises a headgear, and the first and second wire portions are part of the headgear.

Example 62. The series of palatal expanders of any one of Examples 58 to 60, wherein the secondary dental appliance comprises a wire and bracket appliance, and the first and second wire portions are part of the wire and bracket appliance.

Example 63. The series of palatal expanders of any one of Examples 58 to 62, wherein the first and second wire portions are part of the same wire.

Example 64. The series of palatal expanders of any one of Examples 58 to 62, wherein the first wire portion is part of a first wire, and the second wire portion is part of a second wire separate from the first wire.

Example 65. The series of palatal expanders of any one of Examples 58 to 64, wherein the first and second wire interfaces are each located on a buccal side of the respective first and second tooth engagement portion.

Example 66. The series of palatal expanders of any one of Examples 58 to 65, wherein at least one of the first or second wire interfaces comprises an aperture formed in the respective first or second tooth engagement portion, and wherein the aperture is configured to receive the respective first or second wire portion of the secondary dental appliance.

Example 67. The series of palatal expanders of any one of Examples 58 to 66, wherein at least one of the first or second wire interfaces comprises a projection formed in the respective first or second tooth engagement portion, and wherein the projection is configured to engage the respective first or second wire portion of the secondary dental appliance.

Example 68. A computer-implemented method for designing a palatal expander, the computer-implemented method comprising, by one or more processors:

accessing a dental treatment plan for the patient, wherein the dental treatment plan comprises expanding the patient’s palate with a palatal expander and treating the patient’s teeth with a secondary dental appliance;

determining a geometry for the palatal expander, wherein the palatal expander comprises:

a first tooth engagement portion configured to receive one or more first teeth at a left side of an upper dental arch of the patient, wherein the first tooth engagement portion includes a first wire interface configured to removably couple to a first wire portion of the secondary dental appliance,

a second tooth engagement portion configured to receive one or more second teeth at a right side of the upper dental arch of the patient, wherein the second tooth engagement portion includes a second wire interface configured to removably couple to a second wire portion of the secondary

dental appliance, and

a palatal portion between the first and second tooth engagement portions; and

fabricating the palatal expander with the determined geometry.

Example 69. The computer-implemented method of Example 68, wherein the dental treatment comprises expanding the patient’s palate with a series of palatal expanders including the palatal expander.

Example 70. The computer-implemented method of Example 68 or 69, further comprising accessing a digital representation of the secondary dental appliance, wherein the geometry for the palatal expander is determined based on the digital representation of the secondary dental appliance.

Example 71. The computer-implemented method of any one of Examples 68 to 70, wherein the palatal expander is fabricated via an additive manufacturing process.

Example 72. The computer-implemented method of any one of Examples 68 to 71, wherein the palatal expander is configured to secure the secondary dental appliance to the upper dental arch via the coupling between the first wire interface and the first wire portion and the coupling between the second wire interface and the second wire portion.

Example 73. The computer-implemented method of any one of Examples 68 to 72, wherein the secondary dental appliance comprises a headgear or a wire and bracket appliance.

Example 74. The computer-implemented method of any one of Examples 68 to 73, wherein the first and second wire interfaces are each located on a buccal side of the respective first and second tooth engagement portion.

Example 75. The computer-implemented method of any one of Examples 68 to 74, wherein at least one of the first or second wire interfaces comprises an aperture formed in the respective first or second tooth engagement portion, and wherein the aperture is configured to receive the respective first or second wire portion of the secondary dental appliance.

Example 76. The computer-implemented method of any one of Examples 68 to 75, wherein at least one of the first or second wire interfaces comprises a projection formed in the respective first or second tooth engagement portion, and wherein the projection is configured to engage the respective first or second wire portion of the secondary dental appliance.

### Conclusion

Although many of the embodiments are described above with respect to systems, devices, and methods for coupling palatal expanders to wire-based dental appliances, the technology is applicable to other applications and/or other approaches, such as coupling of other types of dental appliances to each other. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIG. 1A–20.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A series of palatal expanders having a sequence and configured to be sequentially worn by a patient in combination with a secondary dental appliance, the series of palatal expanders comprising:
for one or more palatal expanders in the series:
a first tooth engagement portion configured to receive one or more first teeth at a left side of an upper dental arch of the patient, wherein the first tooth engagement portion includes a first wire interface configured to removably couple to a first wire portion of the secondary dental appliance;
a second tooth engagement portion configured to receive one or more second teeth at a right side of the upper dental arch of the patient, wherein the second tooth engagement portion includes a second wire interface configured to removably couple to a second wire portion of the secondary dental appliance; and
a palatal portion between the first and second tooth engagement portions, wherein the palatal portion is configured to apply forces to the first and second tooth engagement portions to expand the palate of the patient.

2. The series of palatal expanders of claim 1, wherein the one or more palatal expanders are each configured to secure the secondary dental appliance to the upper dental arch via the coupling between the first wire interface and the first wire portion and the coupling between the second wire interface and the second wire portion.

3. The series of palatal expanders of claim 2, wherein the one or more palatal expanders are each configured to secure the secondary dental appliance to the upper dental arch without any molar bands or skeletal anchorage devices.

4. The series of palatal expanders of claim 1, wherein the secondary dental appliance comprises a headgear, and the first and second wire portions are part of the headgear.

5. The series of palatal expanders of claim 1, wherein the secondary dental appliance comprises a wire and bracket appliance, and the first and second wire portions are part of the wire and bracket appliance.

6. The series of palatal expanders of claim 1, wherein the first and second wire portions are part of the same wire.

7. The series of palatal expanders of claim 1, wherein the first wire portion is part of a first wire, and the second wire portion is part of a second wire separate from the first wire.

8. The series of palatal expanders of claim 1, wherein the first and second wire interfaces are each located on a buccal side of the respective first and second tooth engagement portion.

9. The series of palatal expanders of claim 1, wherein at least one of the first or second wire interfaces comprises an aperture formed in the respective first or second tooth engagement portion, and wherein the aperture is configured to receive the respective first or second wire portion of the secondary dental appliance.

10. The series of palatal expanders of claim 1, wherein at least one of the first or second wire interfaces comprises a projection formed in the respective first or second tooth engagement portion, and wherein the projection is configured to engage the respective first or second wire portion of the secondary dental appliance.

11. A computer-implemented method for designing a palatal expander, the computer-implemented method comprising, by one or more processors:
accessing a dental treatment plan for the patient, wherein the dental treatment plan comprises expanding the patient’s palate with a palatal expander and treating the patient’s teeth with a secondary dental appliance;
determining a geometry for the palatal expander, wherein the palatal expander comprises:
a first tooth engagement portion configured to receive one or more first teeth at a left side of an upper dental arch of the patient, wherein the first tooth engagement portion includes a first wire interface configured to removably couple to a first wire portion of the secondary dental appliance,
a second tooth engagement portion configured to receive one or more second teeth at a right side of the upper dental arch of the patient, wherein the second tooth engagement portion includes a second wire interface configured to removably couple to a second wire portion of the secondary dental appliance, and
a palatal portion between the first and second tooth engagement portions; and
fabricating the palatal expander with the determined geometry.

12. The computer-implemented method of claim 11, wherein the dental treatment comprises expanding the patient’s palate with a series of palatal expanders including the palatal expander.

13. The computer-implemented method of claim 11, further comprising accessing a digital representation of the secondary dental appliance, wherein the geometry for the palatal expander is determined based on the digital representation of the secondary dental appliance.

14. The computer-implemented method of claim 11, wherein the palatal expander is fabricated via an additive manufacturing process.

15. The computer-implemented method of claim 11, wherein the palatal expander is configured to secure the secondary dental appliance to the upper dental arch via the coupling between the first wire interface and the first wire portion and the coupling between the second wire interface and the second wire portion.

16. The computer-implemented method of claim 11, wherein the secondary dental appliance comprises a headgear or a wire and bracket appliance.

17. The computer-implemented method of claim 11, wherein the first and second wire interfaces are each located on a buccal side of the respective first and second tooth engagement portion.

18. The computer-implemented method of claim 11, wherein at least one of the first or second wire interfaces comprises an aperture formed in the respective first or second tooth engagement portion, and wherein the aperture is configured to receive the respective first or second wire portion of the secondary dental appliance.

19. The computer-implemented method of claim 11, wherein at least one of the first or second wire interfaces comprises a projection formed in the respective first or second tooth engagement portion, and wherein the projection is configured to engage the respective first or second wire portion of the secondary dental appliance.

20. A method for treating a patient’s teeth, the method comprising:
placing a first palatal expander on the patient’s teeth, wherein the first palatal expander comprises:
a first tooth engagement portion configured to receive one or more first teeth at a left side of an upper dental arch of the patient,
a second tooth engagement portion configured to receive one or more second teeth at a right side of the upper dental arch of the patient, and
a palatal portion between the first and second tooth engagement portions;
coupling a first wire portion of a secondary dental appliance to the first tooth engagement portion; and
coupling a second wire portion of the secondary dental appliance to the second tooth engagement portion.
